(19) United States
(12) Patent Application Publication
(10) Pub. No.: US 2026/0292214 A1
(43) Pub. Date: Sep. 24, 2026

(54) Template Matching Prediction with Adaptive Refinement Search Windows

(71) Applicant: Comcast Cable Communications, LLC, Philadelphia, PA (US)

(72) Inventors: Damian Ruiz Coll, Reston, VA (US); Jung Kyung Lee, Reston, VA (US)

(21) Appl. No.: 19/570,788

(22) Filed: Mar. 18, 2026

Related U.S. Application Data
(60) Provisional application No. 63/774,087, filed on Mar. 18, 2025.

(51) Int. Cl. H04N 19/176; H04N 19/139; H04N 19/57

(52) U.S. Cl. CPC H04N 19/176; H04N 19/139; H04N 19/57

(57) ABSTRACT

Blocks of content samples within a picture may be coded. Search areas may be used to select a block candidate for coding a current block. A pre-defined template of the current block may be used to search for the block candidate with a template that best matches the template of the current block. The block candidate may be selected from a plurality of block candidates in the search areas. The window size of the search areas may be determined based on template matching costs associated with a plurality of block candidates. Advantages such as reduced coding complexity may be achieved.

### CROSS-REFERENCE TO RELATED APPLICATIONS

This application claims the benefit of U.S. Provisional Application No. 63/774,087 filed on Mar. 18, 2025. The above referenced application is hereby incorporated by reference in its entirety.

### BACKGROUND

A computing device processes video for storage, transmission, reception, and/or display. Processing a video comprises encoding and decoding, for example, to reduce a data size associated with the video.

### SUMMARY

The following summary presents a simplified summary of certain features. The summary is not an extensive overview and is not intended to identify key or critical elements.

A video may comprise a sequence of frames or pictures displayed consecutively. Blocks of samples within a picture may be encoded and/or decoded. A current block may be coded using a reference block pointed to by a displacement from the current block. The reference block may be selected from an area with samples that are already reconstructed in the same picture as the current block. In intra-template matching prediction (IntraTMP), an intra-prediction mode may be used to select a prediction block within a search area from the reconstructed samples within a current frame. IntraTMP may use a pre-defined template of the current block to search for a candidate reference block with a template that best matches the template of the current block. The candidate reference block may be selected from a plurality of block candidates in a search window size. The search window size may be determined based on template matching costs associated with the block candidates. In this way, advantages, such as a reduction in coding complexity and more efficient compression, may be achieved since an optimized search window size may prevent a search from extending far from the block candidates' location.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system.

FIG. 2 shows an example encoder.

FIG. 3 shows an example decoder.

FIG. 4 shows an example quadtree partitioning of a coding tree block (CTB).

FIG. 5 shows an example quadtree corresponding to the example quadtree partitioning of the CTB in FIG. 4.

FIG. 6 shows example binary tree and ternary tree partitions.

FIG. 7 shows an example of combined quadtree and multi-type tree partitioning of a CTB.

FIG. 8 shows an example tree corresponding to the combined quadtree and multi-type tree partitioning of the CTB shown in FIG. 7.

FIG. 9 shows an example set of reference samples determined for intra prediction of a current block.

FIG. 10A and FIG. 10B show example intra prediction modes.

FIG. 11 shows an example current block and corresponding reference samples.

FIG. 12 shows an example application of an intra prediction mode for prediction of a current block.

FIG. 13A shows an example of inter prediction.

FIG. 13B shows an example motion vector.

FIG. 14 shows an example of bi-prediction.

FIG. 15A shows example spatial candidate neighboring blocks for a current block.

FIG. 15B shows example temporal, co-located blocks for a current block.

FIG. 16 shows an example of intra block copy (IBC).

FIG. 17 shows an example of intra-template matching prediction (IntraTMP).

FIG. 18 shows an example of a current block and a reference region.

FIG. 19A shows an example of a sparse search.

FIG. 19B shows an example block vector.

FIG. 20 shows an example of a top-template type.

FIG. 21 shows an example of a left-template type.

FIG. 22 shows an example of an L-shaped template type.

FIG. 23A and FIG. 23B show examples of adjacent blocks and non-adjacent blocks for determining block vector candidates.

FIG. 24 shows an example method of IntraTMP with merge candidates.

FIG. 25 shows example refinement windows.

FIG. 26A shows an example of an auto-relocated block vector prediction (AR-BVP).

FIG. 26B shows examples of refinement windows of AR-BVP candidates.

FIG. 27 shows an example of IntraTMP with BVP candidates derived using IntraTMP AR-BVP merge.

FIG. 28 shows an example of the IntraTMP AR-BVP merge process.

FIG. 29 shows an example of sparse AR-BVP candidates in IntraTMP.

FIG. 30 shows an example process for applying TMP sparse AR-BVP candidates to the TMP.

FIG. 31 shows examples of overlapping of refinement windows.

FIG. 32A and FIG. 32B show examples of enlarged refinement windows and corresponding new block vector predictor candidate.

FIG. 33 shows clustering the enlarged window generated in FIG. 32A and FIG. 32B, and another refinement window.

FIG. 34 shows an example of a clustering algorithm and its application to adjacent and non-adjacent Merge candidate lists.

FIG. 35 shows an example clustering process.

FIG. 36A shows example TMP cost thresholds and example relationships between TMP cost of BVP candidates and corresponding adaptive refinement windows.

FIG. 36B shows example applications of the TMP cost threshold to adapt the size of refinement windows.

FIG. 37 shows an example IntraTMP process which does not implement a BVP candidates clustering process.

FIG. 38A and FIG. 38B show an example IntraTMP process utilizing the BVP candidates clustering process.

FIG. 39 shows an example method for generating adaptive refinement window sizing.

FIG. 40A, FIG. 40B and FIG. 40C show example methods for using TMP cost thresholds to determine refinement window sizes.

FIG. 41 shows an example method for using clustering of refinement windows.

FIG. 42 shows an example computer system in which examples of the present disclosure may be implemented.

FIG. 43 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of video encoding and decoding systems, which may be used in the technical field of video data storage and/or transmission/reception. More particularly, the technology disclosed herein may relate to video compression as used in encoding and/or decoding devices and/or systems.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

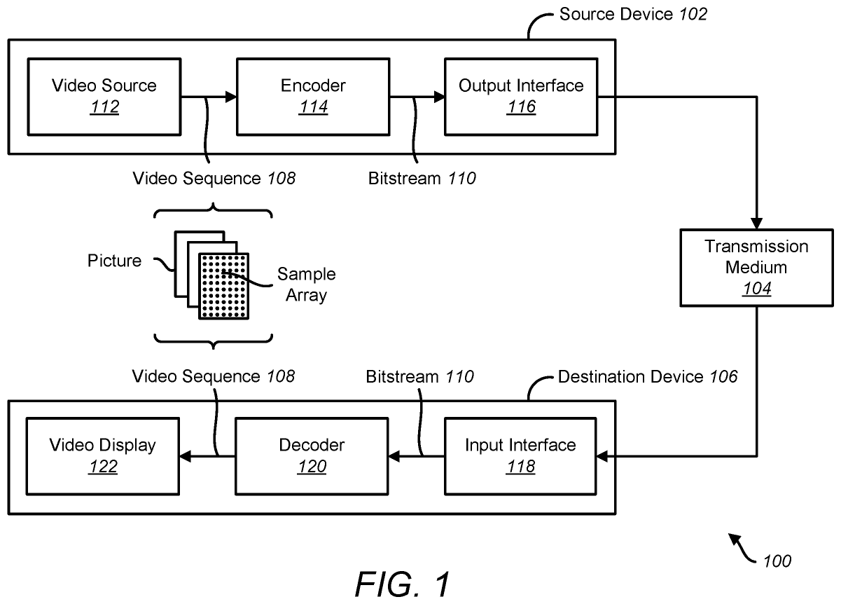

FIG. 1 shows an example video coding/decoding system. Video coding/decoding system 100 may comprise a source device 102, a transmission medium 104, and a destination device 106. The source device 102 may encode a video sequence 108 into a bitstream 110 for more efficient storage and/or transmission. The source device 102 may store and/or send/transmit the bitstream 110 to the destination device 106 via the transmission medium 104. The destination device 106 may decode the bitstream 110 to display the video sequence 108. The destination device 106 may receive the bitstream 110 from the source device 102 via the transmission medium 104. The source device 102 and/or the destination device 106 may be any of a plurality of different devices (e.g., a desktop computer, laptop computer, tablet computer, smart phone, wearable device, television, camera, video gaming console, set-top box, video streaming device, etc.).

The source device 102 may comprise (e.g., for encoding the video sequence 108 into the bitstream 110) one or more of a video source 112, an encoder 114, and/or an output interface 116. The video source 112 may provide and/or generate the video sequence 108 based on a capture of a natural scene and/or a synthetically generated scene. A synthetically generated scene may be a scene comprising computer generated graphics and/or screen content. The video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays used to represent color pictures. For example, three sample arrays may be used for one luma component and two chroma components, respectively. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

The encoder 114 may encode the video sequence 108 into the bitstream 110. The encoder 114 may apply/use (e.g., to encode the video sequence 108) one or more prediction techniques to reduce redundant information in the video sequence 108. Redundant information may comprise information that may be predicted at a decoder and need not be transmitted to the decoder for accurate decoding of the video sequence 108. For example, the encoder 114 may apply spatial prediction (e.g., intra-frame or intra prediction), temporal prediction (e.g., inter-frame prediction or inter prediction), inter-layer prediction, and/or other prediction techniques to reduce redundant information in the video sequence 108. The encoder 114 may partition pictures comprising the video sequence 108 into rectangular regions referred to as blocks, for in example, prior to applying one or more prediction techniques. The encoder 114 may then encode a block using the one or more of the prediction techniques.

The encoder 114 may search for a block similar to the block being encoded in another picture (e.g., a reference picture) of the video sequence 108, for example, for temporal prediction. The block determined during the search (e.g., a prediction block) may then be used to predict the block being encoded. The encoder 114 may form a prediction block based on data from reconstructed neighboring samples of the block to be encoded within the same picture of the video sequence 108, for example, for spatial prediction. A reconstructed sample may be a sample that was encoded and then decoded. The encoder 114 may determine a prediction error (e.g., a residual) based on the difference between a block being encoded and a prediction block. The prediction error may represent non-redundant information that may be sent/transmitted to a decoder for accurate decoding of the video sequence 108.

The encoder 114 may apply a transform to the prediction error (e.g. using a discrete cosine transform (DCT), or any other transform) to generate transform coefficients. The encoder 114 may form the bitstream 110 based on the transform coefficients and other information used to determine prediction blocks using/based on prediction types, motion vectors, and/or prediction modes. The encoder 114 may perform one or more of quantization and entropy coding of the transform coefficients and/or the other information used to determine the prediction blocks, for example, prior to or before forming the bitstream 110. The quantization and/or the entropy coding may further reduce the quantity of bits needed to store and/or transmit the video sequence 108.

The output interface 116 may be configured to write and/or store the bitstream 110 onto the transmission medium 104 for transmission to the destination device 106. Also or alternatively, the output interface 116 may be configured to send/transmit, upload, and/or stream the bitstream 110 to the destination device 106 via the transmission medium 104. The output interface 116 may comprise a wired and/or a wireless transmitter configured to send/transmit, upload, and/or stream the bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

The transmission medium 104 may comprise wireless, wired, and/or computer readable medium. For example, the transmission medium 104 may comprise one or more wires, cables, air interfaces, optical discs, flash memory, and/or magnetic memory. Also or alternatively, the transmission medium 104 may comprise one or more networks (e.g., the internet) or file servers configured to store and/or send/transmit encoded video data.

The destination device 106 may decode the bitstream 110 into the video sequence 108 for display. The destination device 106 may comprise one or more of an input interface 118, a decoder 120, and/or a video display 122. The input interface 118 may be configured to read the bitstream 110 stored on the transmission medium 104 by the source device 102. Also or alternatively, the input interface 118 may be configured to receive, download, and/or stream the bitstream 110 from the source device 102 via the transmission medium 104. The input interface 118 may comprise a wired and/or a wireless receiver configured to receive, download, and/or stream the bitstream 110 in accordance with one or more proprietary, open-source, standardized communication protocols, and/or any other communication protocol (e.g., such as referenced herein).

The decoder 120 may decode the video sequence 108 from the encoded bitstream 110. The decoder 120 may generate prediction blocks for pictures of the video sequence 108 in a similar manner as the encoder 114 and determine the prediction errors for the blocks, for example, to decode the video sequence 108. The decoder 120 may generate the prediction blocks using/based on prediction types, prediction modes, and/or motion vectors received in the bitstream 110. The decoder 120 may determine the prediction errors using the transform coefficients received in the bitstream 110. The decoder 120 may determine the prediction errors by weighting transform basis functions using the transform coefficients. The decoder 120 may combine the prediction blocks and the prediction errors to decode the video sequence 108. The video sequence 108 at the destination device 106 may be, or may not necessarily be, the same video sequence sent, such as the video sequence 108 as sent by the source device 102. The decoder 120 may decode a video sequence that approximates the video sequence 108, for example, because of lossy compression of the video sequence 108 by the encoder 114 and/or errors introduced into the encoded bitstream 110 during transmission to the destination device 106.

The video display 122 may display the video sequence 108 to a user. The video display 122 may comprise a cathode rate tube (CRT) display, a liquid crystal display (LCD), a plasma display, a light emitting diode (LED) display, and/or any other display device suitable for displaying the video sequence 108.

The video encoding/decoding system 100 is merely an example and video encoding/decoding systems different from the video encoding/decoding system 100 and/or modified versions of the video encoding/decoding system 100 may perform the methods and processes as described herein. For example, the video encoding/decoding system 100 may comprise other components and/or arrangements. The video source 112 may be external to the source device 102. The video display device 122 may be external to the destination device 106 or omitted altogether (e.g., if the video sequence 108 is intended for consumption by a machine and/or storage device). The source device 102 may further comprise a video decoder and the destination device 104 may further comprise a video encoder. For example, the source device 102 may be configured to further receive an encoded bit stream from the destination device 106 to support two-way video transmission between the devices.

The encoder 114 and/or the decoder 120 may operate according to one or more proprietary or industry video coding standards. For example, the encoder 114 and/or the decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC)), the WebM VP8 and VP9 codecs, and/or AOMedia Video 1 (AV1), and/or any other video coding protocol).

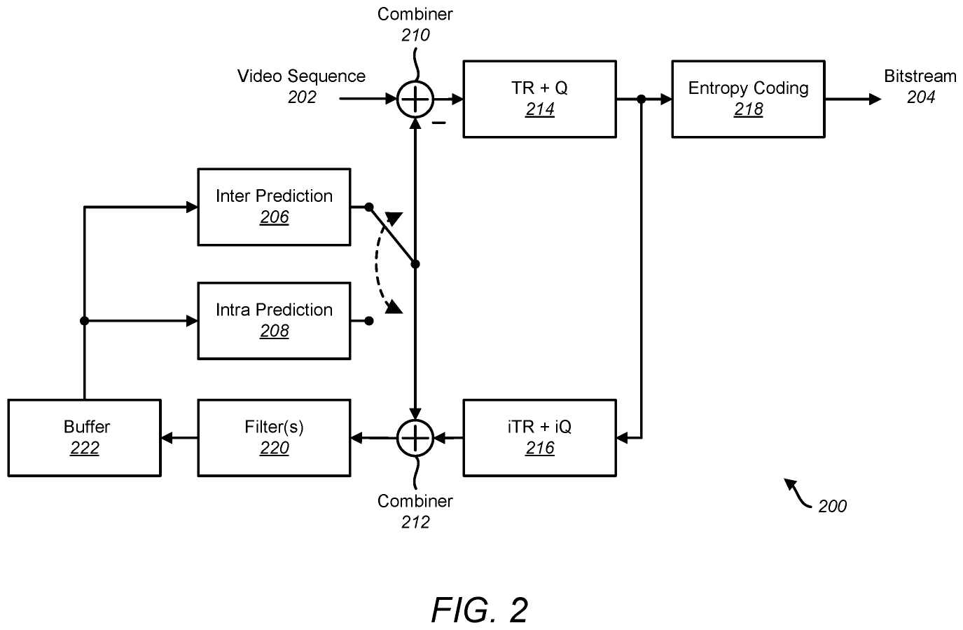

FIG. 2 shows an example encoder. The encoder 200 as shown in FIG. 2 may implement one or more processes described herein. The encoder 200 may encode a video sequence 202 into a bitstream 204 for more efficient storage and/or transmission. The encoder 200 may be implemented in the video coding/decoding system 100 as shown in FIG. 1 (e.g., as the encoder 114) or in any computing, communication, or electronic device (e.g., desktop computer, laptop computer, tablet computer, smart phone, wearable device, television, camera, video gaming console, set-top box, video streaming device, etc.). The encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

The encoder 200 may partition pictures (e.g., frames) of (e.g., comprising) the video sequence 202 into blocks and encode the video sequence 202 on a block-by-block basis. The encoder 200 may perform/apply a prediction technique on a block being encoded using either the inter prediction unit 206 or the intra prediction unit 208. The inter prediction unit 206 may perform inter prediction by searching for a block similar to the block being encoded in another, reconstructed picture (e.g., a reference picture) of the video sequence 202. The reconstructed picture may be or refer to a picture that was encoded and then decoded. The block determined during the search (e.g., a prediction block) may then be used to predict the block being encoded to remove redundant information. The inter prediction unit 206 may exploit temporal redundancy or similarities in scene content from picture to picture in the video sequence 202 to determine the prediction block. For example, scene content between pictures of the video sequence 202 may be similar except for differences due to motion and/or affine transformation of the screen content over time.

The intra prediction unit 208 may perform intra prediction by forming a prediction block based on data from reconstructed neighboring samples of the block to be encoded within the same picture of the video sequence 202. The reconstructed sample may be or refer to a sample that was encoded and then decoded. The intra prediction unit 208 may exploit spatial redundancy or similarities in scene content within a picture of the video sequence 202 to determine the prediction block. For example, the texture of a region of scene content in a picture may be similar to the texture in the immediate surrounding area of the region of the scene content in the same picture.

The combiner 210 may determine a prediction error (e.g., a residual) based on the difference between the block being encoded and the prediction block. The prediction error may represent non-redundant information that may be sent/transmitted to a decoder for accurate decoding of the video sequence 202.

The transform and quantization unit (TR+Q) 214 may transform and quantize the prediction error. The transform and quantization unit 214 may transform the prediction error into transform coefficients by applying, for example, a DCT to reduce correlated information in the prediction error. The transform and quantization unit 214 may quantize the coefficients by mapping data of the transform coefficients to a predefined set of representative values. The transform and quantization unit 214 may quantize the coefficients to reduce irrelevant information in the bitstream 204. The Irrelevant information may be information that may be removed from the coefficients without producing visible and/or perceptible distortion in the video sequence 202 after decoding (e.g., at a receiving device).

The entropy coding unit 218 may apply one or more entropy coding methods to the quantized transform coefficients to further reduce the bit rate. For example, the entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form the bitstream 204.

The inverse transform and quantization unit (iTR+iQ) 216 may inverse quantize and inverse transform the quantized transform coefficients to determine a reconstructed prediction error. The combiner 212 may combine the reconstructed prediction error with the prediction block to form a reconstructed block. The filter(s) 220 may filter the reconstructed block, for example, using a deblocking filter, a sample-adaptive offset (SAO) filter, constrained directional enhancement filters (CDEFs), and/or loop restoration (LR) filters. The buffer 222 may store the reconstructed block for prediction of one or more other blocks in the same and/or different picture of the video sequence 202.

The encoder 200 may further comprise an encoder control unit. The encoder control unit may be configured to control one or more units of the encoder 200 as shown in FIG. 2. The encoder control unit may control the one or more units of the encoder 200 such that the bitstream 204 may be generated in conformance with the requirements of one or more proprietary coding protocols, industry video coding standards, and/or any other video cording protocol. For example, the encoder control unit may control the one or more units of the encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bit rate (or bitrate) of bitstream 204 does not exceed a certain level/threshold. The encoder control unit may determine/control one or more of: partitioning of the pictures of the video sequence 202 into blocks, whether a block is inter predicted by the inter prediction unit 206 or intra predicted by the intra prediction unit 208, a motion vector for inter prediction of a block, an intra prediction mode among a plurality of intra prediction modes for intra prediction of a block, filtering performed by the filter(s) 220, and/or one or more transform types and/or quantization parameters applied by the transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to the entropy coding unit 218 to be further compressed (e.g., to reduce the bit rate). For example, the entropy coding unit 218 may use/apply context adaptive variable length coding (CAVLC), context adaptive binary arithmetic coding (CABAC), syntax-based context-based binary arithmetic coding (SBAC), and/or symbol-to-symbol adaptive multi-symbol (non-binary) arithmetic coding to achieve further compression. The prediction type, prediction information, and/or transform and/or quantization parameters may be packed with the prediction error to form the bitstream 204.

The encoder 200 is merely an example and encoders different from the encoder 200 and/or modified versions of the encoder 200 may perform the methods and processes as described herein. For example, the encoder 200 may comprise other components and/or arrangements. One or more of the components shown in FIG. 2 may be optionally included in the encoder 200 (e.g., the entropy coding unit 218 and/or the filters(s) 220).

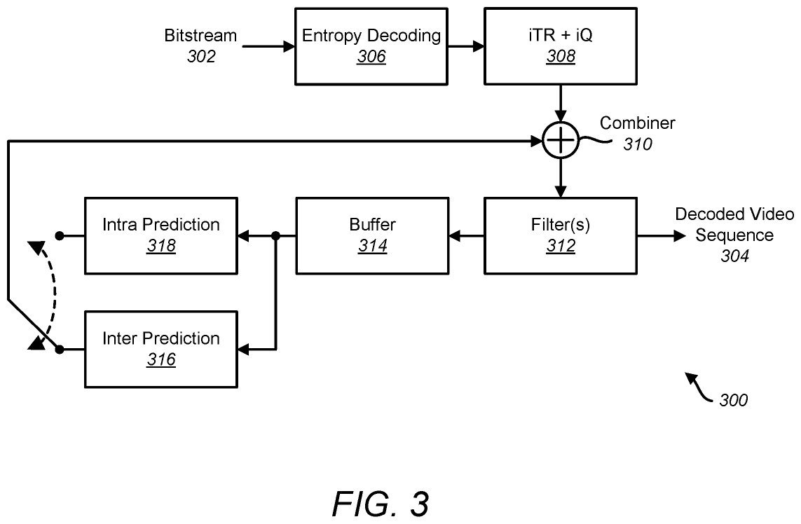

FIG. 3 shows an example decoder. A decoder 300 as shown in FIG. 3 may implement one or more processes described herein. The decoder 300 may decode a bitstream 302 into a decoded video sequence 304 for display and/or some other form of consumption. The decoder 300 may be implemented in the video encoding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). The decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

The decoder 300 may comprise a decoder control unit configured to control one or more units of decoder 300. The decoder control unit may control the one or more units of decoder 300 such that the bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by the inter prediction unit 316 or intra predicted by the intra prediction unit 318, a motion vector for inter prediction of a block, an intra prediction mode among a plurality of intra prediction modes for intra prediction of a block, filtering performed by the filter(s) 312, and/or one or more inverse transform types and/or inverse quantization parameters to be applied by the inverse transform and quantization unit 308. One or more of the control parameters used by the decoder control unit may be packed in bitstream 302.

The Entropy decoding unit 306 may entropy decode the bitstream 302. For example, the entropy decoding unit 306 may use/apply CAVLC, CABAC, and SBAC to decompress the prediction type used to encode a block (intra or inter prediction), prediction information of the block (intra prediction mode if intra predicted, motion vector, etc.), and transform and quantization parameters. The inverse transform and quantization unit 308 may inverse quantize and/or inverse transform the quantized transform coefficients to determine a decoded prediction error. The combiner 310 may combine the decoded prediction error with a prediction block to form a decoded block. The prediction block may be generated by the intra prediction unit 318 or the inter prediction unit 316 (e.g., as described above with respect to encoder 200 in FIG. 2). The filter(s) 312 may filter the decoded block, for example, using a deblocking filter, a sample-adaptive offset (SAO) filter, constrained directional enhancement filters (CDEFs), and/or loop restoration (LR) filters. The buffer 314 may store the decoded block for prediction of one or more other blocks in the same and/or different picture of the video sequence in the bitstream 302. The decoded video sequence 304 may be output from the filter(s) 312 as shown in FIG. 3.

The decoder 300 is merely an example and decoders different from the decoder 300 and/or modified versions of the decoder 300 may perform the methods and processes as described herein. For example, the decoder 300 may have other components and/or arrangements. One or more of the components shown in FIG. 3 may be optionally included in the decoder 300 (e.g., the entropy decoding unit 306 and/or the filters(s) 312).

Although not shown in FIGS. 2 and 3, each of the encoder 200 and the decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. A CB may be further partitioned into intra sub-partitions (ISP) where the reconstructed samples of each sub-partition may be available to generate the prediction of the next sub-partition. For example, a CB may be split into 2 to 4 sub-partitions. For transformations, a CB may be partitioned into one or more transform blocks (TBs). A TB may be a rectangular block of samples that may determine/indicate an applied transform size.

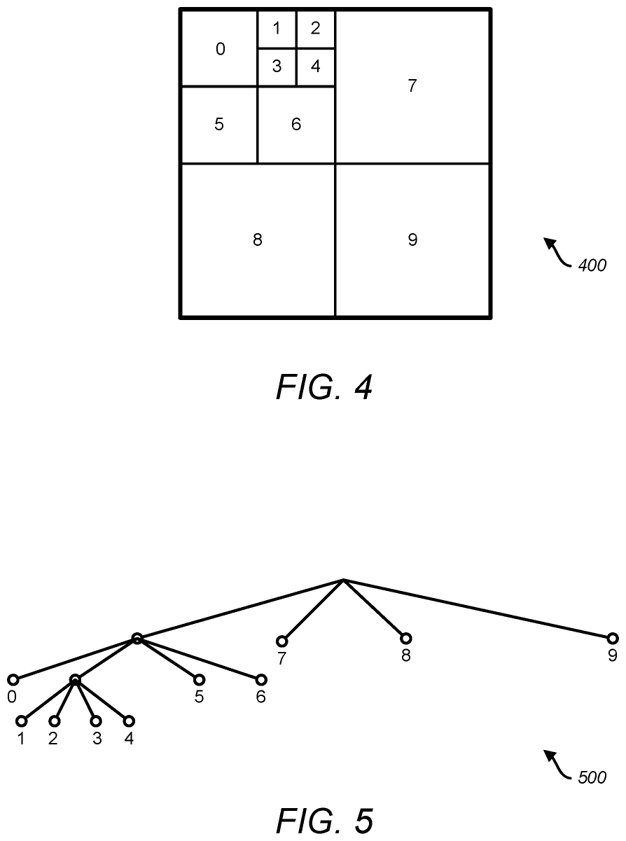

FIG. 4 shows an example quadtree partitioning of a CTB. FIG. 5 shows an example quadtree corresponding to the example quadtree partitioning of the CTB 400 in FIG. 4. As shown in the examples of FIGS. 4 and 5, the CTB 400 may first be partitioned into four CBs of half vertical and half horizontal size. Three of the resulting CBs of the first level partitioning of CTB 400 may be leaf CBs. The three leaf CBs of the first level partitioning of CTB 400 are respectively labeled 7, 8, and 9 in FIGS. 4 and 5. The non-leaf CB of the first level partitioning of CTB 400 may be partitioned into four sub-CBs of half vertical and half horizontal size. Three of the resulting sub-CBs of the second level partitioning of CTB 400 may be leaf CBs. The three leaf CBs of the second level partitioning of CTB 400 are respectively labeled 0, 5, and 6 in FIGS. 4 and 5. The non-leaf CB of the second level partitioning of CTB 400 may be partitioned into four leaf CBs of half vertical and half horizontal size. The four leaf CBs may be respectively labeled 1, 2, 3, and 4 in FIGS. 4 and 5.

The CTB 400 of FIG. 4 may be partitioned into 10 leaf CBs respectively labeled 0-9, and/or any other quantity of leaf CBs. The 10 leaf CBs may correspond to 10 CB leaf nodes (e.g., 10 CB leaf nodes of the quadtree 500 as shown in FIG. 5). In other examples, a CTB may be partitioned into a different number of leaf CBs. The resulting quadtree partitioning of the CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

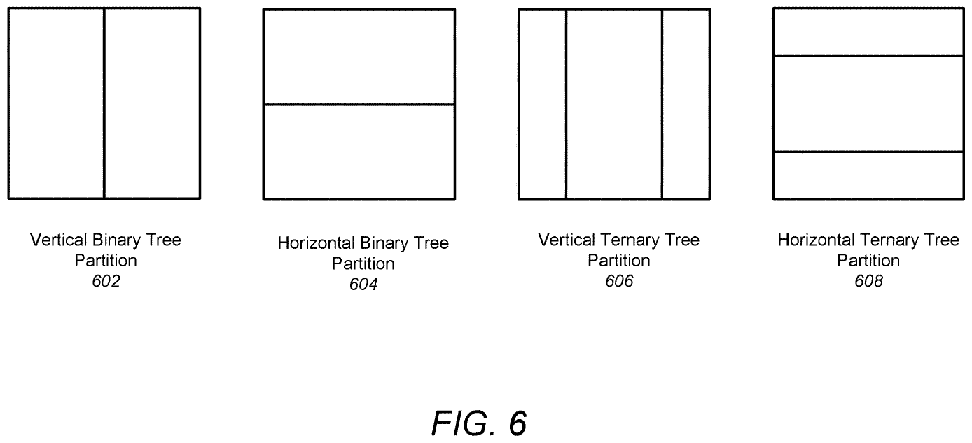

FIG. 6 shows example binary tree and ternary tree partitions. A binary tree partition may divide a parent block in half in either a vertical direction 602 or a horizontal direction 604. The resulting partitions may be half in size as compared to the parent block. The resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

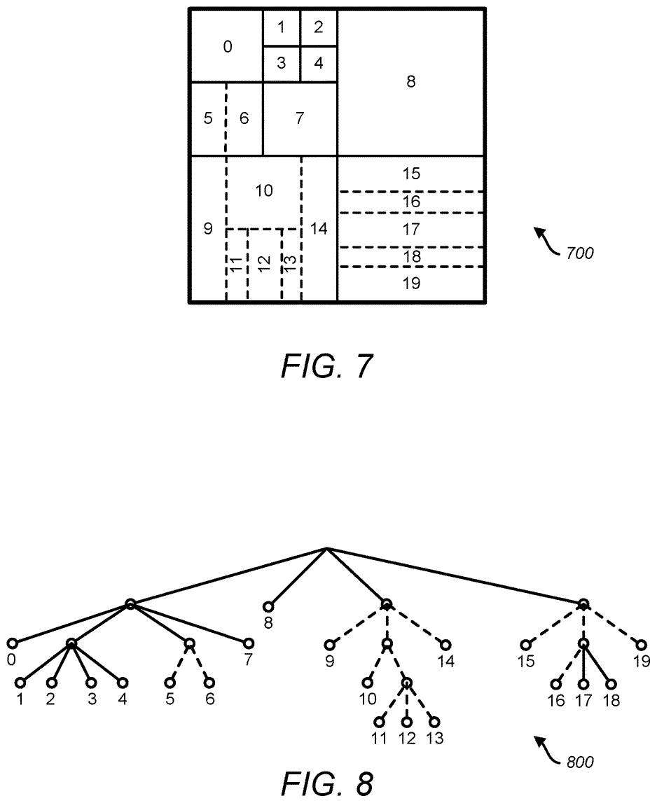

FIG. 7 shows an example of combined quadtree and multi-type tree partitioning of a CTB. FIG. 8 shows an example tree corresponding to the combined quadtree and multi-type tree partitioning of the CTB 700 shown in FIG. 7. In both FIGS. 7 and 8, quadtree splits are shown in solid lines and multi-type tree splits are shown in dashed lines. For ease of explanation, the CTB 700 is shown with the same quadtree partitioning as the CTB 400 described in FIG. 4, and a description of the quadtree partitioning of the CTB 700 (similar to that for CTB 400) is omitted. The quadtree partitioning of the CTB 700 is merely an example and a CTB may be quadtree partitioned in a manner different from the CTB 700. Additional multi-type tree partitions of the CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBs respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, the CTB 700 may be partitioned into 20 leaf CBs respectively labeled 0-19. The 20 leaf CBs may correspond to 20 leaf nodes (e.g., 20 leaf nodes of the tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream (or bitstream). A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block (coding block or transform block) in the AV1 coding format.

Samples of a block to be encoded (e.g., a current block) may be predicted from samples in a line of samples immediately adjacent to the current block, for example, in intra prediction. For example, the line of samples may include samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

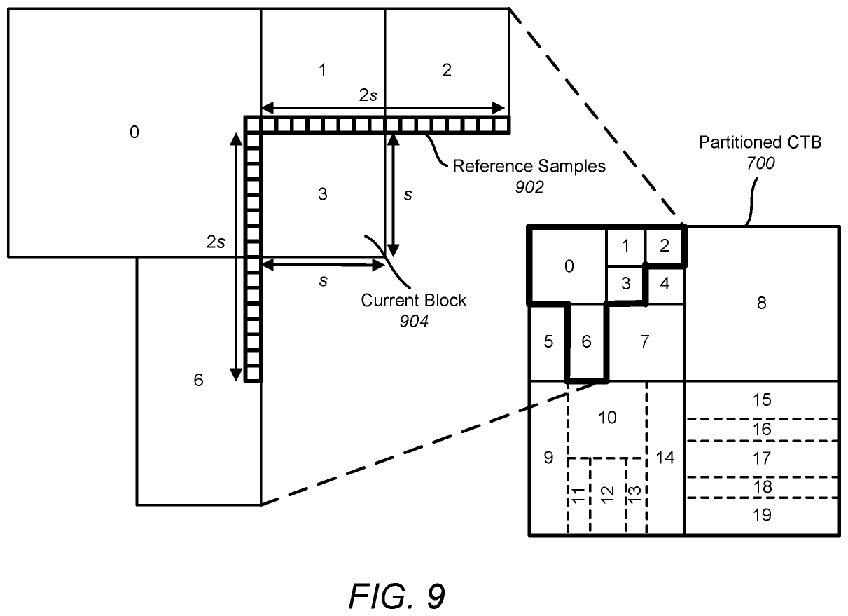

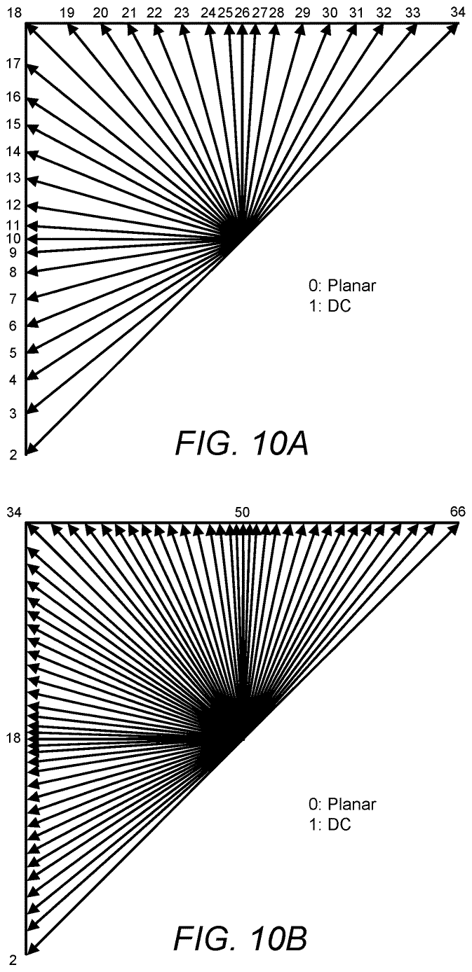

FIG. 9 shows an example set of reference samples determined for intra prediction of a current block. The current block 904 may correspond to a block being encoded and/or decoded. The current block 904 may correspond to block 3 of the partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

Reference samples 902 may include a line of samples immediately adjacent to current block 904. The reference samples 902 may include samples from a column and a row immediately adjacent to current block 904. For example, the line of samples may include reference samples to the left and/or above the current block 904. Reference samples 902 may be obtained (or selected) from a reference line of multiple reference lines (MRL). The MRL may include a line of samples adjacent to current block 904 and a line of samples not adjacent to the current block 904. The MRL may include reference lines identified by corresponding reference line indices that may indicate an i-th line of samples adjacent to current block 904 such that the 0-th line indicates the reference line immediately adjacent (or closest) to the current block 904 and a higher numbered i-th line indicates a line of samples further away from the current block 904. An encoder may select a reference line from a set of MRL and/or may signal an MRL index in the bitstream to indicate the selected reference line. For example, the encoder may signal a codeword encoding the MRL index. The decoder may decode the codeword to determine the MRL index that identifies a specific reference line used in intra prediction of the current block 904.

The current block 904 may be w×h samples in size. The reference samples 902 may comprise: 2w samples (or any other quantity of samples) of an i-th row (e.g., indicated by an MRL index) adjacent to the top-most row of current block 904, 2h samples (or any other quantity of samples) of the i-th column adjacent to the left-most column of current block 904, and the top left neighboring corner sample(s) extending from the i-th column and i-th row with respect to current block 904, for example, for the current block 904 that is w×h samples in size. The current block 904 may be square, such that w=h=s. In other examples, a current block need not be square, such that w/h. Available samples from neighboring blocks of the current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. Samples from neighboring blocks 0, 1, 2, and 6 may be available to construct the reference samples 902 given that these blocks are encoded and reconstructed at an encoder and decoded at a decoder prior to coding of the current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

Unavailable samples from the reference samples 902 may be filled with one or more of the available reference samples 902. For example, an unavailable reference sample may be filled with a nearest available reference sample. The nearest available reference sample may be determined by moving in a clock-wise direction through the reference samples 902 from the position of the unavailable reference. The reference samples 902 may be filled with the mid-value of the dynamic range of the picture being coded, for example, if no reference samples are available.

Samples of the current block 904 may be intra predicted based on reference samples 902, for example, based on (e.g., after) determination and (optionally) filtering of the reference samples 902. A filtering scheme (e.g., a filtering algorithm) may be used/applied for/to the reference samples 902, for example, to improve prediction accuracy. The filtering scheme may be one of a plurality of filter types including at least a smoothing filter (or reference sample smoothing filter) or an interpolation filter. Only one of the plurality of filter types may be selected (e.g., activated) to be used/applied for/to reference samples of a given block, for example, if the reference samples are to be filtered. For example, the interpolation filter may not be selected (e.g., may be disabled), for example, if the smoothing filter is selected (e.g., activated), or vice versa.

A plurality of (e.g., many) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

FIGS. 10A, 10B, and 10C show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

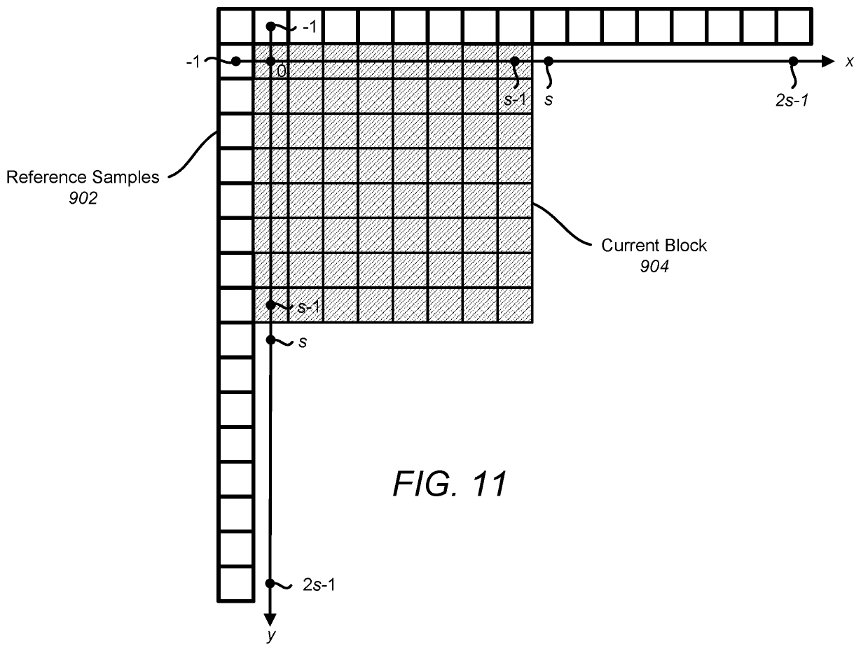

FIG. 11 shows an example current block 904 and corresponding reference samples 902 from FIG. 9. FIG. 11 shows current block 904 and reference samples 902 in a two-dimensional x, y plane, where a sample may be referenced as p[x][y], for example, to further describe how intra prediction modes are used/applied for/to determine a prediction (e.g., a prediction block) of current block 904. The reference samples 902 may be from a reference line among a set of multiple reference lines (MRL) 908-912. To simplify the prediction process, reference samples 902 may be placed in two, one-dimensional arrays. The reference samples 902 belonging to a reference line I from the set of MRL 908-912, above the current block 904, may be placed in the one-dimensional array ref₁[x]:

$${ref}_{1} [ x ] = p [ - l + x ] [ - l ] , ( x \geq 0 ) . \qquad ( 1 )$$

The reference samples 902 belonging to reference line I, to the left of current block 904, may be placed in the one-dimensional array ref₂[y]:

$$r e {f}_{2} [ y ] = p [ - l ] [ - l + y ] , ( y \geq 0 ) . \qquad ( 2 )$$

The variable I represents how many lines away the selected reference line is from current block. For example, if reference line #0 908 is selected, then I is set to 1 to indicate the reference line adjacent to current block 904. For example, if reference line #1 910 is selected, then I is set to 2. For example, if reference line #2 912 is selected, then I is set to 3.

Reference samples 902 may be from reference line 908 that is immediately adjacent to current block 904, for example, if MRL is not activated or selected. In this example, the variable/in Equations (1) and (2) is set to 1.

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in the current block 904. The second of the two interpolated values may be based on a vertical linear interpolation at the location [x][y] in the current block 904. The predicted sample p[x][y] in the current block 904 may be determined/calculated as:

$$p [ x ] ⌈ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at the location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at the location [x][y] in current block 904. s may be equal to a length of a side (e.g., a number of samples on a side) of the current block 904.

A sample at a location [x][y] in current block 904 may be predicted by the mean of the reference samples 902, for example, for a DC mode. The predicted sample p[x][y] in current block 904 may be determined/calculated as:

$$p [ x ] ⌈ y ] = \frac{1}{2 \cdot s} ( {\sum }_{x = 0}^{s - 1} r e {f}_{1} [ x ] + {\sum }_{y = 0}^{s - 1} r e {f}_{2} [ y ] ) . \qquad ( 6 )$$

A sample at a location [x][y] in current block 904 may be predicted by projecting the location [x][y] in a direction specified by a given angular mode to a point on the horizontal or vertical line of samples comprising reference samples 902, for example, for an angular mode. The sample at the location [x][y] may be predicted by interpolating between the two closest reference samples of the projection point, for example, if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

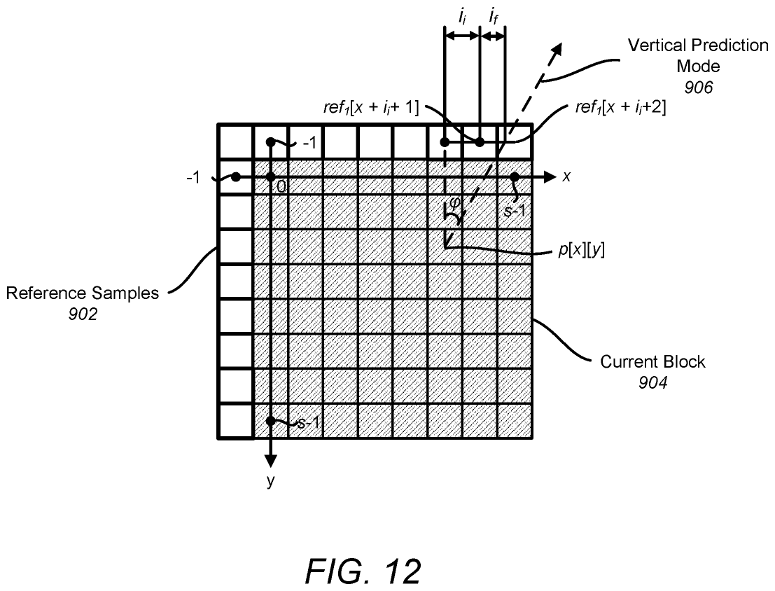

FIG. 12 shows an example application of an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle q with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 and shown as being from a reference line with reference line index of 0 for ease of illustration. Reference samples 902 may be from another reference line of the set of MRL, as explained in FIG. 9. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

$$p [ x ] [ y ] = ( 1 - {i}_{f} ) \cdot re {f}_{1} [ x + {i}_{i} + 1 ] + {i}_{f} \cdot re {f}_{1} [ x + {i}_{i} + 2 ] . \qquad ( 7 )$$

i_{I} may be the integer part of the horizontal displacement of the projection point relative to the location [x][y]. it may be determined/calculated as a function of the tangent of the angle φ of the vertical prediction mode 906 as:

$${i}_{i} = ⌊ ( y + 1 ) \cdot tan φ ⌋ . \qquad ( 8 )$$

i_{f} may be the fractional part of the horizontal displacement of the projection point relative to the location [x][y] and may be determined/calculated as:

$${i}_{f} = ( ( y + 1 ) \cdot tan φ ) - ⌊ ( y + 1 ) \cdot tan φ ⌋ , \qquad ( 9 )$$

where └·┘ is the integer floor function.

A location [x][y] of a sample in current block 904 may be projected onto the vertical line of reference samples ref₂[y], for example, for horizontal prediction modes. A predicted sample p[x][y] for horizontal prediction modes may be determined/calculated as:

$$p [ x ] [ y ] = ( 1 - {i}_{f} ) \cdot re {f}_{2} [ y + {i}_{i} + 1 ] + {i}_{f} \cdot re {f}_{2} [ y + {i}_{i} + 2 ] . \qquad ( 10 )$$

iᵢ may be the integer part of the vertical displacement of the projection point relative to the location [x][y]. iᵢ may be determined/calculated as a function of the tangent of the angle φ of the horizontal prediction mode as:

$${i}_{i} = ⌊ ( x + 1 ) \cdot tan φ ⌋ . \qquad ( 11 )$$

i_{f} may be the fractional part of the vertical displacement of the projection point relative to the location [x][y]. i_{f} may be determined/calculated as:

$${i}_{f} = ( ( x + 1 ) \cdot tan φ ) - ⌊ ( x + 1 ) \cdot tan φ ⌋ , \qquad ( 12 )$$

where └·┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters-one for each of the 32 possible values of the fractional part of the projected displacement if. In other examples, different levels of sample accuracy may be used.

The FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement if. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] [ y ] = {\sum }_{i = 0}^{3} f T [ i ] \cdot re {f}_{1} [ x + iIdx + i ] , \qquad ( 13 )$$

where fI[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} f T [ i ] \cdot re {f}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles q are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles q are used. The supplementary reference samples may be determined/constructed by projecting the reference samples in ref₁[x] on the horizontal line of reference samples 902 to the vertical line of reference samples 902 using the negative horizontal prediction angle q.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC and/or including extended intra prediction modes from WAIP for rectangular blocks. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples, generated from reference samples 902 of a reference line (e.g., from a set of MRL), determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. The encoder may determine/select the intra prediction mode and the associated reference line to encode the current block based on a rate-distortion measure (e.g., Lagrangian rate-distortion cost) determined using the prediction errors. The encoder may signal an indication of the determined/selected intra prediction mode and an indication of the associated MRL index (which may indicate a reference line index). The encoder may signal an indication of the determined/selected intra prediction mode and an indication of the associated MRL index (which may indicate a reference line index), for example, in the bitstream to a decoder for decoding of the current block. The encoder may also signal in the bitstream to the decoder a corresponding prediction error (e.g., residual) of the intra prediction mode.

A decoder may determine/predict samples of a current block being decoded (e.g., current block 904) for an intra prediction mode. For example, a decoder may receive an indication of a reference line (e.g., a reference line index or an MRL index associated with the reference line index) and an intra prediction mode (e.g., an angular intra prediction mode) from an encoder for a current block. The decoder may retrieve a set of reference samples and perform intra prediction, for example, based on the MRL index and the intra prediction mode indicated by the encoder for the current block in a similar manner (e.g., as described above for the encoder). The decoder may obtain the reference samples from a reference line indicated/identified by the decoded MRL index. The reference line may have reference line index 0 and may be immediately adjacent to the current block, for example, if/when MRL is not enabled/activated/selected. In these examples, no indication of MRL index is signaled.

The decoder may add predicted values of the samples (e.g., determined based on the intra prediction mode) of the current block to a residual of the current block to reconstruct the current block. A decoder need not receive an indication of an angular intra prediction mode from an encoder for a current block. A decoder may determine an intra prediction mode, for example, through other decoder-side means (e.g., by applying template-based intra mode derivation (TIMD) tool/technique). While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

An encoder may determine a difference between a current block and a prediction for a current block (e.g., similar to intra prediction). An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

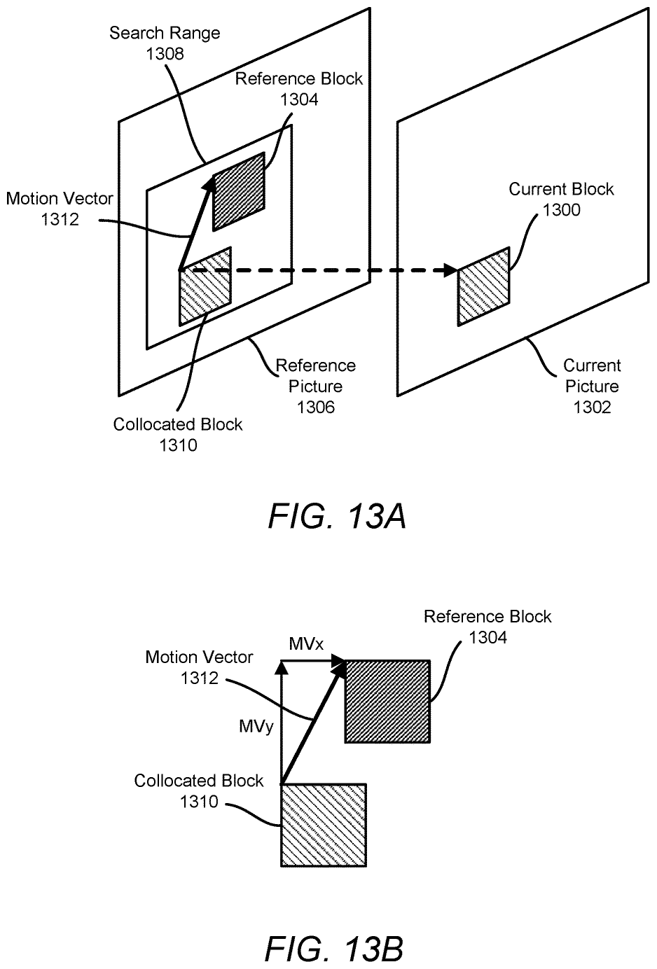

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have 1/2, 1/4, 1/8, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. The motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304. The reference block 1304 may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction.

Inter prediction of a current block, using bi-prediction, may be based on two pictures (e.g., the source of prediction may be from the two pictures). Bi-prediction may be useful, for example, if a video sequence comprises fast motion, camera panning, zooming, and/or scene changes. Bi-prediction may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

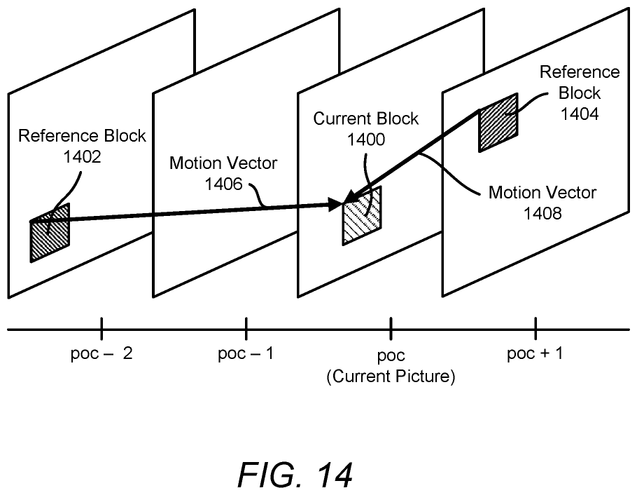

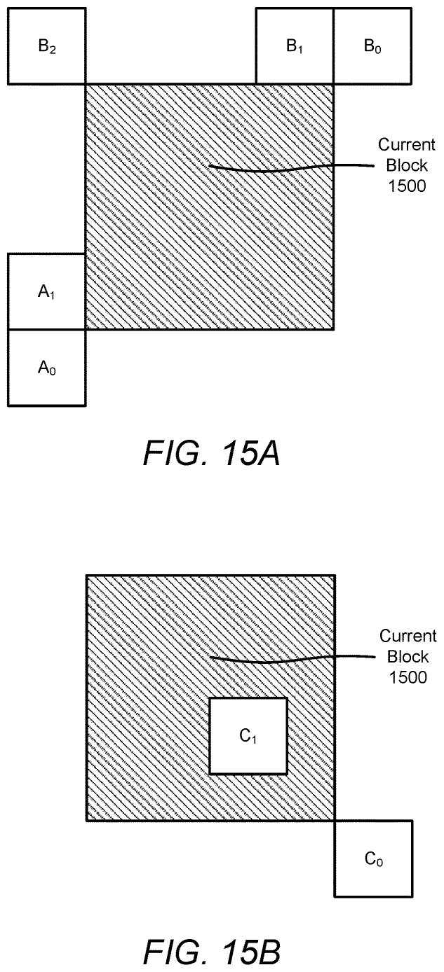

FIG. 14 shows an example of bi-prediction. More specifically, FIG. 14 shows an example of bi-prediction and/or compound prediction performed for a current block. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC). The second picture may succeed the current picture in terms of the POC. The reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. The motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. The encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy)) that indicates a position relative to a position of the current block being coded, the MVD may be represented by two components MVDₓ and MVD_{y}. MVDₓ and MVD_{y} may be determined/calculated as:

$$M V {D}_{x} = M {V}_{x} - M V {P}_{x} , \qquad ( 15 )$$

$$MV {D}_{y} = M {V}_{y} - M V {P}_{y} . \qquad ( 16 )$$

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. The spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AVI, etc.). History-based motion vector prediction (HMVP), combined intra/inter prediction mode (CIIP), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking, and/or SAO filtering).

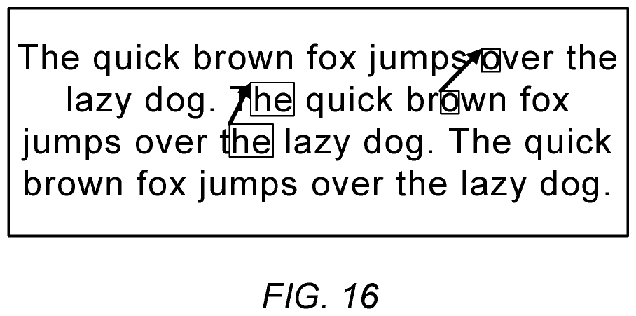

FIG. 16 shows an example of IBC (e.g., an IBC mode or an IntraBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., a prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy)) that indicates a position relative to a position of the current block being coded, the BVD may be represented by two components BVDₓ and BVD_{y}. BVDₓ and BVD_{y} may be determined/calculated as:

$$B V {D}_{x} = B {V}_{x} - B V {P}_{x} , \qquad ( 17 )$$

$$BV {D}_{y} = B {V}_{y} - {BVP}_{y} . \qquad ( 18 )$$

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

The most probable mode (MPM) may refer to a best mode for a current block being coded (e.g., encoded and/or decoded). For example, the MPM may refer to the intra prediction mode (IPM) that is (e.g., most likely to be) the best mode for the current block being encoded or decoded. The MPM may be determined by analyzing the intra prediction modes of the neighboring CUs (e.g., blocks) of a current block (or CU) to be coded (e.g., encoded or decoded), for example, in at least some intra prediction techniques. Video coding may use an MPM list for luma intra prediction. For example, VVC may use an MPM list (e.g., a list of 6 MPMs) may be constructed for luma intra prediction. The MPM list may be derived from the intra prediction modes of the neighboring CUs, and/or may be updated as the encoder progresses through the video frame. When/If encoding a block, the encoder may determine if the current block is a candidate for any of the MPMs in the MPM list. The encoder may compare prediction errors of respective MPMs to determine which MPM from the MPM list is the best mode for the current block, for example, if the current block is a candidate for any of the MPMs in the MPM list. The encoder may evaluate all intra prediction modes (e.g., 67 in VVC) to determine the best mode for the current block, for example, if the current block is not a candidate for any of the MPMs in the MPM list.

The use of MPMs may improve (e.g., significantly improve) the coding efficiency. The use of MPMs may improve (e.g., significantly improve) the coding efficiency because the encoder does not need to signal the intra prediction mode for the current block if such mode is one of the MPMs (e.g., in the MPM list). The encoder does not need to signal the mode number which may require a significant number/quantity of bits. Instead, for example, the encoder may signal an index to the MPM list. The decoder may infer the intra prediction mode for the current block from the corresponding MPM list generated (e.g., reciprocally and identically generated) at the decoder. Advantages such as reduced signaling overhead in the bitstream and increased efficiency may be achieved.

Various types of intra modes may be considered to construct the MPM list. For example, three types of intra modes may be considered to construct the MPM list: default intra modes; neighboring intra modes; and derived intra modes. A unified MPM (e.g., 6-MPM) list may be used for intra blocks, for example, irrespective of whether Multiple Reference Lines (MRL) and Intra Sub-Partitions (ISP) coding tools are applied/used. The MPM list for the current block may be constructed, for example, based on intra modes of neighbor (or neighboring) blocks of the current block. The MPM list for the current block may be constructed, for example, based on intra modes of a left neighbor block (e.g., block corresponding to A1 in FIG. 15A) and an above neighbor block (e.g., block corresponding to B1 in FIG. 15A) of the current block. The intra mode of the left neighbor block may be denoted as Left. The intra mode of the above neighbor block may be denoted as Above. The unified MPM list may be constructed as follows: when/if a neighboring block is not available, its intra mode may be set to planar mode by default; if both modes Left and Above are non-angular modes, then the MPM list may be set to include {planar, DC, V, H, V−4, V+4}, where “V” and “H” may refer to vertical mode and horizontal mode, respectively; if one of modes Left and Above is an angular mode, and the other is non-angular, set a mode Max as the larger mode of Left and Above, and set the MPM list to include {planar, Max, Max−1, Max+1, Max−2, Max+2}; if Left and Above are both angular and are different, set a mode Max as the larger mode in Left and Above and a mode Min as the smaller mode in Left and Above, and if Max−Min is equal to 1, then set the MPM list to include {planar, Left, Above, Min−1, Max+1, Min−2}, if Max−Min is greater than or equal to 62, then set the MPM list to include {planar, Left, Above, Min+1, Max−1, Min+2}, if Max−Min is equal to 2, set the MPM list to include {planar, Left, Above, Min+1, Min−1, Max+1}, or otherwise, set the MPM list to include {planar, Left, Above, Min−1,−Min+1, Max−1}; and if Left and Above are both angular and are the same, set the MPM list to include {planar, Left, Left−1, Left+1, Left−2, Left+2}.

An encoder may encode an MPM index in a bitstream to indicate the position of a selected intra prediction mode in a MPM list to a decoder. The encoder may represent the MPM index as a codeword and may encode (e.g., entropy encode) the codeword into the bitstream. The decoder may derive the MPM list (e.g., in a manner identical to the encoder), and use the MPM index obtained from the codeword decoded from bitstream to obtain the intra prediction mode from the MPM list derived at the decoder. The first bin of codeword, representing the MPM index, may be context coded using an arithmetic coder (e.g., CABAC) so as to achieve additional coding efficiencies. For example, three contexts may be used, corresponding to whether the current intra block is MRL enabled, ISP enabled, or a normal intra block.

Pruning may be used to remove duplicated intra modes. Pruning may be used to remove duplicated intra modes so that the MPM list includes only unique intra modes, for example, during the 6 MPM list generation process. For entropy coding of the 61 non-MPM modes (that is, the 67 modes in VVC minus the 6 MPM), a truncated binary code (TBC) may be used.

The MPM list may be extended to include additional candidates (e.g., 16 additional candidates), and may be divided into two parts: the primary MPM (PMPM) (e.g., including 6 entries) and the secondary MPM (SMPM) (e.g., including 16 entries). The first entry in a general MPM list may be a planar mode. The remaining entries may include the intra modes of the adjacent neighboring blocks corresponding to positions left (L), above (A), below-left (BL), above-right (AR), and above-left (AL) (e.g., shown in FIG. 15A as A1, B1, A0, B0, and B2), and decoder-side intra mode derivation (DIMD) modes which may be sorted in ascending order of a cost such as, for example, SAD, SSD, SATD, etc. Up to a preconfigured/predetermined number/quantity of modes (e.g., 5) with the smallest costs may be added to the MPM list. The cost for a respective MPM (e.g., an IPM corresponding to an entry in the MPM list) may be determined (e.g., computed) between the prediction of the reconstructed samples of the template of the current block and the reconstructed samples. For example, the prediction may be generated by applying/using the respective MPM for the template. Sorted directional modes may be added into the general MPM list, and then into the default modes, until a general MPM list with a predetermined quantity (e.g., 22) entries is constructed. The order of neighboring blocks may correspond to A, L, BL, AR, AL, for example, if a CU block is vertically oriented. The order of neighboring blocks may correspond to L, A, AL, AR, BL, for example, if a CU block is not vertically oriented.

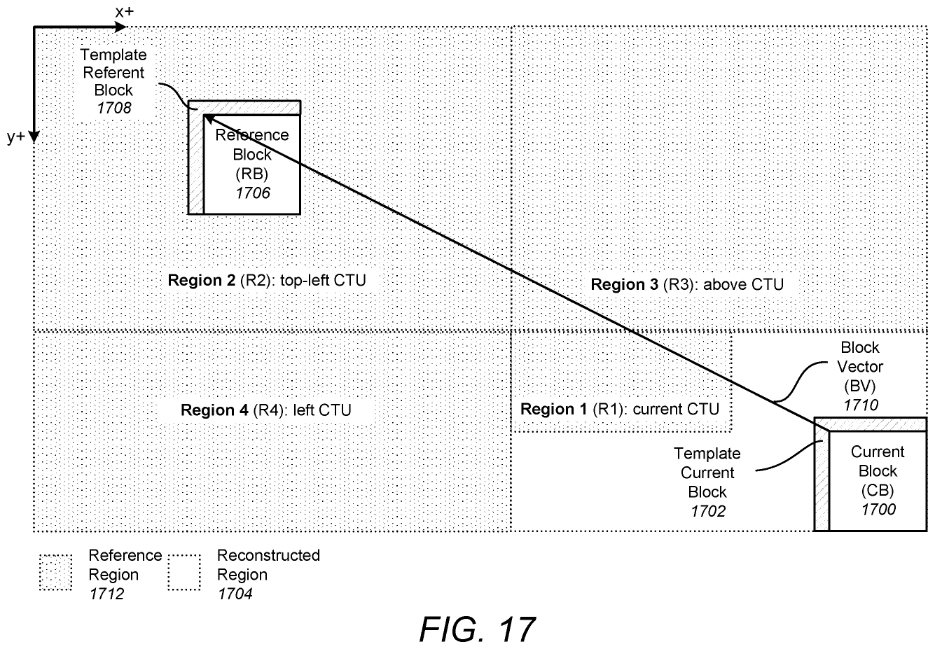

Intra-template matching prediction (IntraTMP) may be a special intra-prediction mode that may select a prediction block within a predetermined reference region (RR) or search area from the reconstructed samples within the current frame. IntraTMP may use a predefined template of the current block to search for a candidate reference block of which the template best matches the template of the current block. FIG. 17 shows an example of intra-template matching prediction (IntraTMP). More specifically, FIG. 17 shows, for an example current block 1700, a reference region 1712 or search area from the reconstructed samples (or reconstructed region) 1704 within which a search is performed for a candidate reference block 1706. The template 1708 (“candidate reference block template”) of the candidate reference block 1706 best matches the template 1702 (“current block template”) of the current block 1700. The reference region may be divided in four rectangular reference regions (e.g., R1, R2, R3, and R4).

A number/quantity of (e.g., N) candidates with lower template costs may be stored in an intraTMP list and ranked by lower cost value (e.g., ascending cost). A number/quantity of (e.g., N) candidates with lower template costs may be stored in an intraTMP list and ranked by lower cost value (e.g., ascending cost), for example, based on determining (e.g., computing) a cost function (e.g., SAD, SATD) between the template 1702 of the current block and the templates of several candidate reference blocks. Each of the candidates with lower template costs may be indicated by a corresponding block vector predictor (BVP) candidate 1710 (BVP candidate may also be referred to herein as block vector (BV) candidate). This process may be performed by both encoder and decoder.

The residual blocks obtained as the difference between the samples of the current block 1700 and the candidate reference blocks 1706 in the list may be determined (e.g., computed), and the reference block with the better rate-distortion performance may be selected as the best intraTMP reference block. An index indicating the position of the best BVP or BV candidate within the intraTMP list may be signaled to the decoder, for example, to facilitate the block decoding using the IntraTMP prediction mode.

Template matching in the reference region 1712 may be performed in a plurality of sub-regions. Template matching in the reference region 1712 may be performed in a plurality of sub-regions (e.g., a set of rectangular sub-regions, e.g., R1 to R4 in the example of FIG. 17), for example, due to the reference region having an irregular (e.g., non-rectangular) shape and to facilitate hardware implementation. The dimensions of the sub-regions may be determined, for example, based on the current block's size and relative position inside the current CTU.

The dimensions of the reference region 1712 comprising all sub-regions (e.g., global reference region) may be determined by the parameters such as SearchRange_w and SearchRange_h. These parameters may be set proportional to the dimensions of the current block 1700 (e.g., CbWidth, CbHeight), for example, by using a multifactor parameter denoted as ‘a’. The multifactor parameter ‘a’ may control the gain/complexity trade-off. The multifactor parameter ‘a’ may be uniform and equal to 5, or may be determined by the current block dimensions based on the following equations:

$$\begin{matrix}SearchRange\_w = a * CbWidth \\ SearchRange\_h = a * CbHeight\end{matrix}$$

The global reference region for block dimensions 4 and 8 may be extended to 64 pixels, based on the following equations:

$$\begin{matrix}SearchRange\_w = max ( 64 , 5 * CbWidth ) \\ SearchRange\_h = max ( 64 , 5 * CbHeight )\end{matrix}$$

This may have the effect of using a variable multifactor parameter ‘ ’ based on the block dimensions, as shown in the following table:

| Block size | 64 | 32 | 16 | 8 | 4 |
|---|---|---|---|---|---|
| Multifactor ‘a’ | 5 | 5 | 5 | 8 | 16 |
| SearchRange_w | 320 | 160 | 80 | 64 | 64 |
| SearchRange_h | 320 | 160 | 80 | 64 | 64 |

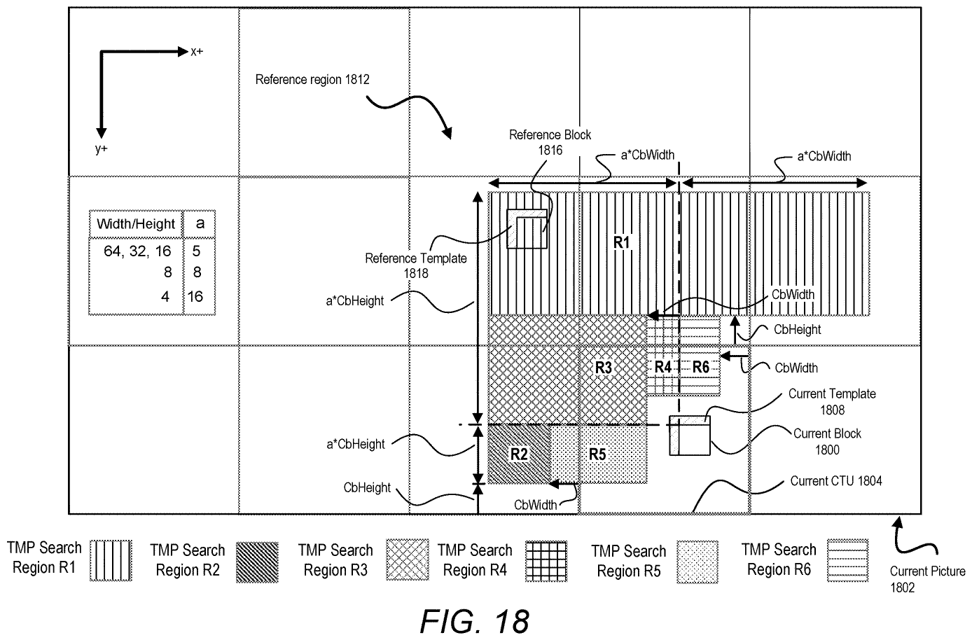

FIG. 18 shows an example of a current block and a reference region. More specifically, FIG. 18 shows a current block 1800 in a current CTU 1804 of a current picture 1802, and a reference region 1812 with examples of identified corresponding TMP search regions R1-R6. Additionally, examples of a reference block 1816, a reference block template 1818, and a current block template 1808 may be shown.

A search process may be performed in two steps: a sparse search step, and a refinement search step. A search process may be performed in two steps: a sparse search step, and a refinement search step, for example, to reduce the high computational burden of an exhaustive template matching search in the whole reference region.

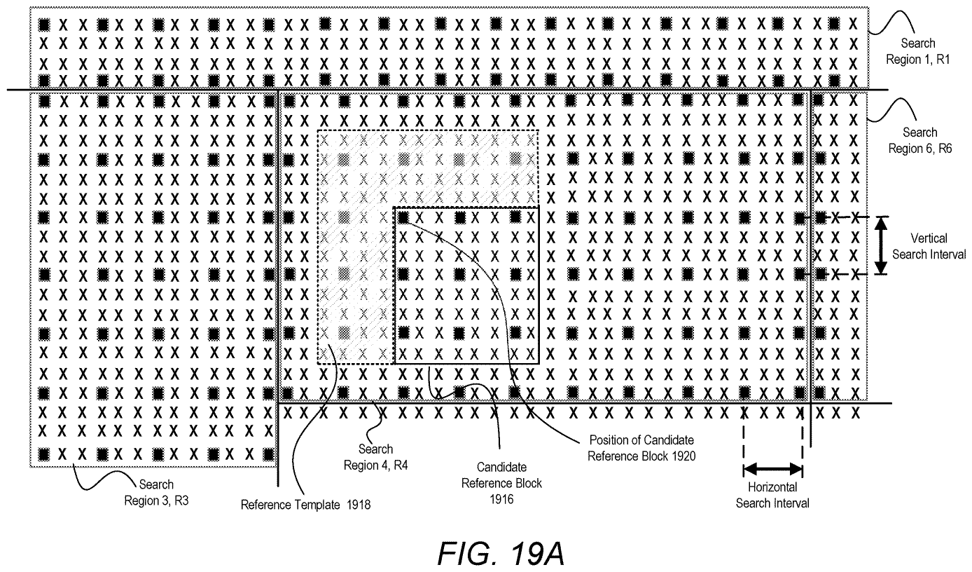

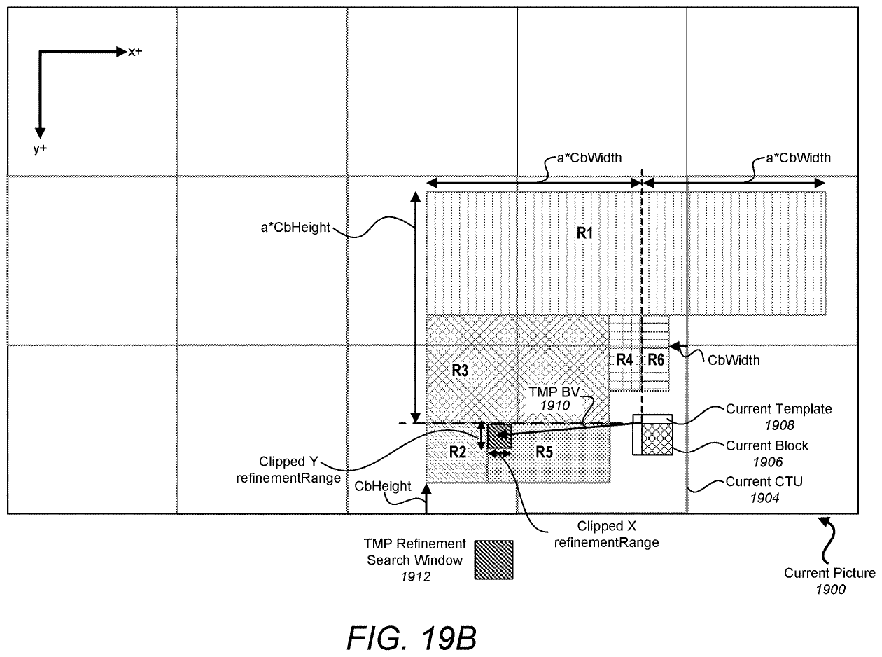

FIG. 19A shows an example of a sparse search (e.g., of IntraTMP). The sparse search may be performed in a regular grid using a subsampling interval (e.g., 3 pixels or 4 pixels) in the horizontal and vertical directions. In the example, the subsampling interval may be 3. In some other examples, the subsampling interval may be greater than 3 (e.g., 4). FIG. 19A shows an example candidate reference block 1916 in a search region 4 (R4) and a corresponding reference template 1918. The template cost may be determined (e.g., computed) for each reference block position (or position of candidate reference block) within a search region (e.g., reference block position 1920 of reference block 1916). BVP candidates associated with the best (e.g., least cost) reference blocks may be recorded in a list (e.g., Sparse List) and sorted in an (e.g., ascending) order based on the cost. Subsample positions may be shown in the form of dark squares in/within the reference region. Subsample positions may be separately determined for each search region. The size of the list (e.g., Sparse List) may be set/determined, for example, to 30.

The refinement search (which is the second step of the search) may be a refinement of the reference block candidates (e.g., BVP candidates) in the list (e.g., Sparse List). Refinement may be made in a refinement window (or refinement search window, search window, refine window) around the reference block candidates from the sparse search, using a sampling interval. For example, refinement may be made in a window of a predetermined size (e.g., 3×3 pixels or 5×5 pixels) around the respective sparse BVP candidates using a sampling interval of 1. In addition to the sparse BVP, one or more additional BVP candidates may be generated within the refinement search window at the integer pixel positions. If the refinement window (or refine window) crosses into another search region, the refinement window may be clipped to the region boundary to which the candidate(s) may belong. FIG. 19B shows an example block vector. More specifically, FIG. 19B shows a block vector according to IntraTMP where the block vector's refinement window is clipped at the boundary of a search region. FIG. 19B shows a current block 1906 and a current template 1908 located in a current CTU 1904 of a current frame 1900 (or current picture), a corresponding reference region with respective search regions R1-R6, and an example BVP 1910. A refinement search window 1912 of the example BVP 1910 may be clipped where R5 (a search region in which the BVP 1910 is located) borders R2 and R3. The candidates (e.g., 19 candidates) with the lowest template costs (e.g., SAD costs) among the generated additional candidates and the sparse BVP candidates may be selected, for example, for a Refined Intra TMP list.

The encoder/decoder may select among different intraTMP sub-modes by checking the rate-distortion performance of each sub-mode. The encoder/decoder may select among different intraTMP sub-modes by checking the rate-distortion performance of each sub-mode, for example, based on that the encoder/decoder has constructed the Refined IntraTMP List. An IntraTMP sub-mode may be signaled to the decoder in combination with an index to the best candidate in the Refined IntraTMP List or a cluster of candidates (e.g. the Fusion mode). The IntraTMP sub-mode may be a single predictor sub-mode, a fusion sub-mode, a sub-pel precision sub-mode, and/or a linear filter model sub-mode. In the single predictor sub-mode, a single BVP candidate may be selected from the Refined IntraTMP List and signaled to the decoder. In the fusion sub-mode, multiple BVP candidates may be blended to derive the final BV prediction block. The blending weights may be determined (e.g., computed) either from the template matching cost of each predictor or with a Wiener-filter-based weight derivation method. In the sub-pel precision sub-mode, when a single predictor is used, sub-pel precision may be used with 1/2-pel precision, 1/4-pel precision, and 3/4-pel precision, each with 8 possible directions. In the linear filter model sub-mode, a linear filter may be learned between the reference and current templates and applied to (e.g., used for) the reference block. This mode may be used for a single predictor, for example, if/when sub-pel precision is not used and a single predictor may be used.

Several types of template shapes may be used. Several types of template shapes may be used, for example, for at least some examples of IntraTMP. Five types of templates have been proposed according to the current block location in the frame: a top template type, a left template type, an L-shaped template type, an only-top template type, and an only-left template type.

The top template type may be used, for example, if/when only the top samples of a current block are available (e.g., if/when the current block is located at/on the left boundary of a picture). TMP cost may be determined (e.g., computed) using the top samples of both the current block and a reference block. A top template may be, for example, four samples in height.

The left template type may be used, for example, if/when only the left samples of a current block are available (e.g., if/when the current block is located at/on the top boundary of a picture). TMP cost may be determined (e.g., computed) using the left samples of both the current block and a reference block. A left template may be, for example, four samples in width.

The L-shaped template type may be used in the other cases (e.g., a current block is not located at the top or left boundary of a picture) where samples surrounding the current block included in an L-Shape are available. TMP cost may be determined (e.g., computed) using an L-shaped template of both the current block and a reference block. The L-shaped template may be, for example, four samples in width and height.

The L-shaped template may introduce two more template types: the Only-Top (Only-T) and Only-Left (Only-L) templates. In addition to the TMP cost of the L-shaped template, the TMP cost for the Only-T and Only-L templates may be determined (e.g., computed), and the best BV candidates (e.g., N candidates, N referring to number or quantity) may be stored in different Only-T and Only-L lists.

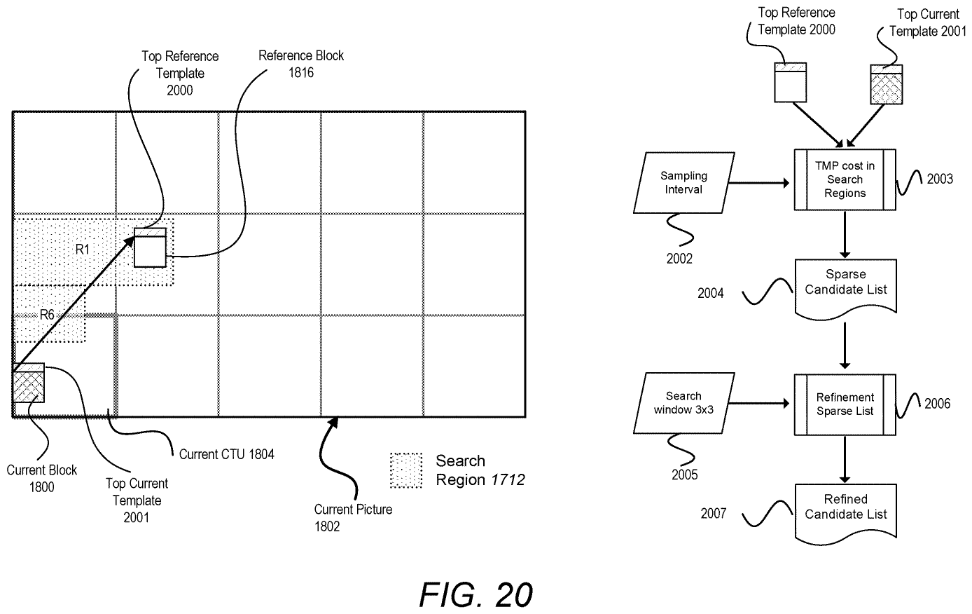

FIG. 20 shows an example of the top template type (e.g., as used in IntraTMP). Only the top templates (e.g., a template 2001 of a current block 1800 and a template 2000 of a reference block 1816) may be used for the TMP cost determination (e.g., computation) in a sparse search 2003. The sparse search 2003 may be determined (e.g., computed) using a sampling interval (SI) 2002 (e.g., of three), and a sparse candidate list (e.g., Sparse List) 2004 may be generated (e.g., built) using the best (lowest cost) BV candidates (e.g., 30 BV candidates). Those candidates may be refined in a refinement search 2006 using a window (e.g., 3×3 window) 2005 with an SI (e.g., of 1), and a refined candidate list 2007 may be generated (e.g., built).

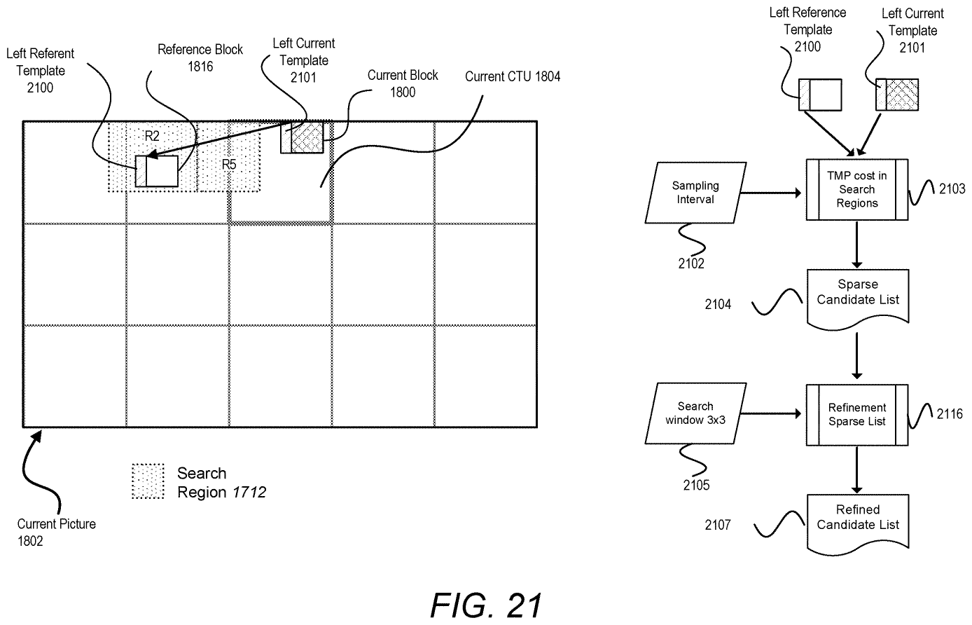

FIG. 21 shows an example of the left template type (e.g., as used in IntraTMP). The same top template type logic may be applied/used for the left template type. A left template 2100 of a reference block 1816 and a left template 2101 of a current block 1800 may be used, for example, instead of top templates (e.g., as shown in FIG. 20). The TMP cost determination (e.g., calculation) in a sparse search 2103, a sampling interval 2102 for the sparse search, sparse candidate list 2104, a refinement search 2116 (e.g., refinement of the sparse list), a refinement search window 2105, and a refined candidate list 2107 of the left template process shown in FIG. 21 may be identical (except for the use of a left template instead of a top template) to those described with respect to FIG. 20 (e.g., 2003, 2002, 2004, 2006, 2005, and 2007 in FIG. 20).

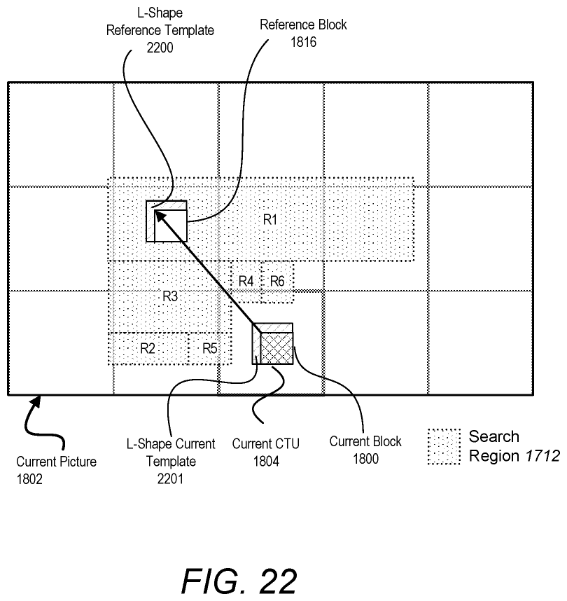

FIG. 22 shows an example of the L-shaped template type (e.g., as used in IntraTMP). A current block 1800 may have an available (e.g., reconstructed samples are available for) L-shaped template 2201. For example, reconstructed samples may be available for the L-shaped template 2201. An L-shaped template 2200 of a reference block 1816 may be used to determine (e.g., compute) the L-shape TMP cost in all search regions, as described herein for the top template type and the left template type.

In addition to the L-shape TMP cost, the Only-Top TMP cost and Only-Left TMP cost may be determined (e.g., computed). A sparse search may generate (e.g., build) three sparse candidate lists (e.g., Sparse Lists). The three sparse candidate lists may comprise one Sparse L-Shape List (e.g., with a size of 30 BV candidates), and two additional lists: a Sparse Only-T List and a Sparse Only-L List (e.g., both with a length of 6 BV candidates).

These three sparse candidate lists may be refined by determining (e.g., computing) the cost of respective template type using a refinement search window (e.g., of 3×3). The best BV candidates (e.g., N candidates) may be candidates that have obtained the lower (e.g., lowest) TMP costs. The best BV candidates may be stored in three refined lists: a Refined L-Shape List (e.g., with a size of 19 BV candidates), a Refined Only-T List (e.g., with a length of 3 BV candidates), and a Refined Only-L List (e.g., with a length of 3 BV candidates). The final IntraTMP list may have 19 candidates as the L-Shape List. The final IntraTMP list may be a combination of the BV candidates in the Refined L-Shape List, the Refined Only-T List, and the Refined Only-L List.

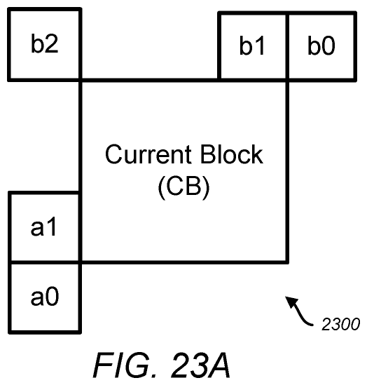

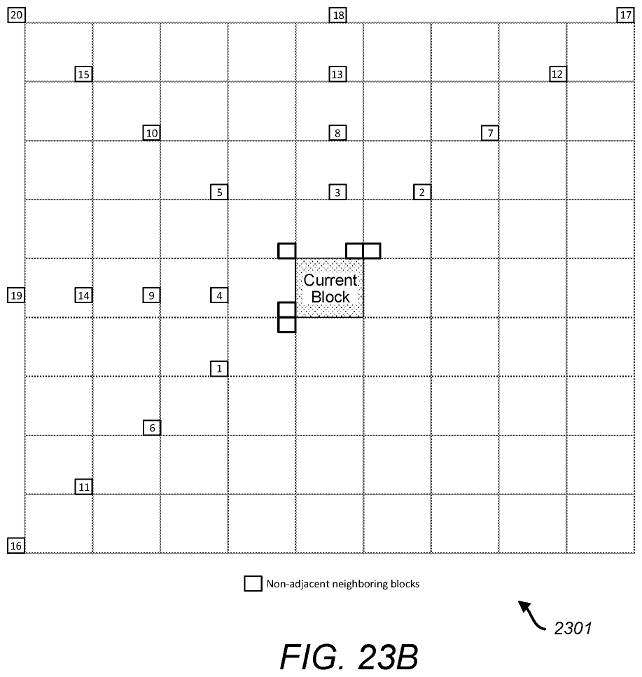

A set of merge BVP candidates may be generated using another technique called “Intra TMP with merge candidates.”, in addition to the sparse BVP candidates obtained by TMP searching within the RR in IntraTMP. Merge BVP candidates may be a subset of the IBC merge candidates, including only the spatial candidates of the current block. The TMP merge BVP candidates may use the 5 adjacent BVs from the adjacent blocks (e.g., 2300 in FIG. 23A) and multiple (e.g., 20) non-adjacent BV candidates (e.g., 2301 in FIG. 23B) from the non-adjacent neighboring blocks encoded using an IBC or TMP mode.

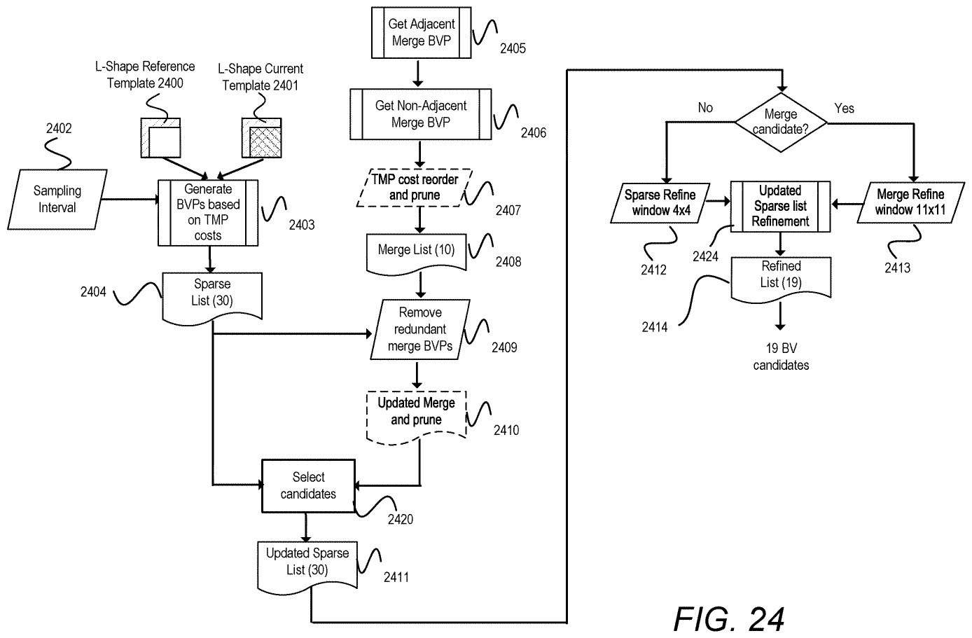

An example of the IntraTMP with merge candidates process is shown in FIG. 24. For example, a maximum of 50 BVP candidates including BVP candidates 2405 from the adjacent blocks and BVP candidates 2406 from non-adjacent blocks may be reordered and pruned in step 2407 to remove duplicate BVP candidates. The BVP candidates may be ranked in an ascending order based on the associated TMP costs, and the best 10 candidates (candidates with the lowest TMP costs) may be selected to generate the TMP merge list 2408. The TMP merge list 2408 can be ordered ascendingly according to the TMP costs of the BVP candidates. The BVP candidates in the TMP merge list 2408 may also be referred to as “merge BVP candidates.” A sparse list 2404 may be generated at step 2403 for the current block, as described above in relation to IntraTMP. For example, the sparse list 2404 may be generated by calculating TMP costs for reference templates (e.g., L-shape reference templates) 2400 and the current block's template 2401 in search regions using a predetermined sampling interval 2402. Up to 10 top merge BVP candidates in the TMP merge list 2408 may be checked in the sparse list 2404 for duplicates, and the redundant BVPs in the TMP merge list 2408 may be removed in step 2409 to generate the updated TMP merge list 2410. The merge BVP candidate list may be only pruned after the redundant checking at 2410. The merge BVP candidates list may not be reordered based on the TMP. The merge BVP candidates may be ordered according to their position relative to the Sparse search regions, ranking the BVP outside the Sparse search regions first and thereafter consecutively ordering the candidates overlapping any Sparse search regions (inner BV candidates). At least some implementation may not prune and reorder the merge BVP candidate list.

The merge BVP candidates from the updated TMP merge list 2410 may be considered along with the BVP candidates in the sparse list 2404 to select (e.g., based on the TMP costs) the candidates at step 2420 for refinement. The best 30 candidates (e.g., having the lowest TMP costs) may be selected to form the updated sparse list 2411.

BVP candidates in the updated sparse list 2411 may be refined at step 2424 using a refinement search window (also referred to as a “search window” or “refinement window”) to generate a refined candidates list 2414. The refinement search window for a BVP candidate may have a fixed window size that depends on the type of the BVP candidate. For example, BVP candidates generated from the sparse searching in the regular TMP reference region (in the initial sparse list 2404) may use a 4×4 refinement window 2412 (with a sampling interval of 4 samples). BVP candidates from the updated TMP merge list 2410, inside or outside the regular reference region, can use a search window size of 11×11 samples 2413 for refinement. In some implementations, the refined candidate list 2414 includes 19 BV candidates.

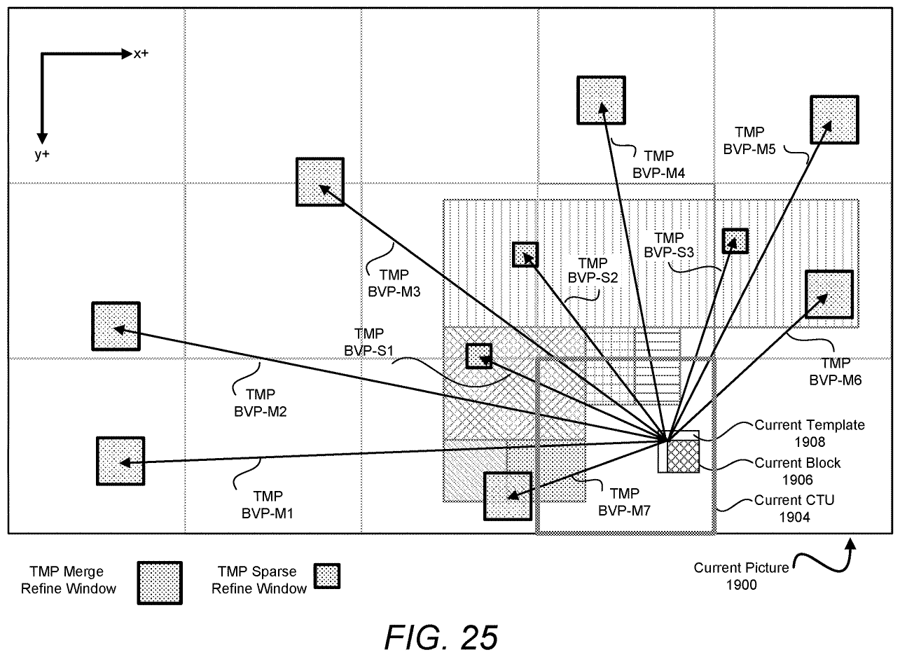

FIG. 25 depicts an example of refinement windows of 5 merge BVP candidates (BVP-M1 to BVP-M5) located outside of the regular TMP reference region, one merge BVP candidate (BVP-M6) located inside the regular TMP reference region, and one merge BVP candidate (BVP-M7) which is partially overlapping with the regular TMP reference region. FIG. 25 also shows an example of refinement windows of three sparse BVP candidates (BVP-S1 to BVP-S3) positioned within the regular TMP reference region.

IntraTMP with Merge Candidates is described in K. Naser et al, “EE2-1.2: IntraTMP with Merge Candidates,” JVET-AG0151, January 2024, the content of which is herein incorporated by reference. At least another technique, known as Auto-relocated block vector prediction (AR-BVP), may be used in the construction of the AMVP and/or merge IBC list. A guiding BV may be selected from the BVP candidates in the AMVP and/or merge IBC list. A BV (referred to herein as a “coding BV”) pointing to a reference block of a block containing a position derived relative to a position pointed to by the guiding BV may be identified. An AR-BVP candidate may be determined as the combination of the guiding BV and the identified coding BV. For example, the coding BV may be similar to a block vector displacement (BVD) in AMVP IBC.

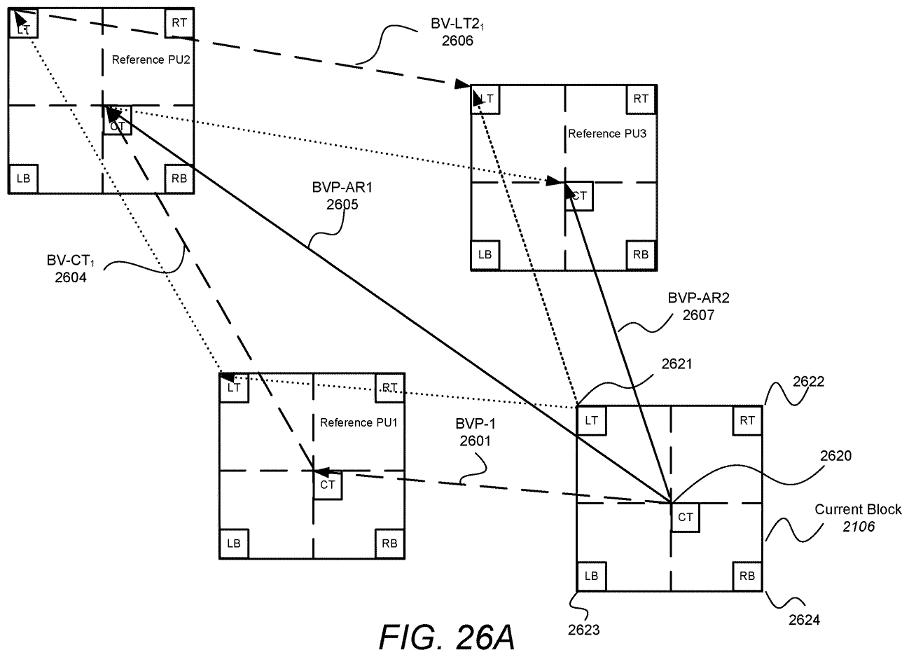

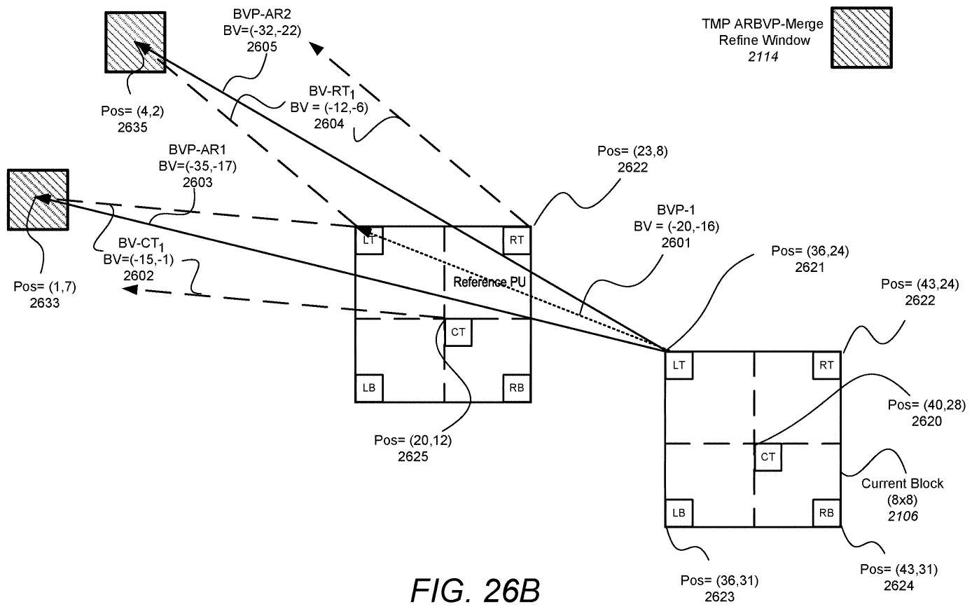

FIG. 26A shows an example of an auto-relocated block vector prediction (AR-BVP). Specifically, FIG. 26A shows an example of AR-BVP used/applied to IBC where the guiding BV (BV-1) 2601 is a BVP candidate in the IBC list. The guiding BV may be used to identify a first reference block (e.g., reference PU1), and five positions of the first reference block that are aligned with the five positions of the current block 2106 are also identified. Each of the five positions may be checked to determine if a coding block containing the sample at the position is encoded/decoded using the IBC mode or IntraTMP mode. These positions may be denoted correspond to the center of block (CT) 2620, left-top (LT) 2621, right-top (TR) 2622, left-bottom (LB) 2623, and right-bottom (RB) 2624. The block vector used to indicate the reference block of the first reference block may be used as the coding BV to combine with the guiding BV, for example, if the AR-BVP is used in IBC and a block containing a sample at a position of at least one of the five positions (CT, LT, RT, LB, and RB) defined relative to the first reference block was coded (e.g., encoded and/or decoded) using IntraTMP or IBC mode.

FIG. 26A further shows one example of multiple candidate AR BVPs iteratively derived from the initial guiding BV 2601. Guiding BV 2601 may point to the first reference block (PU1). The five positions of the first reference block PU1, corresponding to the guiding BV 2601, may be used/applied to the five respective positions (CT, LT, RT, LB, and RB) of current block 2106. Each of the five positions of the first reference block may be checked to determine if a block at any of those positions was coded in an IBC or IntraTMP mode. A block at the position CT of the first reference block may be determined to be coded using BV-CT1 2604. BV-CT1 2604 may be used/applied to the first reference block to determine a second reference block (reference PU2), from which five positions of the second reference block may be checked to derive one or more AR-BVPs. The first AR-BVP candidate (BVP-AR1) 2605 may be derived as the addition of the guiding BV 2601 and the coding BV (BV-CT1) 2604 used for the encoding and/or decoding of the block containing/at position CT of the first reference block. The second AR-BVP candidate, BV-AR2 2607, may be derived as the addition of previous AR-BVP (BVP-AR1 2605) and a block vector BV-LT2₁ 2606 derived from a block at LT position of the second reference block (reference PU2). Each of the five positions of the second reference block (reference PU2) may be checked to determine if a block containing the sample at those respective positions was coded (e.g., encoded and/or decoded) in an IntraTMP or IBC mode. The block at the LT position may satisfy the condition and was coded using BV-LT2₁ 2606, which points to a third reference block (reference PU3).

This cascading process may be iterated multiple times and referred to a number of hops. The cascading process may be constrained to one hop. For example, BVP-AR1 2605 may be added as a candidate AR BVP derived from BVP-1 2601, and BVP-AR2 2607, which corresponds to a second hop, would not be determined and added as a second candidate AR BVP.

The AR-BVP candidates 2605 (and 2607) may be included in the AMVP and/or merge lists after the spatial adjacent candidates. AR-BVP candidates 2605 (and 2607) may be included in the AMVP and/or merge lists after the spatial non-adjacent candidates. AR-BVP candidates 2305 (and 2307) may be included in the AMVP and/or merge lists after the HMVP candidates.

AR-BVP technique may be implemented for IntraTMP and may be referred to as IntraTMP AR-BVP merge. This technique may use the BVPs in the IntraTMP merge list as guiding BVs for the AR-BVP process.

The TMP AR-BVP candidates, 2605 and 2607, may be included in the TMP merge lists after the adjacent and non-adjacent merge candidates. TMP AR-BVP candidates 2605 and 2607 and the adjacent and the non-adjacent merge candidates may be sorted in an ascending order of the TMP costs within the TMP merge list. The merge candidates (adjacent and non-adjacent candidates) and the AR-BVP candidates outside the TMP reference region may be included first within the TMP merge list.

The refinement window for the AR-BVP candidates may have a different window size than that of the TMP merge candidates and the TMP sparse candidates. FIG. 26B shows examples of refinement windows for AR-BVP candidates derived from different positions associated with the initial guiding BV 2601. The first AR-BVP candidate (BVP-AR1) 2603 may be derived as the addition of the guiding BV 2601 and the coding BV (BV-CT1) 2602 used for the encoding/decoding of a block containing the central position (CT) of the reference block (reference PU). The guiding BV 2601 may be shown as starting from the upper left conner of the current block 2106 because the BVs of a block are typically referenced with respect to the upper left conner of the block. The BV associated with the block containing the central position CT, BV-CT1 2602, may be shifted based on the guiding BV 2601 so that the addition of these two BVs can generate AR-BVP candidate BVP-AR1 2603. Similarly, another AR-BVP candidate, BV-RT1 2605, may be derived based on the BV associated with a block containing the sample at the RT position of the reference block. An AR-BVP candidate may be refined with a refinement window 2114. Specific refinement window 2114 for a given AR-BVP candidate may be set according to the AR-BVP candidate. Positions 2633 and 2635 pointed to by BVP-AR1 2603 and BVP-AR2 2605, respectively, may be used to determine the respective refinement windows.

The following source code is an example implementation for obtaining the five positions relative to a guiding BV and determining if a block at each of the five positions is coded based on IBC or IntraTMP mode:

```
const PredictionUnit& pu = *cs.getPU(area.pos( ), CHANNEL_TYPE_LUMA); // pu
is the top left corner of the CB
  // posCand indicate the 5 offset positions related to the CB. The pu position is equal to
the topleft( ) not center( )
  Position posCand[5] ={pu.Y( ).center( ),pu.Y( ).topLeft( ),pu.Y( ).topRight( ),
pu.Y( ).bottomLeft( ),pu.Y( ).bottomRight( ) };
// EXAMPLE
pu: {PU: x = 32, y = 24, width = 8, height = 8}
posCand = {{x=36 y=28 }, {x=32 y=24 }, {x=39 y=24 }, {x=32 y=31 }, {x=39 y=31
}}
// Loop FOR to test the five positions around a first IBC Merge/AMVP candidate or
TMP merge candidate
// bvBasedMergeCandidatesITMP_AR is the list of TMP merge candidates
  for (int mergeIndex = 0; (mergeIndex < 25) &&
(bvBasedMergeCandidatesITMP_AR.size( ) < totalNum); mergeIndex++)
  {
    cMv_Sparse = SparseCandidatesITMP[mergeIndex];
    offsetX = cMv_Sparse.m_pX;
    offsetY = cMv_Sparse.m_pY;
    cMv = Mv(offsetX, offsetY); // This is the Merge candidate to use as base for the
AR-BVP
        for (int n = 0; n < 5 && bvBasedMergeCandidatesITMP_AR.size( ) < totalNum;
n++)// Check the 5 positions around the Merge BV
    {
      // puCascadedid the Merge candidate + one of the offset (CT, TL, TR, BL, BR)
      const PredictionUnit* puCascaded = pu.cs-
>getPURestricted(posCand[n].offset(offsetX, offsetY), pu, pu.chType);
      if (!puCascaded ∥ ((puCascaded->cu->predMode != MODE_IBC) &&
(!puCascaded->cu->tmpFlag)))
      {
        continue; // If the block in that position was not encoded with IBC or TMP, skip
it and go to the next among the 5
      }
      Mv arbv = cMv + puCascaded->bv; //Build the AR-BVP candidate
      // Check if reference block pointed out for the AR-BVP is already decoded
      if (PU::validItmpBv(pu, arbv.hor, arbv.ver))
      {
        if (!PU::CheckBvAvailable(bvBasedMergeCandidatesITMP, arbv) &&
!PU::CheckBvAvailable(bvBasedMergeCandidatesITMP_AR, arbv))
        {
          // If the AR-BVP is valid and it is not already in the TMP merge list, it is added
at the end of the TMP Merge list
          bvBasedMergeCandidatesITMP_AR.push_back(arbv);
          if (bvBasedMergeCandidatesITMP_AR.size( ) >= totalNum)
          {
            break; // If the list is complete, finish the TMP AR-BVP process
          }
        }
      }
```

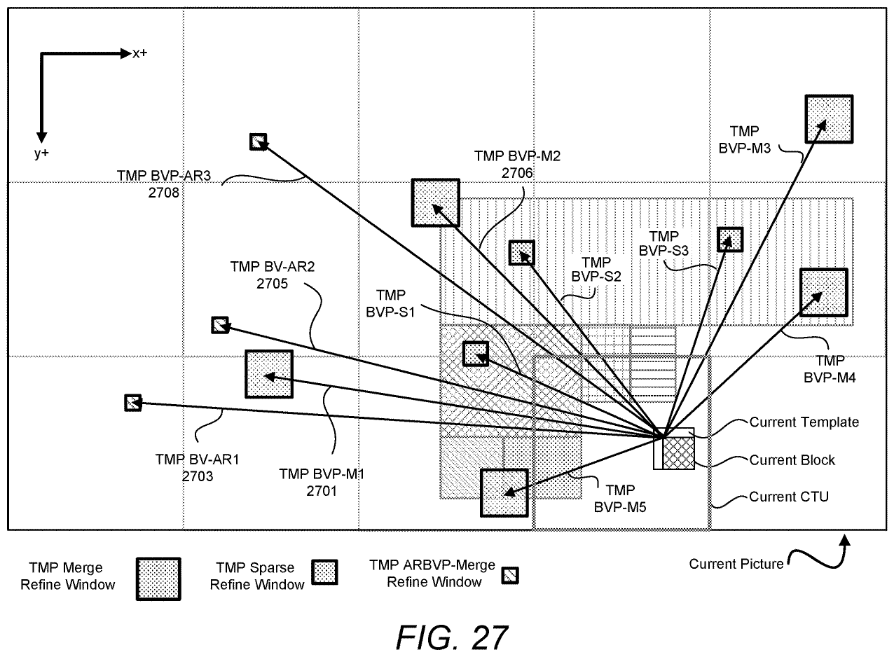

FIG. 27 shows an example of IntraTMP with BVP candidates derived using IntraTMP AR-BVP merge. Specifically, FIG. 27 shows one example of IntraTMP with BVP candidates derived using IntraTMP AR-BVP merge as discussed herein with respect to FIGS. 26A and 26B. Concerning the example shown in FIG. 27, TMP merge candidate BVP-M1 2701 pointing to a location outside the TMP reference region may be used as a guiding BV to derive two AR-BVP candidates, BV-AR1 2703 and BV-AR2 2705. Likewise, TMP Merge candidate BVP-M2 2706 is used as guiding BV to derive a new ARBVP candidate BV-AR3 2708.

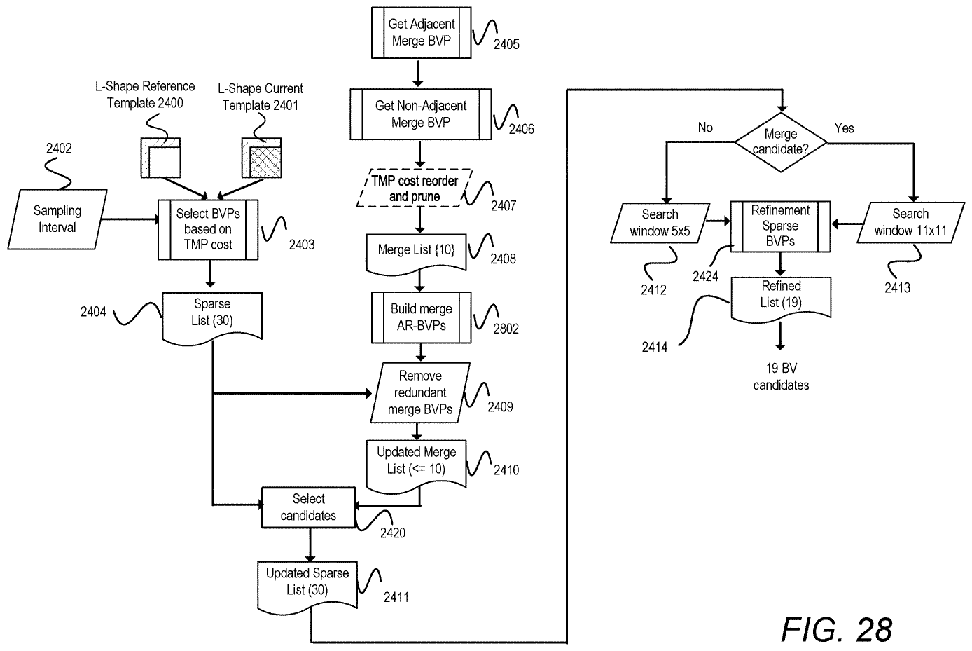

FIG. 28 shows an example of the IntraTMP AR-BVP merge process. The process shown in FIG. 28 is similar to the process shown in FIG. 24 except that at step 2802 is added to use/apply the AR-BVP to the merge list 2408 to generate AR-BVP candidates using the BVPs in the merge list 2408 as guiding BVs. Step 2409 is used/applied to the merge list 2408 and the generated AR-BVP candidates.

As discussed herein, the AR-BVP technique may be used/applied to TMP merge candidates in the initial merge list 2408 to derive additional BVP candidates (referred to as “merge AR-BVP candidates”) to be used in generating an updated merge list 2410. The AR-BVP technique may be used/applied to TMP merge candidates in the initial merge list 2408, for example, after reordering in accordance with TMP cost and pruning to a predetermined number at step 2407, to derive additional BVP candidates (referred to as “merge AR-BVP candidates”) to be used in generating an updated merge list 2410. The number of TMP merge candidates in the initial merge list 2408 may be small for reasons such as a limited number of the adjacent and non-adjacent blocks being coded (e.g., encoded or decoded) using the IBC mode or the IntraTMP mode, the BVs of such adjacent and non-adjacent neighboring blocks being invalid, or the candidates derived from these merge candidates being duplicated in the list. This may lead to a small number of merge AR-BVP candidates being generated which significantly reduces the efficiency of the AR-BVP merge technique.

Examples described herein relate to the use of the AR-BVP technique on TMP BVP candidates to derive additional BVP candidates to provide diversity of candidates. The AR-BVP technique may be used/applied to the BVP candidates derived in a search process using the TMP such as the sparse list to generate sparse AR-BVP candidates for use in the IntraTMP coding. The number of candidates in the sparse list is typically larger than the number of BV candidates in the initial merge list 2408. Consequently, there can be more derived sparse AR-BVP candidates than the merge AR-BVP candidates, leading to better BVP candidates to be selected for the refinement stage.

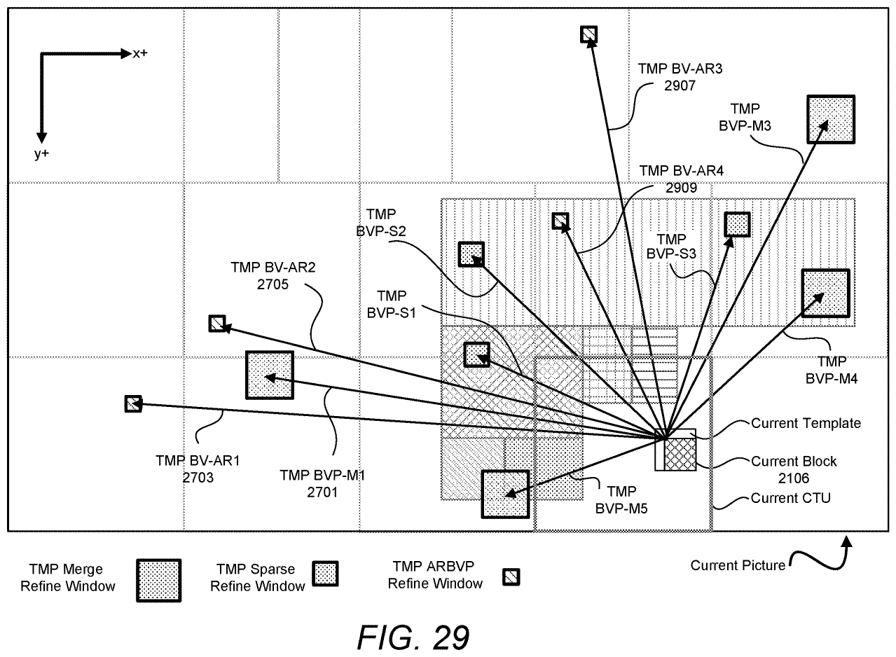

FIG. 29 shows an example of sparse AR-BVP candidates in IntraTMP. Specifically, FIG. 29 shows an example of sparse AR-BVP candidates in IntraTMP generated by using/applying the AR-BVP technique to the TMP BV candidates. Compared with FIG. 27, in addition to the BV-AR1 2703 and BV-AR2 2705, which may be merge AR-BVP candidates derived from the BVP-M1 merge candidate as explained herein, a few sparse AR-BVP candidates may be generated. The sparse candidate TMP BVP-S2 may be used as a guiding BV, from which two new sparse ARBVP candidates, BV-AR3 2907 and BV-AR4 2909 may be derived using the AR-BVP technique as discussed herein with respect to FIGS. 25-26B.

The five positions used to determine the coding BVs for deriving the sparse AR-BVP candidates may be based on the size of current block 2106, as explained herein with respect to FIGS. 26A-B. The reference block of the current block may be the same size as the current block and thus the size of the reference block may determine the five positions, CT, LT, RT, LB, and RB in the reference block. The five positions used to determine the coding BVs for deriving the sparse AR-BVP candidates may be based on the size of the refinement window at the position pointed to by the TMP sparse BVP candidate. The positions may include a first position pointed to by the TMP sparse BVP candidate in the sparse list and the four corners of the refinement window centered at the first position.

The TMP sparse AR-BVP candidates 2907 and 2909 may be included in the TMP merge lists after the adjacent and non-adjacent merge candidates. The TMP sparse AR-BVP candidates 2907 and 2909 may be included in the TMP merge lists, for example, after adding BVP candidates from lists 2405 and 2406 of FIG. 24 or FIG. 28. TMP sparse AR-BVP candidates 2907 and 2909, and the adjacent and the non-adjacent merge candidates may be sorted in an ascending order based on the TMP costs within the TMP merge list. The merge candidates (e.g., adjacent and non-adjacent), and the AR-BVP candidates pointing outside of the TMP reference region may be included first within the TMP merge list before other candidates. The refinement window for the sparse AR-BVP candidates may use a different refinement window size than that of the TMP merge candidates and the TMP sparse candidates as shown for example in FIG. 29.

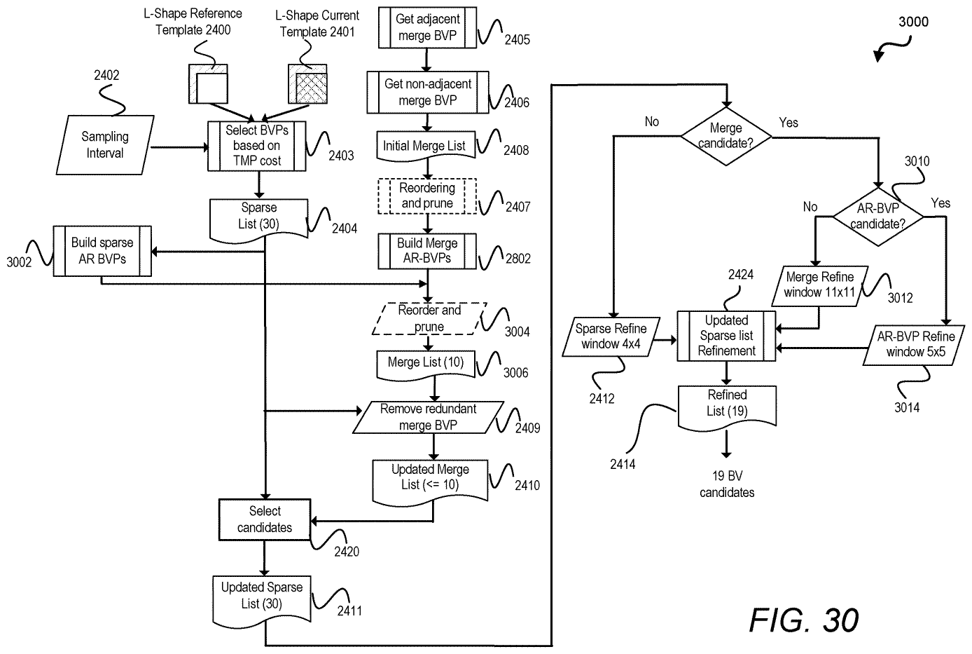

FIG. 30 shows an example process for applying TMP sparse AR-BVP candidates to the TMP. Specifically, FIG. 30 shows an example process 3000 for using/applying TMP sparse AR-BVP candidates to the TMP. Process 3000 may be performed at the encoder and the decoder to generate the same refined list 2414 at step 2424. Operations of process 3000 that have the same labels as those in FIGS. 24 and 28 may be performed in the same or similar way.

Compared with FIG. 28, process 3000 may include a new step 3002, which may generate one or more sparse AR-BVP candidates from BVP candidates in sparse list 2404. The sparse AR BVP candidates may be derived, for example, by setting each BVP candidate in sparse list 2404 as a guiding BV, as explained herein with respect to FIGS. 25-29. For a BVP in the sparse list 2404, the reference block pointed to by the BVP may be identified. Five locations, such as the CT, LT, LB, RT, and RB, of the reference block may be determined. For each of the five locations, the coding block that contains the sample at the location may be identified and the associated coding mode of the coding block may be determined. The BV of the coding block (coding BV) may be combined with the guiding BV to generate the sparse AR-BVP candidate. The BV of the coding block (coding BV) may be combined with the guiding BV to generate the sparse AR-BVP candidate, for example, if the coding block is coded using an intra prediction mode having a BV associated therewith (e.g., the IntraTMP mode or the IBC mode). The remaining locations may be evaluated similarly. The same process may be repeated for other BVP candidates in the sparse list 2404 to generate additional sparse AR-BVP candidates.

Operations at step 3002 may be performed, for example, after obtaining adjacent and non-adjacent BVP candidates of lists 2405 and 2406, respectively. Operations at step 3002 may be performed, for example, before operations of obtaining BVP candidates of lists 2405 and 2406. The various candidates such as adjacent candidates 2405, non-adjacent candidates 2406, merge AR-BVP candidates (step 2802) and sparse AR-BVP candidates (step 3002) may be reordered and/or pruned at step 3004 to generate the resulting merge list 3006. The merge list 2408 before the sparse AR-BVP candidates and the merge AR-BVP candidates may be added is referred to as the initial merge list 2408.

As shown in FIG. 30, the refinement search window for AR-BVP candidates (merge AR-BVP candidates and sparse AR-BVP candidates) may be set to be different from other merge candidates. A determination step 3010 may be added to determine whether a merge BVP candidate is an AR-BVP candidate. The refinement search window 3012 may be set to a size used before the AR-BVP technique is used/applied (e.g., 11×11). The refinement search window 3012 may be set to a size used before the AR-BVP technique is used/applied (e.g., 11×11), for example, if the merge BVP candidate is not an AR-BVP candidate. The refinement search window 3014 may be set to be a smaller size (e.g., 5×5). The refinement search window 3014 may be set to be a smaller size (e.g., 5×5), for example, if the merge BVP candidate is an AR-BVP candidate. The refinement search window for merge candidates in the initial merge list 2408 may have a larger size than that of the AR-BVP candidates. Thus, the refinement search at step 2424 may be performed on candidates having 4×4 refinement windows 2412, candidates having 5×5 refinement windows 3014, and candidates having 11×11 refinement windows 3012.

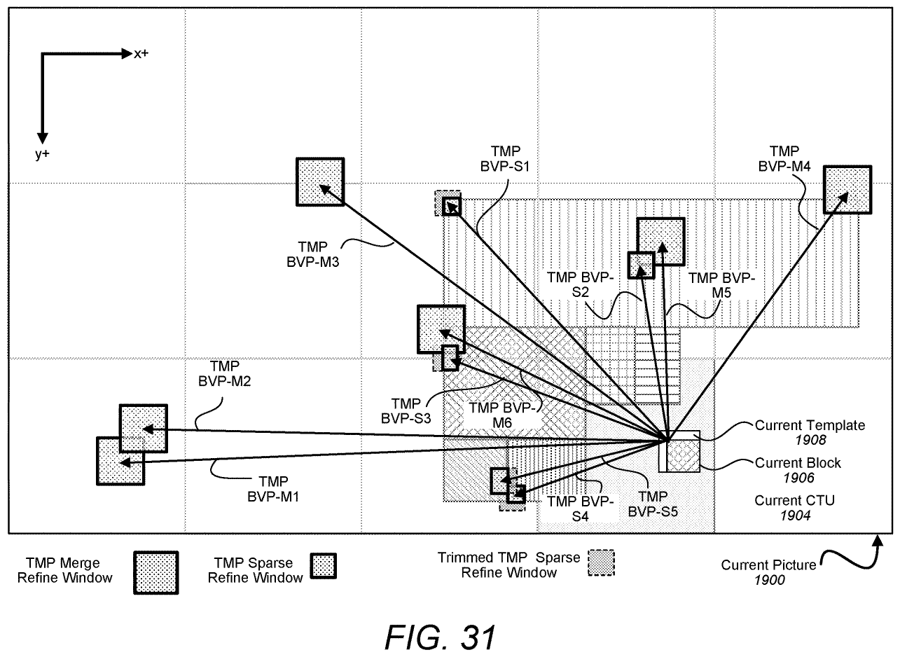

The refinement windows of any two sparse BPVs may never overlap because the sparse BVP candidates in IntraTMP are obtained by using/applying a sampling interval of 4 (or another number such as, for example, 3), and the refinement window is ±1 sample around the BVP candidate. The refinement windows of two sparse BVP candidates may overlap only at the boundaries of two search subregions because the sampling interval is used/applied individually to each subregion (e.g., BVP-S4 and BVP-S5 as shown in FIG. 31). Refinement widows of the sparse BVPs may be constrained to the subregion to which the BVP candidate belongs to avoid such overlap.

The BVP Merge candidates may come from spatial neighbor blocks without any constraint related to their position. Consequently, the refinement windows of the Merge candidates may overlap with one another. FIG. 31 shows several examples of refinement windows of merge candidates overlapping:
BVP-M1 and BVP-M2 may be two Merge BVP candidates outside the TMP reference region, of which the refinement windows overlap with each other;
BVP-M5 and BVP-S2 may depict the overlapping of the refinement windows of a Merge BVP candidate and a Sparse BVP candidate inside the regular TMP reference region; and
BVP-M6 and BVP-S3 may show the overlapping of the refinement windows of a Merge BVP candidate (BVP-M6) and a Sparse BVP candidate (BVP-S3) inside the regular TMP reference region, where the refinement window of the Sparse BVP is constrained to the boundaries of the subregion.

The refinement window overlap may present at least two issues that can affect the performance of encoders and decoders:
The TMP cost may be computed twice at the overlapping locations, which increases the complexity inefficiently; and
Two BVP candidates whose refinement windows overlap may reduce the diversity of the candidates in the Merge List.

In relation to the first of the two issues identified above, since implementations of IntraTMP with Merge Candidates calculate template costs for each reference block candidate (e.g., with a sampling interval of 1 within the refinement window), duplicate calculations in the overlapped regions may significantly increase the computation load. In relation to the second of the two issues, since the size of the refined list (e.g., refined list 2414 in FIG. 24) is limited, including two BVP candidates that have significant overlap may often necessitate excluding another candidate that is further from the overlapping candidates.

One way to address the above identified issues may be to simply remove each BVP candidate whose refinement window overlaps another refinement window from the TMP Merge List. Such an approach may result in the removal of high-quality BVP candidates (e.g., resulting in reduced residual coding) from consideration for the final refined list. Instead of removing the duplicated BVP candidates in the TMP Merge List, some implementations may provide for implementing a clustering algorithm to merge the Merge BVP candidates that are close to each other whose refinement search windows overlap. The new refinement search window may be extended (enlarged) to cover the refinement search windows of both BVP candidates.

A new BVP candidate may be determined in implementations of the clustering algorithm. A new BVP candidate may be determined, for example, based on the extended refinement window. The new BVP candidate may replace the overlapping BVP candidates whose refinement windows were encompassed in the extended refinement window. Having a single refinement window may avoid the above identified issue of duplicated computation. Having only a single BVP candidate in the Merge List for each group of overlapping refinement windows may avoid the above identified issue of reduced diversity of candidates in the Merge List.

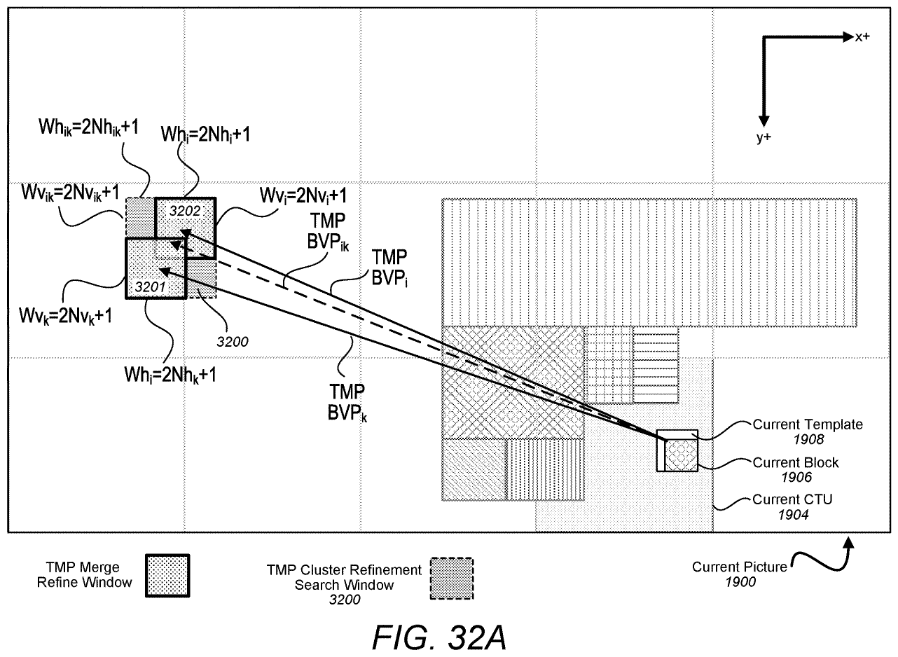

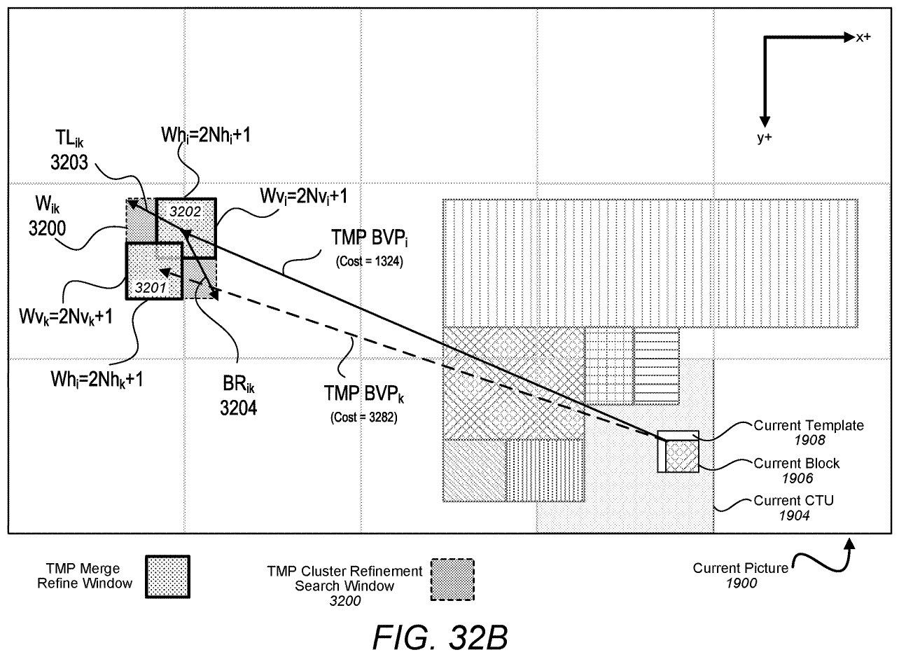

FIG. 32A and FIG. 32B show examples of enlarged refinement windows and corresponding new block vector predictor candidate. Specifically, FIG. 32A shows one example of two BVP Merge candidates, BVP; and BVPk, whose refinement windows 3202 and 3201 partially overlap. The clustering algorithm may determine a new refinement window (Wᵢₖ) 3200 with dimensions (Wₕᵢₖ, Wᵥᵢₖ) covering both original refinement windows (Wᵢ 3201 and Wₖ 3202). The new Merge BVP candidate (BVPᵢₖ) may be computed as the centroid of the new refinement window (Wᵢₖ) 3200.

In FIG. 32B, the clustering algorithm may determine a new refinement window (Wᵢₖ) 3200 with dimensions (Wₕᵢₖ, Wᵥᵢₖ) covering both original refinement windows (Wᵢ 3201 and Wₖ 3202). The clustering may select one of the BVP Merge candidates, BVPᵢ and BVPk, according to one specific criterion (e.g. the candidate with lower TMP cost), instead of determining a new Merge BVP candidate (BVPᵢₖ) computed as the centroid of the new refinement window (Wᵢₖ) 3200. In the example shown in FIG. 32B, the Merge BVP candidate BVPᵢ has a cost of 1324 and BVPk has a cost of 3282, so the candidate BVP; may be selected to represent the enlarged refine window 3200.

The dimensions of the enlarged refinement window (Wᵢₖ) 3200 may be indicated by its top-left and bottom-right corners, which may be determined by the top-left 3203 and bottom-right 3204 displacement vectors.

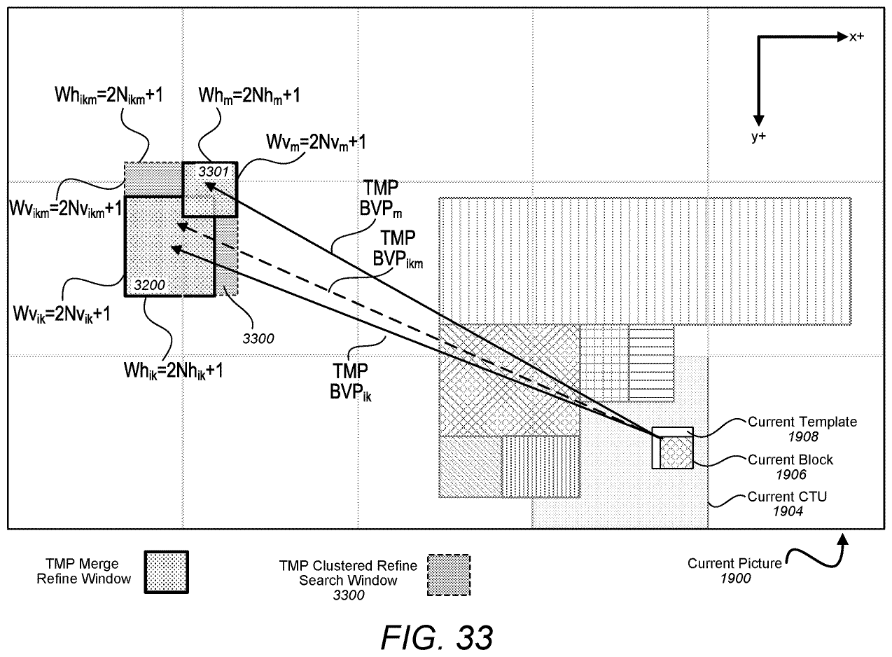

The clustering may be iteratively used/applied through the BVP candidates in the TMP Merge list. Therefore, a merged BVP candidate (e.g., BVPᵢₖ in FIG. 32A (or BVPᵢ in FIG. 32B) having refinement window 3200) may be clustered with another BVP candidate in the list (e.g., BVPₘ having refinement window 3301), resulting in a new BVP candidate (BVPᵢₖₘ) and a new refinement window (Wᵢₖₘ 3300), as shown for example in FIG. 33.

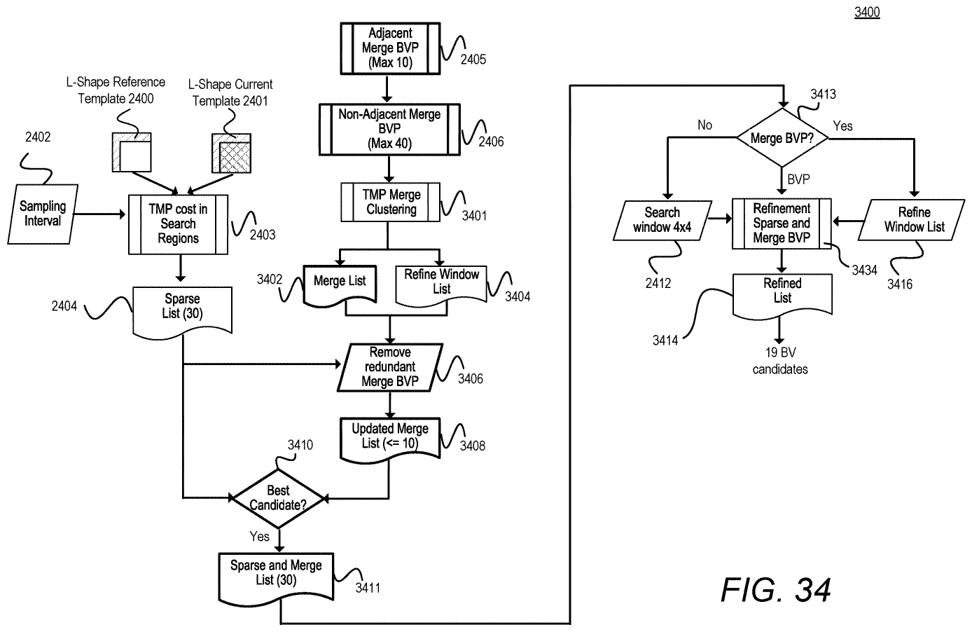

FIG. 34 shows an example of a clustering algorithm its application to adjacent and non-adjacent Merge candidate lists. Specifically, FIG. 34 shows a flowchart of the clustering algorithm shown in relation to FIGS. 32A-B and FIG. 33 being used/applied to the adjacent Merge BVP candidates 2405 and the non-adjacent Merge BVP candidates 2406. The adjacent Merge BVP candidates 2405 and non-adjacent Merge BVP candidates 2406 may be determined as described herein with respect to the IntraTMP with Merge Candidates technique. Operations of process 3400, as shown for example in FIG. 34, that have the same labels as those in FIGS. 24 and 28 may be performed in the same or similar way. In process 3400, at step 3401 a clustering algorithm, for example, the clustering algorithm shown in FIGS. 32A-B and FIG. 33, may be used/applied to output a TMP merge list 3402 of BVP candidates that have no BVP candidates with overlapped refinement windows (i.e., any overlapped refinement windows were encompassed in enlarged windows determined according to clustering shown in FIGS. 32A-33) and an additional refinement window list 3404 comprising the refinement window dimensions for each BVP candidate in the merge list 3402. The merge list 3402 may include new BVP candidates corresponding to enlarged refinement windows according to the clustering algorithm shown in FIGS. 32A-B and FIG. 33 and BVP candidates from lists 2405 and 2406 that have non-overlapping refinement windows. The refinement window list 3404, as described for example in FIG. 32A, may include, for each BVP candidate in merge list 3402, the height and width of the corresponding refinement window, which may be either an enlarged refinement window, determined according to the clustering shown in FIGS. 32A-B and FIG. 33, or a non-enlarged refinement window.

The BVP candidate stored in merge list 3402 for an enlarged refinement window, as described for example in FIG. 32A, may be the centroid of the enlarged window. The enlarged refinement windows, as described in FIG. 32B, may be stored in the form of the top-left and bottom-right coordinates of the enlarged refinement window and the BVP candidate stored in merge list 3402 for the enlarged window may be the BVP candidate of one of the overlapping refinement windows that is encompassed by the enlarged refinement window. For a particular enlarged refinement window that encompasses two refinement windows Wᵢ and Wₖ, the BVP candidate BVPᵢ of Wᵢ may be selected as the corresponding BVP candidate based on some selection criterion, and the top-left and bottom-right of the enlarged refinement window may be specified as displacement vectors from BVPᵢ.

Removal, from the merge list 3402, of the BVP candidates that are duplicates of the candidates in the sparse list 2404 may be performed at step 3406. Up to a predetermined number (e.g., 10) of the lowest TMP cost candidates from the merge list after step 3406 may be selected as the updated merge list 3408. At step 3410, up to a predetermined number (e.g., 30) of the lowest TMP cost BVP candidates may be selected from the sparse list 2404 and the updated merge list 3408 to generate the sparse and merge list 3411. At step 3413, the type of each BVP candidate in the sparse and merge list 3411 may be determined, and a refinement window of 4×4 may be set of sparse BVP candidates at 2412 and a refinement window as specified in refine window list 3401 may be set for merge BVP candidates at step 3416. At step 3424, each BVP candidate in the sparse and merge list 3411 may undergo refinement using the corresponding refinement window, leading to the updated list 3414 of refined BVP candidates. A predetermined number (e.g., 19) of the lowest TMP cost candidates from the refinement step 3424 may be selected to a list from which the BVP candidate is selected for coding (e.g., encoding or decoding) the current block.

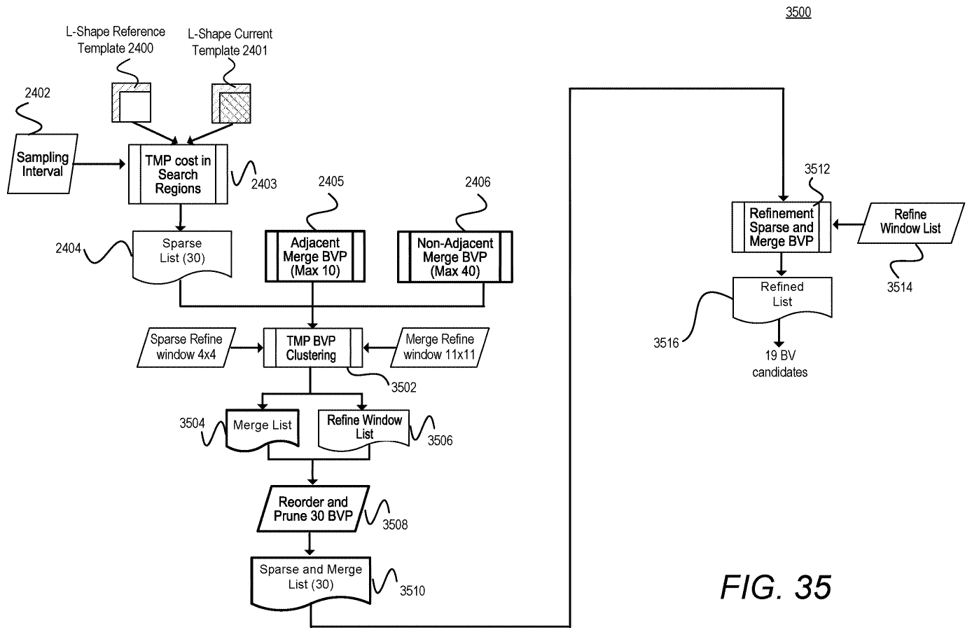

FIG. 35 shows an example clustering process. Specifically, FIG. 35 shows a flowchart of an example clustering process 3500, used/applied to the Sparse List 2404 and the adjacent Merge BVP candidates 2405 and non-adjacent Merge BVP candidates 2406 at the same TMP BVP clustering step 3502 of the clustering process 3500. The Sparse List 2404 may be generated according to the sparse search stage in an IntraTMP process, and the adjacent Merge BVP candidates 2405 and non-adjacent Merge BVP candidates 2406 may be determined according to FIGS. 23A-23B as in the IntraTMP with Merge Candidates process. Operations of clustering process 3500 that have the same labels as those in FIGS. 24 and 28 may be performed in the same or similar way. The size of refinement windows for the sparse candidates and the merge candidates may be different as shown. Two lists are built as a result of the clustering: a sparse and merge list 3504 that includes BVP candidates from any of the lists 2404, 2405, 2406 and/or BVP candidates corresponding to enlarged refinement windows for any of the BVP candidates from the lists 2404, 2405, 2406, and a refinement window list 3506 comprising corresponding information (e.g., height and width of the refinement window or the top-left and bottom-right coordinates) of the corresponding refinement windows. It should be noted that the refinement window information may be maintained in the same list as the corresponding BVP candidate information.

At step 3508 of the example clustering process 3500, the BVP candidates in list 3504 may be reordered in ascending TMP cost of the BVP candidates (non-clustered BVP candidate, a new BVP candidate defined for the centroid of the clustered refinement search regions, or one of the BVP candidates whose refinement windows partially or fully overlap) and pruned to a best quantity of candidates (e.g., the best 30 candidates) forming the updated sparse and merge list 3510. The refinement step 3512 of BVP candidates of the updated sparse and merge list 3510 may use the refinement window list 3514 to use/apply the refinement search efficiently to respective BVP candidates in the updated sparse and merge list 3510 and to generate the refined list 3516. The refined window list 3514 may include the same refine windows as the refine window list 3506, and may or may have the same or a lesser number of refine windows as the refine window list 3506. For the respective refinement window of each BVP candidate in the list being considered, the candidate reference block that has the best TMP cost may be determined and the BVP candidate corresponding to that candidate reference block may be added to the refined list 3516, similar to that described herein with respect to the refinement stage of IntraTMP in the refinement search.

The top quantity of BVP candidates (e.g., top 30 BVP candidates) among the sparse and Merge candidates, including the ARBVP candidates derived from the Merge and the Sparse candidates, may be refined using a fixed window size that depends on the type of BV. The refinement search technique may result in the necessity to compute a series of template-matching (TMP) costs that correspond directly to the size of the refinement window (also referred to as “refinement search window”) because the refinement search technique does not utilize a sampling interval (i.e., every sample in the window is tested). A TMP cost may be calculated at each position within the refinement window. IntraTMP may be currently configured to utilize a template height of 4 samples, which implies that each TMP cost necessitates calculating the Sum of Absolute Differences (SAD) or the Sum of Absolute Transformed Differences (SATD) of 4·(W+H+4) samples, where W and H represent the current block width and height, respectively.

Thus, the refinement stage may potentially yield more accurate results and may incur a significant computational expense due to the extensive calculations required for each match within the refinement window. Examples of such IntraTMP implementations are described herein with respect to FIG. 24, FIG. 28, FIG. 30, FIG. 34, and FIG. 35.

The table below shows example refinement window sizes and the TMP costs for each type of candidate in IntraTMP. Merge BVP candidates, as shown for example in the table below, may have a refinement window size (W_{M}) of 11×11 that results in 121 TMP cost calculations for each BVP candidate, sparse BVP candidates may have a refinement window size (W_{S}) of 4×4 that results in 16 TMP cost calculations for each BVP candidate, merge-ARBVP candidates and sparse-ARBVP candidates may both have a refinement window size (W_{MAR} and W_{SAP}, respectively) of 5×5 that results in 25 TMP cost calculations for each BVP candidate.

| Candidate | Parameter | Window Size | Number of TMP costs |
|---|---|---|---|
| Merge | W_{M} | 11 × 11 | 121 |
| Sparse | W_{S} | 4 × 4 | 16 |
| Merge-ARBVP | W_{MAR} | 5 × 5 | 25 |
| Sparse-ARBVP | W_{SAP} | 5 × 5 | 25 |

FIG. 30 shows an example of the use of the different refinement window sizes in IntraTMP, in relation to the Merge, Sparse, and ARBVP candidates. The Sparse BVP candidate refinement window 2412 may be 4×4, the Merge BVP candidate refinement window 3012 may be 11×11, and the ARBVP refinement window 3014 may be 5×5.

FIG. 35 shows another example of the IntraTMP tool, where the sparse (refinement window size 4×4) and merge candidates (refinement window size 11×11) may be clustered at step 3502 based on the overlapping refinement windows. The resulting refinement window may be recorded in the refine window list 3506, for example, if a merge candidate is combined (e.g., clustered) with a sparse candidate. FIG. 34 shows an example in which the clustering occurs only between merge candidates at step 3401.

The combined refinement window (e.g., 3203 in FIG. 32B, 3300 in FIG. 33) using the sparse and merge windows may reach a size of up to 14×14 samples (196 TMP costs). The combined refinement window (e.g., 3203 in FIG. 32B, 3300 in FIG. 33) using the sparse and merge windows may reach a size of up to 14×14 samples (196 TMP costs), for example, if clustering of refinement windows is implemented. Another merge candidate may subsequently cluster such a merge candidate, and the combined refined window may, in the worst case, be as large as 21×21 samples (441 TMP costs) because a merge candidate may be included in the sparse list if it has a lower cost than the last sparse candidate.

The size of the refinement window of a BVP candidate, in implementations of IntraTMP mode, may be preconfigured and set based on a type of the BVP candidate. Having a fixed window size for refinement windows of a BVP candidate of a particular type (e.g., Spare, Merge, ARBVP) may lead to a number of different issues, including but not limited to the following issues:
Candidates with low TMP costs suggesting that the optimal reference block may be situated nearby, particularly for certain types of content, such as, natural content. The refinement stage may conduct an extensive search within the refinement window surrounding the BVP candidate, irrespective of its TMP cost. The refinement stage may still seek a better BVP candidate with a lower cost, for example, if the TMP cost of a candidate is zero, indicating that all samples from the current template match those of the reference template. This approach may be inefficient and unnecessary, as achieving a position with a lower TMP cost may be unfeasible or highly unlikely.
Also, in some instances, performing the search within a large refinement window may not be efficient for candidates with a high TMP cost. The probability of discovering a position with a lower TMP cost may be relatively low, particularly for natural content.

Examples described herein provide for determining an adaptive refinement window for each BVP candidate (e.g., in the Sparse and/or Merge candidate list) based on its TMP cost, rather than employing a fixed refinement window size for each type of BVP candidate. By doing so, an IntraTMP tool, configured according to this disclosure, may be enabled to significantly reduce the complexity of both the encoder and decoder with minimal compression losses, resulting in a more efficient compression-to-complexity tradeoff for searching for BVP candidates with higher likelihood of pointing to the optimal reference block.

The refinement window size for candidates with low costs may be reduced to prevent the unjustified search from extending far from the BVP candidate's location. The search of large window areas may be prevented, for example, if the candidate has a low TMP cost. A better candidate may be discovered within the large window area at a reasonable computation cost.

Consequently, the present disclosure may provide for determining the refinement window size in a plurality of intervals of costs based on the TMP cost of the BVP candidate. For example, the refinement window size may be determined in three intervals based on the normalized TMP cost, as follows:
A linear, quadratic, a stepwise, or nonlinear function may be used/employed to determine the window size, for example, for Sparse and Merge candidates with a normalized cost below a threshold (Th₁);
A stepwise, or nonlinear function may be used/employed to determine the window size, for example, for Merge candidates with a normalized TMP cost exceeding that of the last Sparse candidate, a linear, quadratic; and
The fixed refinement window size based on the candidate type depicted in the table above (W_{M}=11, W_{S}=4, W_{MAR}=W_{SAR}=5) may be used, for example, for candidates with a normalized cost between the Th₁ and a second cost threshold (Th₂), for instance, the cost of the last Sparse candidate.
Respective examples may use/apply only the size adjustment of the refinement window to the candidates with a cost below the first threshold Th₁, may use/apply only to the candidates with a cost greater than the second threshold Th₂, or may use/apply in both cases.

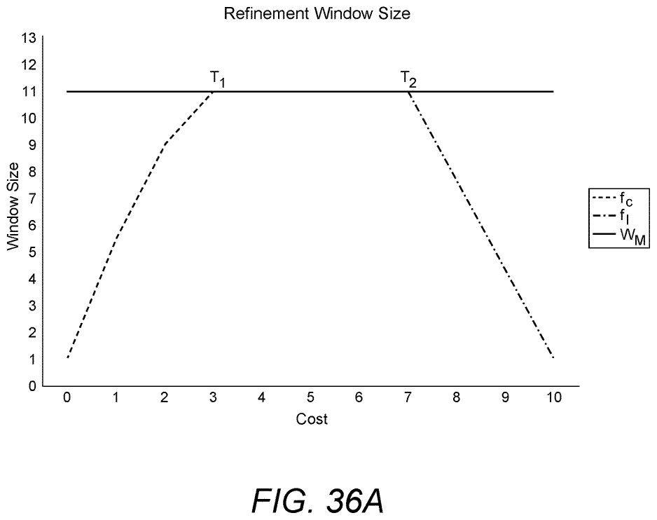

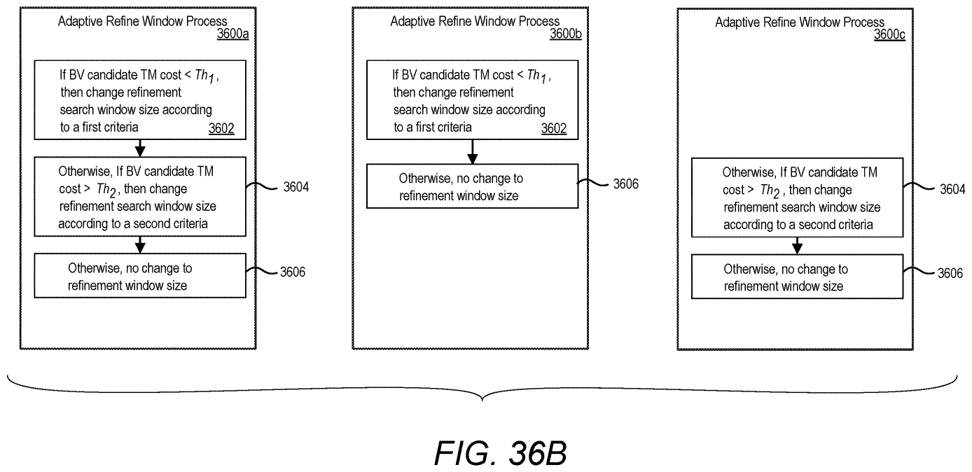

FIG. 36A shows an example for determining a size of the refinement window for a BVP candidate. The horizontal axis may represent the base 2 logarithm of the normalized TMP cost (e.g. SAD cost (Cost)) computed as follows, being:

$$\overline{Cost} = \{ \begin{matrix}\begin{matrix}{log}_{2} ⌈ \frac{{SAD}_{i}}{NumTmpSamples} ⌉ & ∀ {SAD}_{i} \neq 0\end{matrix} \\ \begin{matrix}0 & otherwise\end{matrix}\end{matrix} \qquad ( 19 )$$

where SADᵢ represents the Sum of Absolute Differences between the samples of the current block and those of the candidate (candidate i), and NumTmpSamples represents the total number of samples in the template according to the template type (L-SHAPE, ONLY-LEFT, or ONLY-TOP).

The y-axis may represent the refinement window size assigned to a candidate based on its normalized TMP cost (C̅o̅s̅t̅). For normalized TMP costs below the Th₁ a quadratic function ƒ_{c} may be used, and a linear function ƒₗ for the candidates with a normalized TMP may cost above the Th₂, which is determined by the cost of the last candidate in the Sparse list. In this example, the ƒ_{c} and ƒₗ may be defined as follows:

$$\begin{matrix}{f}_{c} = - ( \frac{c - {W}_{M}}{T {h}_{1}^{2} - BitDepth \cdot {Th}_{1}} ) \cdot ( {\overline{Cost}}_{i}^{2} + BitDepth \cdot {\overline{Cost}}_{i} ) + c & ∀ c \geq 0\end{matrix} \qquad ( 20 )$$

$$\begin{matrix}{f}_{l} = - \frac{{W}_{M} - b}{BitDepth - {Th}_{2}} \cdot ( {\overline{Cost}}_{i} - BitDepth ) + b & ∀ b \geq 0\end{matrix} \qquad ( 21 )$$

where c and b are constants, and BitDepth represents the bit depth of samples.

FIG. 36B shows some example processes in which the size of the refinement window for a BVP candidate is determined in an adaptive refinement window process. In the respective processes 3600a, 3600b and 3600c, the size of the refinement window may be adaptively determined in accordance with one or both threshold TMP costs, such as Th1 and Th2 described herein with respect to FIG. 36A, of BVP candidates.

In adaptive refinement window process 3600a, at step 3602, the refinement window size may be changed according to a first criteria. The refinement window size may be changed according to a first criteria, for example, if it is determined that for a particular BVP candidate its TMP cost is less than Th1. At step 3604, the refinement window size may be changed according to a second criteria. The refinement window size may be changed according to a second criteria for example, if BVP candidate TMP cost is greater than Th2. No change to the refinement window size may be made at step 3606, for example, if the TMP cost is between Th1 and Th2.

The first criteria may be the using/applying of a function, such as, a quadratic function fc that associates a window size for a range of TMP cost for TMP costs less than Th1. Example of quadratic functions fc may be provided above in equation 19 and is shown in FIG. 36A. Examples of quadratic functions fc are not limited to the functions identified herein. Some examples described herein may provide for using any function, a linear, quadratic, a stepwise, or higher degree function, to determine the window size that corresponds to TMP costs less than Th1. In some embodiments, Th1 may be a preconfigured value. Th1 may be a numeric value 0 or greater than 0. Th1 may be selected based on a tradeoff between accuracy of BVP candidate selection and reduction in TMP cost computations. Th1 may be preconfigured, or dynamically configured in accordance with the type of video content.

The second criteria may be the using/applying of a function, such as, a linear function fl that associates a window size for a range for TMP costs greater than Th2. Examples of linear function fl may be provided above in equation 19 and shown in FIG. 36A. Examples of linear function fl are not limited to the functions identified above. Some examples described herein may provide for using any function, a linear, quadratic, a stepwise, or higher degree function, to determine the window size that corresponds to TMP costs greater than Th2. Th2 may be a numeric value that is less than the maximum possible normalized TMP cost. Th2 may be selected based on a tradeoff between accuracy of BVP candidate selection and reduction in TMP cost computations. Th2 may be preconfigured, or dynamically configured in accordance with the type of video content.

In some instances, no change may be made to the size of the refinement window. No change may be made to the size of the refinement window, for example, if the TMP cost of the BVP candidate is between Th1 and Th2. As shown in FIG. 30 etc., IntraTMP implementations may provide respective BVP candidates with refinement windows that are sized based solely on the type of BVP candidate (e.g., whether the candidate is a merge, sparse, merge-ARBV, or sparse-ARBVP candidate). No change to the refinement window may be made by the adaptive refinement window process. No change to the refinement window may be made by the adaptive refinement window process, for example, if the TMP cost for a candidate is determined to be between Th1 and Th2.

In adaptive refinement window process 3600b, only the first threshold may be used to adaptively adjust the size of the refinement window. At step 3602, the size of the refinement window may be changed according to the first criteria as described herein with respect to process 3600a. The size of the refinement window may be changed according to the first criteria as described herein with respect to process 3600a, for example, if the BVP candidate's TMP cost is less than Th1. No change may be made to the size of the refinement window size, for example, if the TMP cost is determined at step 3606 to be not less than Th1. Step 3606 is described above in relation to process 3600a.

In adaptive refinement window sizing process 3600c, only the second threshold may be used to adaptively adjust the size of the refinement window. At step 3604, the size of the refinement window may be changed according to the second criteria as described herein with respect to process 3600a. The size of the refinement window may be changed according to the second criteria as described herein with respect to process 3600a, for example, if the BVP candidate's TMP cost is greater than Th2. No change may be made to the size of the refinement window size, for example, if the TMP cost is determined at step 3606 to be not greater than Th2. Step 3606 is described above in relation to process 3600a.

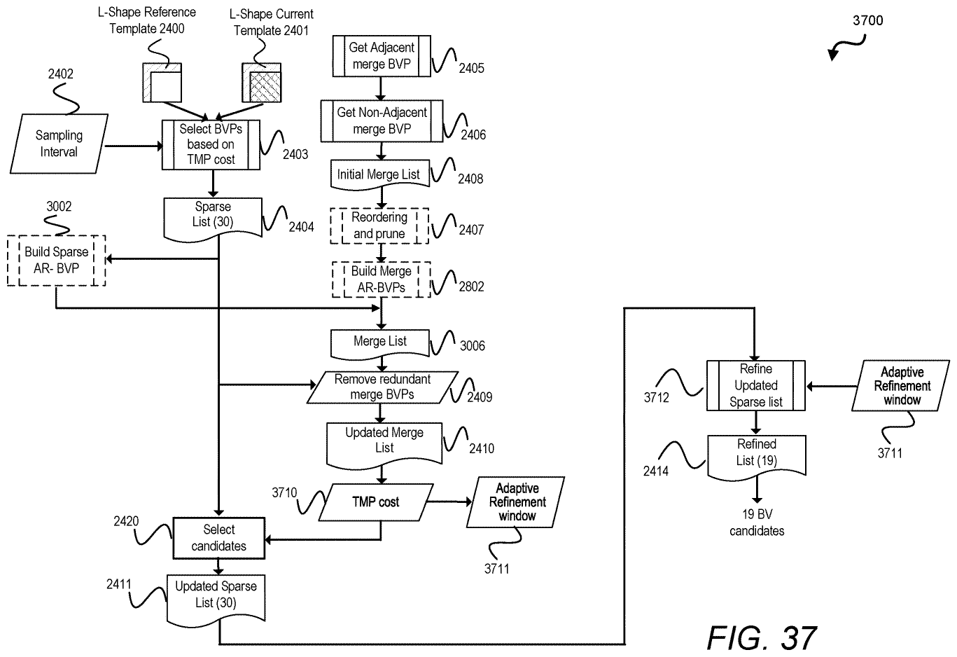

FIG. 37 shows an example Intra TMP process that does not implement a BVP candidates clustering. Specifically, FIG. 37 shows a flowchart 3700 of a process according to the examples described herein in an IntraTMP process, which does not implement the clustering stage among the BVP candidates. The example process of flowchart 3700 may be the same as the process 3000 described herein with respect to FIG. 30, except for the modification to generate an adaptive refinement window list 3711 using TMP costs at step 3710, and to perform the refinement of BVP candidates in the updated sparse list 2411 at step 3712 by using the refinement window list 3711. Operations of process 3700 that have the same labels as those in FIGS. 24, 25 and 28 may be performed in the same or similar way. The TMP cost 3710 for the list may be calculated, and a new refinement window list 3711 may be created, encompassing the specific refinement window dimensions for each candidate in the list. The TMP cost 3710 for the list may be calculated, and a new refinement window list 3711 may be created, encompassing the specific refinement window dimensions for each candidate in the list, for example, if the updated Merge list 2410 has been constructed, incorporating the Merge candidates (e.g., in lists 2405 and 2406) and optionally the ARBVP candidates (at step 2802 and at step 3002).

The TMP cost utilized to determine the window size may be reused from the TMP cost calculation 3710 performed in the Intra™ tool for candidate selection at step 2420, adding little or no further complexity that is specifically due to the adaptive refinement window sizing of example embodiments. The refinement step 3712 may employ the refinement window list 3711 to search for the optimal reference block in the area designated for the refinement window.

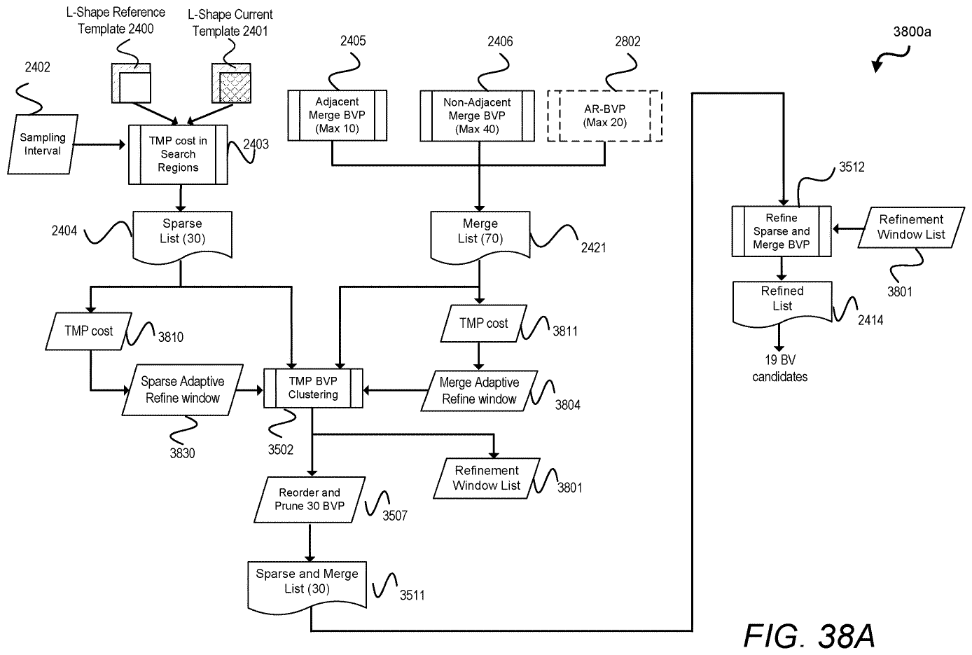

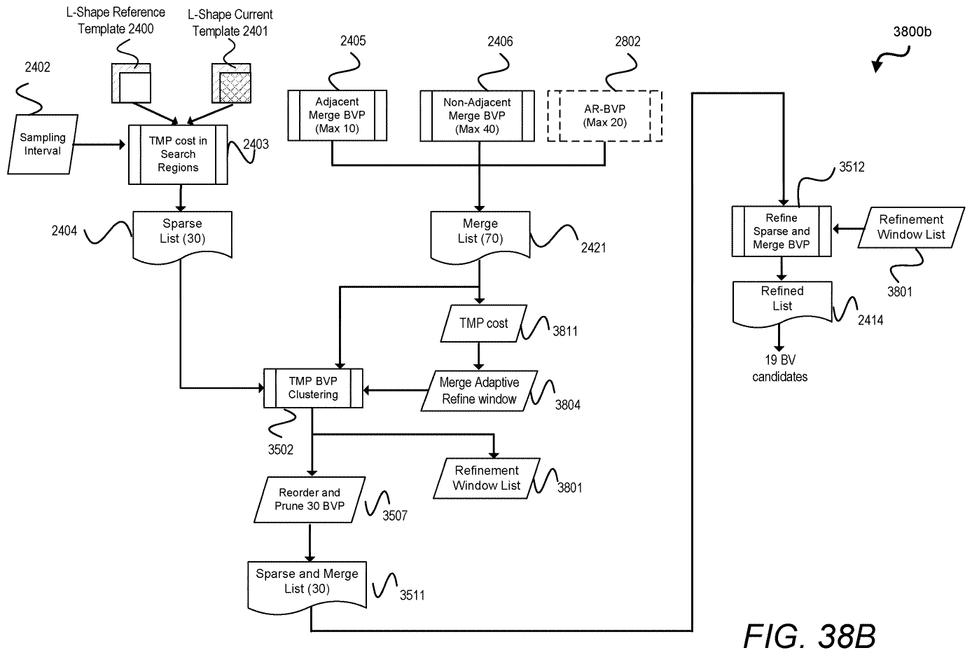

FIG. 38A and FIG. 38B show an example IntraTMP process utilizing a BVP candidates clustering process. Specifically, FIG. 38A shows a flowchart 3800a of a process according to an example of this disclosure in an IntraTMP process utilizing the BVP candidates clustering process. Operations of process 3800 that have the same labels as those in FIGS. 24, 28 and 35 may be performed in the same or similar way. The process of flowchart 3800 may be the same as the process 3500 described herein with respect to FIG. 35, except that the clustering at step 3502 may now be performed on BVP candidates for which the refinement windows have been adaptively sized using adaptive refinement window processes such as processes 3600a, 3600b, or 3600c described herein. Additionally, or alternatively, ARBVP candidates at step 2802 may also be included in the merge list 2421. The TMP costs 3810 and 3811 may be calculated for the BVP candidates from those lists. The TMP costs 3810 and 3811 may be calculated for the BVP candidates from those lists, for example, after the Sparse 2404 and Merge 2421 lists have been compiled. This TMP cost may be used to determine the specific size of the refinement window for each candidate. The adaptive refinement window lists 3830 and 3804 may also be employed in the clustering process to evaluate the refinement window's overlap and establish the refinement window's new size, for example, if an overlapping condition occurs. The TMP cost calculated to determine the window size may be reused from the TMP cost computed for the clustering step 3502 to decide whether a candidate is included in the final Sparse and Merge list 3511, adding little or no further complexity to the adaptive refinement method. The refinement window list 3801 may be formed, for example, if the clustering step 3502 occurs. The refinement window list 3801 may be formed if the clustering step 3502 occurs, since the clustering is performed using sparse adaptive refinement windows 3830 and merge adaptive windows 3804. Due to the clustering process, the BVP candidates output from the clustering step 3502 may include BVP candidates that are different from any of the candidates in the sparse list 2404 and merge list 2421. At refinement step 3512, refinement may be performed in the same manner as step 3512 described herein with respect to FIG. 35. At refinement step 3512, the refinement window list 3801 may be used/employed to search for the optimal reference block in the area designated for the refinement window. At refinement step 3512, the refined list 2414 of BVP candidates may be generated (e.g., determined). The process of the flowchart 3800b shown in FIG. 38B may be identical to the process of flowchart 3800a shown in FIG. 38A, except for the TMP cost calculation at step 3810 and the adaptive refinement window process at step 3830 for sparse candidates being absent from FIG. 38B.

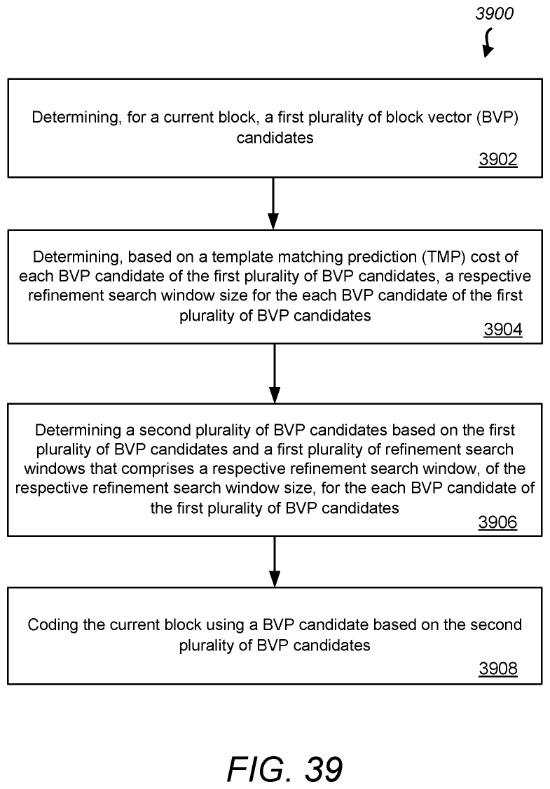

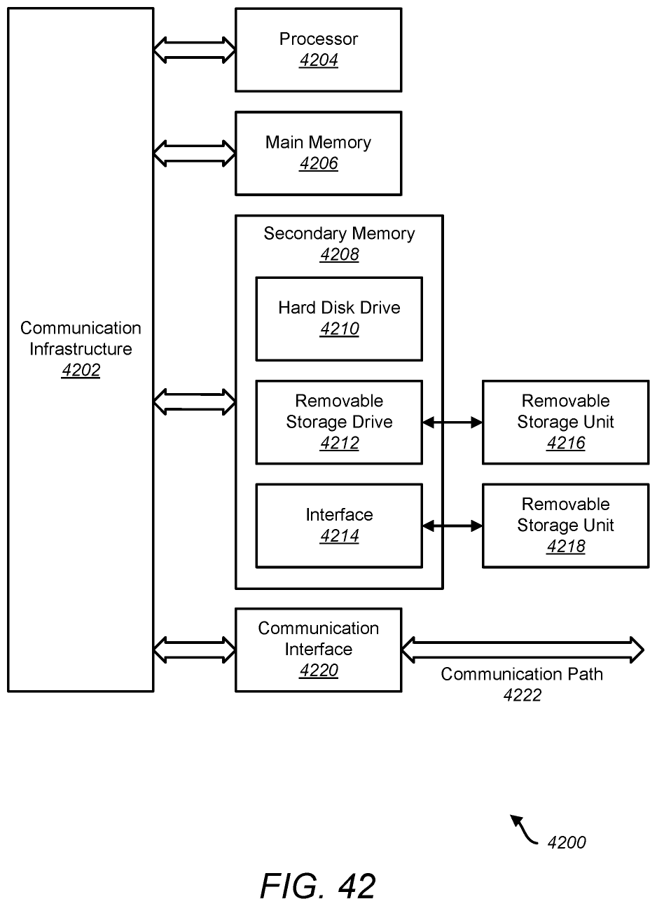

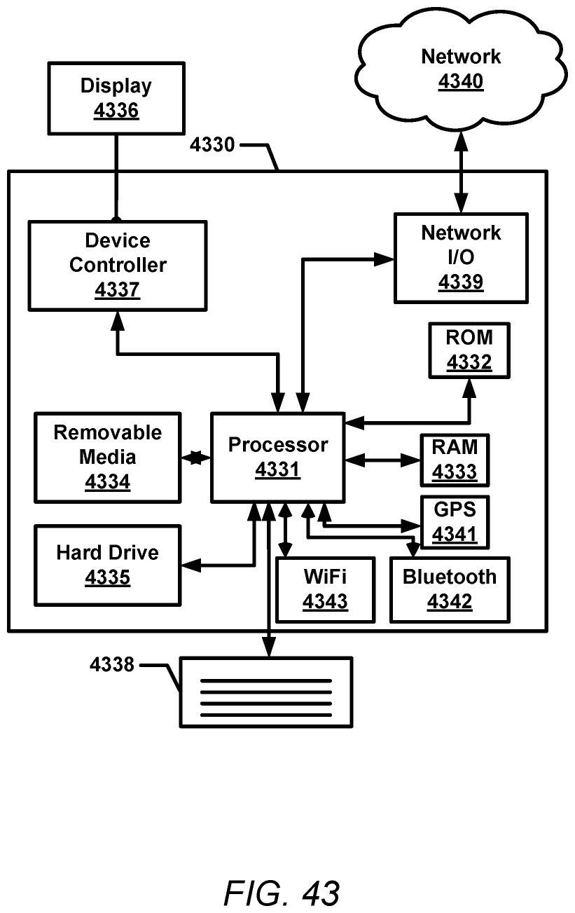

FIG. 39 shows an example method for generating adaptive refinement window sizing. Specifically, FIG. 39 shows a flowchart of an example method 3900 for adaptively configuring the size of refinement windows of BVP candidates for predicting the current block. The adaptive sizing of the refinement windows may be performed in accordance with the template matching prediction (TMP) cost of BVP candidates, and may be performed, for example, in an IntraTMP process as shown for instance in FIG. 37 and FIG. 38. The example method 3900 may enable the selection of a BVP candidate for a current block with a reduced number of TMP cost calculations, thereby improving encoder/decoder efficiency. One or more steps of the example method 3900 may be performed and/or implemented by an encoder (e.g., encoder 200 of FIG. 2), an example computer system 4200 as described herein with respect to FIG. 42, and/or an example computing device 4330 as described herein with respect to FIG. 43. One or more steps of the example method 3900 may be performed and/or implemented by a decoder (e.g., decoder 300 of FIG. 3), an example computer system 4200 as described herein with respect to FIG. 42, and/or an example computing device 4330 as described herein with respect to FIG. 43.

The method 3900 may begin at step 3902. At step 3902, a first plurality of BVP candidates may be determined for a current block. For example, the first plurality of BVP candidates may be determined as described in relation to determining any one of, the updated merge list 2410 in FIG. 37, the BVP candidates input to the clustering step 3502 in FIG. 38, the updated merge list 2410 in FIG. 24, the updated merge list 2410 in FIG. 28, the updated merge list 2410 in FIG. 30, the updated merge list 3408 or merge list 3402 in FIG. 34, or the BVP candidates input to the clustering step 3502 in FIG. 35. The first plurality of BVP candidates may be determined according to IntraTMP or a variation of the IntraTMP.

As described herein, for example, in relation to FIG. 24, FIG. 28, FIG. 30, FIG. 34, FIG. 35, FIG. 37, and FIG. 38, the BVP candidates may each be associated with a respective refinement window of which the size is determined only in accordance with the type of the BVP candidate. Refinement windows for sparse BVP candidates may have a size 4×4, refinement windows for merge BVP candidates may have a size 11×11, and refinement windows for ARBVP candidates may have a size of 5×5. This window size may be referred to as the default refinement window size and may be based only on the type of BVP candidate. The default refinement window size may be a fixed window size that is based on the type of BVP candidate.

At step 3904 a respective refinement window size for each BVP candidate of the first plurality of BVP candidates may be determined. The respective refinement window size for each BVP candidate of the first plurality of BVP candidates may be determined, for example, based on the TMP cost of each BVP candidate of the first plurality of BVP candidates

For each candidate in the first plurality of BVP candidates, the TMP cost may be calculated in accordance with the type of template (L-shape, left-only, top-only, etc.). The TMP cost may be calculated as the difference between the corresponding sample positions in the BVP candidate's template and the current block's template for each sample in the template. The number of TMP cost calculations for a BVP candidate may be determined by the size of the template (e.g., height and width of the template). The height and width of the template may correspond to the height and width of the reference block corresponding to the BVP candidate. Example TMP cost calculations (e.g., based on SAD, SATD, SSE) for the first plurality of BVP candidates may be described in relation to step 3710 in FIG. 37 and steps 3810-3811 in FIG. 38. The TMP cost calculation, performed, for example, at steps 3710 and 3810-3811, may calculate a normalized TMP cost using equation (19) or similar equation.

Each BVP candidate in the first plurality of candidates may be subjected to an adaptive refinement window process, such as, for example, any of the processes shown in flowcharts 3600a, 3600b, or 3600c. The adaptive refinement window process may determine, for each of the first plurality of BVP candidates, a refinement window size based on that BVP candidate's TMP cost. Thus, the adaptive refinement window process may, at least for some of the BVP candidates, change the refinement window sizes to sizes different than the default window size for each BVP candidate. As described herein with respect to FIG. 36B, an example implementation may use any one of the processes shown in flowcharts 3600a, 3600b, or 3600c to compare the TMP cost of the BVP candidate to one or both thresholds Th1 and Th2 and accordingly either adjust the window size or maintain the default window size. The updated refinement window sizes may be stored in association with the BVP candidates. For example, in FIG. 37 the adaptively determined refinement window sizes may be stored in an adaptive refinement window list at 3711 and in FIG. 38 the adaptively determined refinement window sizes may be stored in adaptive refinement window lists at step 3711, at step 3804, and at step 3830. As shown, the adaptive refinement window process may be used/applied at step 3830 and/or step 3804 to the sparse list 2404 and merge list 2421, respectively, based on TMP cost calculations at step 3810 and step 3811. At the end of step 3904, each BVP candidate of the first plurality of BVP candidates may be associated with a respectively different refinement window, or at least a respectively determined size of a refinement window. At least the refinement window sizes associated with some of the BVP candidates in the first plurality of BVP candidates may have been determined based on comparing the TMP cost of the BVP candidate with one or both of Th1 and Th2, and may be different from the window sizes that are determined based only on the type of the BVP candidate.

At step 3906, a second plurality of BVP candidates may be determined based on the first plurality of BVP candidates and a first plurality of refinement windows. The first plurality of refinement windows may comprise a respective refinement window, of the respective refinement window size, for each BVP candidate of the first plurality of BVP candidates. Step 3806 may include performing a refinement search for each BVP candidate in the first plurality of BVP candidates and determining a BVP candidate based on each refinement search. Whereas a refinement search may be performed in the refinement window for a particular BVP candidate from the first plurality of BVP candidates, the BVP candidate that is determined as the best (e.g., lowest TMP cost difference with the current block) from that refinement search may or may not be that particular BVP candidate from the first plurality of BVP candidates. The BVP candidates that are determined from the refinement search of the refinement windows may be the second plurality of BVP candidates that may or may not include BVP candidates of the first plurality of BVP candidates.

The second plurality of BVP candidates may be the same as the first plurality of BVP candidates, a subset of the first plurality of BVP candidates, or have BVP candidates that are different than the first plurality of BVP candidates. As described herein, the first plurality of BVP candidates may be determined based on a first sampling interval, and the second plurality of BVP candidates may be determined based upon a second sampling interval that may be different from (e.g., smaller than) the first sampling interval. The first plurality of BVP candidates may have the lowest TMP costs from among BVP candidates obtained from sampling the search region according to the first sampling interval, and the second plurality of BVP candidates may have the lowest TMP costs from among BVP candidates obtained from sampling a first plurality of refinement windows corresponding to the first plurality of BVP candidates, according to the second sampling interval.

As shown in FIG. 37, the updated merge list 2410, with the adaptive window sizes determined at step 3711, or the updated sparse list 2411, may correspond to the first plurality of BVP candidates. The updated merge list 2410 may not include sparse BVP candidates, and the updated sparse list 2411 may include both merge BVP candidates and sparse BVP candidates. The BVP candidates obtained from the updated merge list 2410 may each be associated with a refinement window size determined according to an adaptive refinement window process. In updated sparse list 2411, the BVP candidates obtained from the sparse list may be associated with refinement windows of a fixed size that is determined based only on the type of BVP candidate. The updated sparse list 2411, which is input to the refinement step 3712, may include one or more sparse candidates in addition to candidates from the updated merge list 2410 since the adaptive refinement window process is not used/applied to the sparse list 2404 in FIG. 37. The refined list of BVP candidates 2414 may correspond to the second plurality of BVP candidates.

Refinement processing, such as at step 3712, may be performed on the first plurality of BVP candidates, a subset of the first plurality of BVP candidates or a superset of the first plurality of BVP candidates. The refinement processing of the BVP candidates from the first plurality of BVP candidates may be performed, for example, by searching for the optimal BVP candidate within the adaptively sized refinement windows of the BVP candidates from the first plurality of BVP candidates. As shown for example in FIG. 27, the refined list 2414 may be obtained from the refinement processing step 3712.

The first plurality of BVP candidates, as shown for example in FIG. 38A, may correspond to one of, or the combination of, the sparse list 2404 and the merge list 2421. The adaptive refinement window process may be used/applied at step 3830 and/or step 3804 to the sparse list 2404 and merge list 2421, respectively. The adaptive refinement window process may be used/applied at step 3830 and/or step 3804 to the sparse list 2404 and merge list 2421, for example, based on TMP cost calculations at step 3810 and step 3811 to adaptively determine the refinement window sizes before the clustering at step 3502. The updated sparse and merge list 3511 may comprise BVP candidates determined from the clustering at step 3502. Referring to the example shown in FIG. 38A, the first plurality of BVP candidates may correspond to the sparse candidates in, for example, sparse list 2404, and merge candidates 2421 as provided as input to the clustering step 3502. And, the second plurality of BVP candidates may correspond to the BVP candidates in the refined list 2414. Clustering step 3502 in accordance with the process described herein with respect to FIG. 38A, may occur after the adaptive refinement windows are determined for the respective candidates from the sparse list 2404 and the merge list 2421, or for only the merge list 2421. Thus, the clustering may be performed on refinement windows of which at least some have been adaptively sized in accordance with a process such as any of 3600a, 3600b, or 3600c described herein.

In another example, as shown in FIG. 38B, the first plurality of BVP candidates may correspond to the merge list 2421. The adaptive refinement window process may be used/applied at step 3804 to the merge list 2421, respectively. The adaptive refinement window process may be used/applied at step 3804 to the merge list 2421, for example, based on TMP cost calculations at step 3811 to adaptively determine the refinement window sizes before the clustering at step 3502. The updated sparse and merge list 3511 may comprise BVP candidates determined from the clustering at step 3502. The first plurality of BVP candidates may correspond to the merge candidates 2421 as provided as input to the clustering step 3502, and the second plurality of BVP candidates may correspond to the BVP candidates in the refined list 3516. In accordance with the process described herein with respect to FIG. 38B, clustering 3502 may occur, for example, after the adaptive refinement windows are determined for the respective candidates from the merge list 2421.

At step 3908, the current block may be coded (e.g., encoded or decoded) based on a BVP candidate selected based on the second plurality of BVP candidates. The second plurality of BVP candidates may correspond to the refined list 2414 shown, for example, in FIG. 37 and FIGS. 38A-B, and the refinement search within adaptively sized refinement windows of the second plurality of BVP candidates may correspond to the refinement search performed at steps 3712 and 3512 shown in FIG. 37, FIG. 38A and FIG. 38B. A BVP candidate may be selected from the second plurality of BVP candidates. A BVP candidate may be selected from the second plurality of BVP candidates, for example, based on a criteria such as, but not limited to, TMP cost or RDO cost, as the predictor for the current block. A BVP candidate may be selected from the second plurality of BVP candidates based on a criteria such as, but not limited to, TMP cost or RDO cost, as the predictor for the current block, for example, after selecting the second plurality of BVP candidates based on the refinement search. The selected BVP candidate may be used to encode or decode the current block.

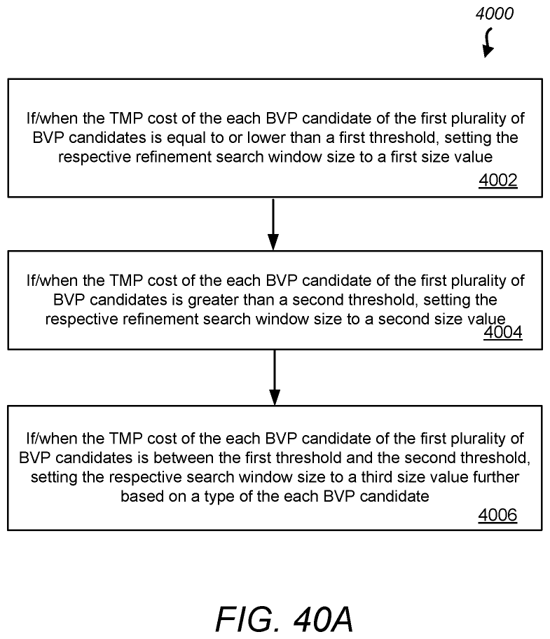

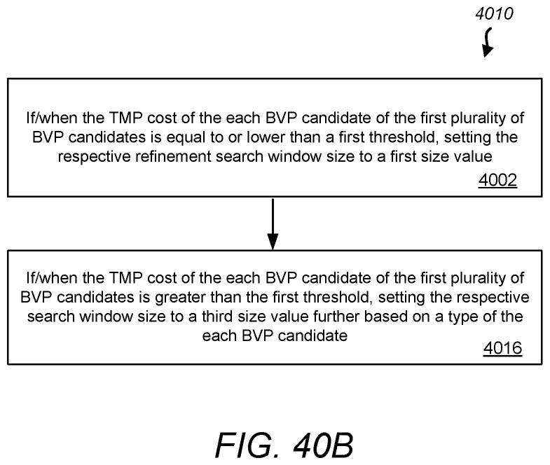

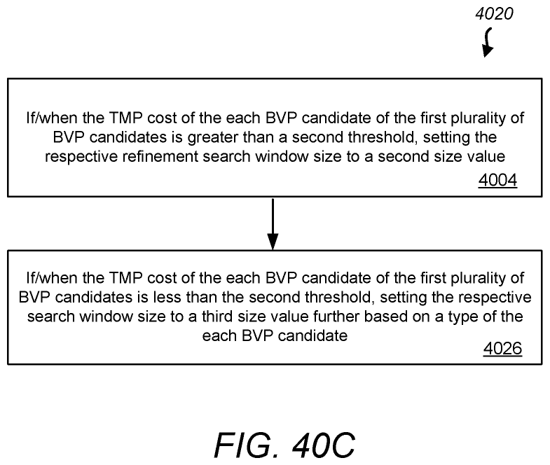

FIG. 40A, FIG. 40B and FIG. 40C show example methods for using TMP cost thresholds to determine refinement window sizes. Specifically, FIG. 40A shows a flowchart of an example method 4000 for determining, based on the TMP cost of each BVP candidate of the first plurality of BVP candidates, the respective refinement window size for each BVP candidate of the first plurality of BVP candidates. The example method 4000 may be performed at step 3904 to adaptively determine the refinement window sizes for respective BVP candidates in accordance with TMP cost. One or more steps of the example method 4000 may be performed and/or implemented by an encoder (e.g. encoder 200 of FIG. 2), an example computer system 4200 as described herein with respect to FIG. 42, and/or an example computing device 4330 as described herein with respect to FIG. 43. One or more steps of the example method 4000 may be performed and/or implemented by a decoder (e.g., decoder 300 of FIG. 30, an example computer system 4200 as described herein with respect to FIG. 42, and/or an example computing device 4330 as described herein with respect to FIG. 43.

At step 4002, the refinement window size for that BVP candidate may be set to a first size value. The refinement window size for that BVP candidate may be set to a first size value, for example, if/when the TMP cost of a BVP candidate of the first plurality of BVP candidates is equal to or lower than a first threshold. The first threshold is referred to above as Th1. The BVP candidates having a TMP cost below Th1 may be considered to have near optimal TMP costs.

At step 4004, the refinement window size of that BVP candidate may be set to a second size value. The refinement window size of that BVP candidate may be set to a second size value, for example, if/when the TMP cost of the BVP candidate of the first plurality of BVP candidates is greater than a second threshold. The second threshold is referred to above as Th2. BVP candidates having TMP costs greater than Th2 may be considered as having very high TMP costs and therefore unlikely to be the most optimal BVP candidate. At step 4006, the refinement window size may be set to a third size value. The refinement window size may be set to a third size value, for example, based on a type of the BVP candidate. The refinement window size may be set to a third size value based on a type of the BVP candidate, for example, if/when the TMP cost of the BVP candidate of the first plurality of BVP candidates is between the first threshold and the second threshold.

The first size value, as described herein with respect to FIGS. 36A-B, may be determined according to a quadratic or other function of TMP cost, the second size value may be determined according to a linear or other function of the TMP cost, and the third size value may be based on the default refinement window size values for the type of BVP candidate. The first and second size values may be preconfigured fixed values, or may depend on the current block size.

FIG. 40B shows a flowchart of an example method 4010 for determining, based on the TMP cost of each BVP candidate of the first plurality of BVP candidates, the respective refinement window size for the BVP candidate of the first plurality of BVP candidates. The method 4010 may be performed at step 3904 to adaptively determine the refinement window sizes for respective BVP candidates in accordance with TMP cost. One or more steps of the example method 4010 may be performed and/or implemented by an encoder (e.g., encoder 200 of FIG. 2), an example computer system 4200 as described herein with respect to FIG. 42, and/or an example computing device 4330 as described herein with respect to FIG. 43. One or more steps of the example method 4010 may be performed and/or implemented by a decoder (e.g., decoder 300 of FIG. 3), an example computer system 4200 as described herein with respect to FIG. 42, and/or an example computing device 4330 as described herein with respect to FIG. 43.

At step 4002, the refinement window size for that BVP candidate may be set to a first size value. The refinement window size for that BVP candidate may be set to a first size value, for example, if/when the TMP cost a BVP candidate of the first plurality of BVP candidates is equal to or lower than a first threshold. The first threshold is referred to above as Th1. The BVP candidates having a TMP cost below Th1 may be considered to have near optimal TMP costs. At step 4016, the refinement window size may be set to a third size value further. The refinement window size may be set to a third size value, for example, based on a type of the BVP candidate. The refinement window size may be set to a third size value based on a type of the BVP candidate, for example, if/when the TMP cost of the BVP candidate of the first plurality of BVP candidates is equal to or greater than the first threshold.

As described herein with respect to FIGS. 36A-B, the first size value may be determined according to a quadratic or other function of TMP cost, and the third size value may be based on the default refinement window size values for the type of BVP candidate. The first and second size values may be preconfigured fixed values, or may depend on the current block size.

FIG. 40C shows a flowchart of an example method 4020 for determining, based on the TMP cost of each BVP candidate of the first plurality of BVP candidates, the respective refinement window size for each BVP candidate of the first plurality of BVP candidates. The method 4020 may be performed at step 3904 to adaptively determine the refinement window sizes for respective BVP candidates in accordance with TMP cost. One or more steps of the example method 4020 may be performed and/or implemented by an encoder (e.g., encoder 200 of FIG. 2), an example computer system 4200 as described herein with respect to FIG. 42, and/or an example computing device 4330 as described herein with respect to FIG. 43. One or more steps of the example method 4020 may be performed and/or implemented by a decoder (e.g., decoder 300 of FIG. 3), an example computer system 4200 as described herein with respect to FIG. 42, and/or an example computing device 4330 as described herein with respect to FIG. 43.

At step 4004, the refinement window size of that BVP candidate may be set to a second size value. The refinement window size of that BVP candidate may be set to a second size value, for example, if/when the TMP cost of a BVP candidate of the first plurality of BVP candidates is greater than a second threshold. The second threshold may be referred to above as Th2. BVP candidates having TMP costs greater than Th2 may be considered as having very high TMP costs and therefore unlikely to be the most optimal BVP candidate. At step 4026, the refinement window size may be set to a third size value further based on a type of each BVP candidate. The refinement window size may be set to a third size value further based on a type of each BVP candidate, for example, if/when the TMP cost of the BVP candidate of the first plurality of BVP candidates is equal to or less than the second threshold.

The second size value may be determined according to a linear or other function of the TMP cost, and the third size value may be based on the default refinement window size values for the type of BVP candidate, as described in relation to FIGS. 36A-B. The first and second size values may be preconfigured fixed values, or may depend on the current block size.

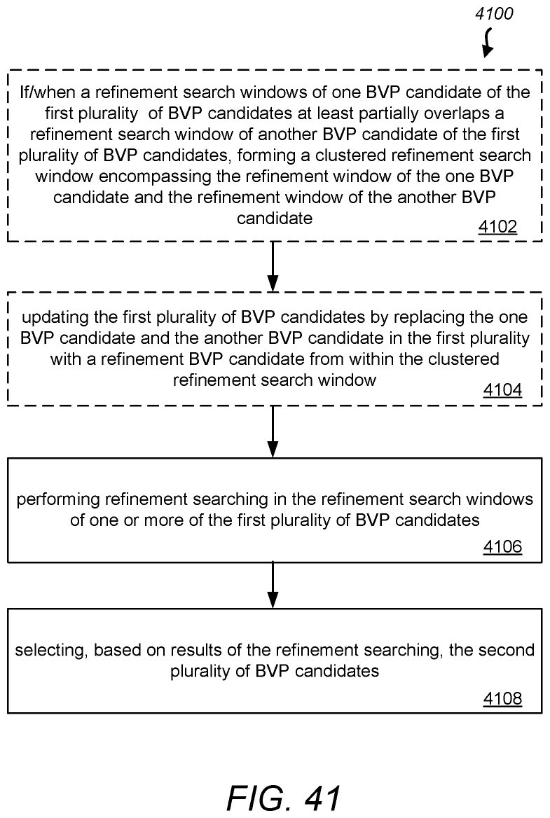

FIG. 41 shows a flowchart of an example method for determining, based on the TMP cost of each BVP candidate of the first plurality of BVP candidates, the respective refinement window size for the each BVP candidate of the first plurality of BVP candidates. The example method 4100 may update the first plurality of BVP candidates in accordance with a clustering stage, for example, the clustering step 3502 described herein with respect to FIG. 38. The method 4100 may be performed at step 3904. One or more steps of the example method 4100 may be performed and/or implemented by an encoder (e.g., encoder 200 of FIG. 2), an example computer system 4200 as described herein with respect to FIG. 42, and/or an example computing device 4330 as described herein with respect to FIG. 43. One or more steps of the example method 4100 may be performed and/or implemented by a decoder (e.g., decoder 300 of FIG. 3), an example computer system 4200 as described herein with respect to FIG. 42, and/or an example computing device 4330 as described herein with respect to FIG. 43.

At step 4102, a clustered refinement window encompassing the refinement window of the one BVP candidate and the refinement window of the another BVP candidate may be formed. The clustered refinement window encompassing the refinement window of the one BVP candidate and the refinement window of the another BVP candidate may be formed, for example, if/when a refinement window of one BVP candidate of the first plurality of BVP candidates at least partially overlaps a refinement window of another BVP candidate of the first plurality of BVP candidates. The clustering of refinement windows is described in relation to step 3502.

At step 4104, the first plurality of BVP candidates may be updated. The first plurality of BVP candidates may be updated, for example, by replacing the one BVP candidate and the another BVP candidate in the first plurality of BVP candidates with a refinement BVP candidate selected for the clustered refinement window. The refinement BVP candidate may be selected as the centroid of the clustered refinement window. The refinement BVP candidate may be at another position in the clustered refinement window. The first plurality of BVP candidates may be updated, for example, by substituting the refinement BVP candidate in place of the one BVP candidate and the another BVP candidate. Steps 4102 and 4104 as shown in FIG. 41 may be optional.

At step 4106, refinement searching may be performed in the refinement search windows of one or more of the first plurality of BVP candidates. Refinement searching is described herein in relation to, for example, steps 3512 and 3424 in several of the above discussed figures.

At step 4108, the second plurality of BVP candidates may be selected. The second plurality of BVP candidates may be selected, for example, based on results of the refinement searching. The selected second plurality of BVP candidates is referred to in steps 3906 and 3908 as described herein with respect to FIG. 39.

Examples of the present disclosure may be implemented in hardware using analog and/or digital circuits, in software, through the execution of instructions by one or more general purpose or special-purpose processors, or as a combination of hardware and software. Consequently, examples of the disclosure may be implemented in the environment of a computer system or other processing system. An example of such a computer system 4200 is shown in FIG. 42. FIG. 42 shows an example computer system in which examples of the present disclosure may be implemented. For example, various devices and/or systems described herein (e.g., in FIGS. 1, 2, and 3) may be implemented in the form of one or more computer systems 4200. Furthermore, each of the steps of the flowcharts depicted in this disclosure may be implemented on one or more computer systems 4200.

Computer system 4200 includes one or more processors, such as processor 4204. Processor 4204 may be, for example, a special purpose processor, a general purpose processor, a microprocessor, and/or a digital signal processor. Processor 4204 may be connected to a communication infrastructure 4202 (e.g., a bus or network). Computer system 4200 may also include a main memory 4206 (e.g., a random access memory (RAM)) and/or a secondary memory 4208.

Secondary memory 4208 may include a hard disk drive 4210 and/or a removable storage drive 4212 (e.g., a magnetic tape drive, an optical disk drive, and/or the like). Removable storage drive 4212 may read from and/or write to a removable storage unit 4216. Removable storage unit 4216 may comprise a magnetic tape, optical disk, and/or the like. The removable storage unit 4216 may be read by and/or may be written to by removable storage drive 4212. The removable storage unit 4216 may comprise a computer usable storage medium having stored therein computer software and/or data.

The secondary memory 4208 may include other similar means for allowing computer programs or other instructions to be loaded into computer system 4200. Such means may include a removable storage unit 4218 and/or an interface 4214. Examples of such means may include a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 4218 and interfaces 4214 which may allow software and/or data to be transferred from removable storage unit 4218 to computer system 4200.

Computer system 4200 may also include a communications interface 4220. Communications interface 4220 may allow software and data to be transferred between computer system 4200 and external devices. Examples of communications interface 4220 may include a modem, a network interface (e.g., an Ethernet card), a communications port, etc. Software and/or data transferred via communications interface 4220 may be in the form of signals which may be electronic, electromagnetic, optical, and/or other signals capable of being received by communications interface 4220. The signals may be provided to communications interface 4220 via a communications path 4222. Communications path 4222 may carry signals and may be implemented using wire or cable, fiber optics, a phone line, a cellular phone link, an RF link, and/or any other communications channel(s).

The computer system 4200 may also comprise one or more sensor(s) 4224. The sensor(s) 4224 may measure or detect one or more physical quantities and convert the measured or detected physical quantities into an electrical signal in digital and/or analog form. For example, the sensor(s) 4224 may include an eye tracking sensor to track the eye movement of a user. A display of a point cloud may be updated, for example, based on the eye movement of a user. The sensor(s) 4224 may include a head tracking sensor to track the head movement of a user. A display of a point cloud may be updated, for example, based on the head movement of a user. The sensor(s) 4224 may include a camera sensor for taking photographs and/or a 3D scanning device (e.g., a laser scanning device, a structured light scanning device, and/or a modulated light scanning device). The 3D scanning devices may determine geometry information by moving one or more laser heads, structured light, and/or modulated light cameras relative to the object or scene being scanned. The geometry information may be used to construct a point cloud.

A computer program medium and/or a computer readable medium may be used to refer to tangible storage media, such as removable storage units 4216 and 4218 or a hard disk installed in hard disk drive 4210. The computer program products may be means for providing software to computer system 4200. Computer programs (which may also be called computer control logic) may be stored in main memory 4206 and/or secondary memory 4208. Computer programs may be received via communications interface 4220. Such computer programs, when executed, may enable the computer system 4200 to implement the present disclosure as discussed herein. In particular, the computer programs, when executed, may enable processor 4204 to implement the processes of the present disclosure, such as any of the methods described herein. Accordingly, such computer programs may represent controllers of the computer system 4200.

Features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

FIG. 43 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 4330 may include one or more processors 4331, which may execute instructions stored in the random-access memory (RAM) 4333, the removable media 4334 (such as a Universal Serial Bus (USB) drive, compact disk (CD) or digital versatile disk (DVD), or floppy disk drive), or any other desired storage medium. Instructions may also be stored in an attached (or internal) hard drive 4335. The computing device 4330 may also include a security processor (not shown), which may execute instructions of one or more computer programs to monitor the processes executing on the processor 4331 and any process that requests access to any hardware and/or software components of the computing device 4330 (e.g., ROM 4332, RAM 4333, the removable media 4334, the hard drive 4335, the device controller 4337, a network interface 4343, a GPS 4341, a Bluetooth interface 4342, a WiFi interface 4343, etc.). The computing device 4330 may include one or more output devices, such as the display 4336 (e.g., a screen, a display device, a monitor, a television, etc.), and may include one or more output device controllers 4337, such as a video processor. There may also be one or more user input devices 4338, such as a remote control, keyboard, mouse, touch screen, microphone, etc. The computing device 4330 may also include one or more network interfaces, such as a network interface 4343, which may be a wired interface, a wireless interface, or a combination of the two. The network interface 4343 may provide an interface for the computing device 4330 to communicate with a network 4340 (e.g., a RAN, or any other network). The network interface 4343 may include a modem (e.g., a cable modem), and the external network 4340 may include communication links, an external network, an in-home network, a provider's wireless, coaxial, fiber, or hybrid fiber/coaxial distribution system (e.g., a DOCSIS network), or any other desired network. Additionally, the computing device 4330 may include a location-detecting device, such as a global positioning system (GPS) microprocessor 4341, which may be configured to receive and process global positioning signals and determine, with possible assistance from an external server and antenna, a geographic position of the computing device 4330.

The example in FIG. 43 may be a hardware configuration, although the components shown may be implemented as software as well. Modifications may be made to add, remove, combine, divide, etc. components of the computing device 4330 as desired. Additionally, the components may be implemented using basic computing devices and components, and the same components (e.g., processor 4331, ROM storage 4332, display 4336, etc.) may be used to implement any of the other computing devices and components described herein. For example, the various components described herein may be implemented using computing devices having components such as a processor executing computer-executable instructions stored on a computer-readable medium, as shown in FIG. 43. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may comprise a decoder. The computing device may determine, for a current block of content, a first plurality of block vector predictor (BVP) candidates; for each BVP candidate of the first plurality of BVP candidates: may determine a respective refinement search window size based on a template matching prediction (TMP) cost of the BVP candidate; may determine a second plurality of BVP candidates based on: the first plurality of BVP candidates; and a plurality of refinement search windows that comprises a respective refinement search window, of the respective refinement search window size, for the each BVP candidate of the first plurality of BVP candidates; may decode the current block based on a BVP candidate selected from the second plurality of BVP candidates, wherein the determining the respective refinement search window size may further comprise: determining, based on comparing the TMP cost of the BVP candidate to at least one threshold, the respective refinement search window size; wherein the determining the respective refinement search window size for the BVP candidate of the first plurality of BVP candidates may further comprise: based on the TMP cost of the BVP candidate being lower than a first threshold, setting the respective refinement search window size to a first size value; or based on the TMP cost of the BVP candidate being equal to or greater than the first threshold, setting the respective refinement search window size to a second size value; wherein the determining the respective refinement search window size for the BVP candidate of the first plurality of BVP candidates may further comprise: selecting the respective refinement search window size from at least two different search window sizes, wherein the at least two different search window sizes may be independent of a type of the BVP candidate; wherein the determining the second plurality of BVP candidates may further comprise: based on a refinement search window of one BVP candidate of the first plurality of BVP candidates at least partially overlapping a refinement search window of another BVP candidate of the first plurality of BVP candidates, forming a clustered refinement search window encompassing the refinement search window of the one BVP candidate and the refinement search window of the another BVP candidate; replacing, based on a TMP search of the clustered refinement search window, the one BVP candidate and the another BVP candidate with a refinement BVP candidate; performing refinement searching in the refinement search windows of one or more of the first plurality of BVP candidates; and selecting, based on results of the refinement searching, the second plurality of BVP candidates; wherein the determining the second plurality of BVP candidates may further comprise: performing refinement searching in the refinement search windows of one or more of the first plurality of BVP candidates; and selecting, based on results of the refinement searching, the second plurality of BVP candidates; wherein the TMP cost may be calculated based on at least one of: a L-shape template of the current block; or a top-only or left-only template of the current block; wherein: the first plurality of BVP candidates may comprise: sparse BVP candidates; merge BVP candidates; and auto-relocated block vector prediction (AR-BVP) BVP candidates; and the merge BVP candidates comprise: adjacent merge candidates of the current block; and non-adjacent merge candidates of the current block; wherein: the first plurality of BVP candidates may comprise: merge BVP candidates of the current block; and no sparse BVP candidates of the current block; the second plurality of BVP candidates may comprise: BVP candidates determined based on the first plurality of BVP candidates and sparse candidates of the current block, wherein each of the sparse candidates may be associated with a respective refinement search window of predetermined size; wherein the respective refinement search window size may be determined further based on a size of the current block; wherein the TMP cost may comprise absolute differences (SAD), sum of absolute transformed differences (SATD), or sum of squares error (SSE); wherein the TMP cost may be calculated for a template of the each BVP candidate and the template may have a predetermined height; wherein the first plurality of BVP candidates may be determined based on sampling a search region in a first sampling interval; wherein the first plurality of BVP candidates may have the lowest TMP costs of BVP candidates obtained from the sampling the search region according to the first sampling interval; wherein the second plurality of BVP candidates may be determined based on sampling the first plurality of refinement windows in a second sampling interval; wherein the second sampling interval may be smaller than the first sampling interval; wherein the second plurality of BVP candidates may have the lowest TMP costs of BVP candidates comprising BVP candidates obtained from the sampling the first plurality of refinement windows; wherein the refinement search window for the respective BVP candidate may be centered at a position indicated by the BVP candidate; wherein the respective refinement window size may specify a width and a height of the refinement search window. The computing device may comprise one or more processors and memory, storing instructions that, when executed by the one or more processors, perform the method described herein. A system may comprise the computing device configured to perform the described method, additional operations, and/or include additional elements; and a second computing device configured to encode the current block. A computer-readable medium may store instructions that, when executed, cause performance of the described method, additional operations, and/or include additional elements.

A computing device may perform a method comprising multiple operations. The computing device may comprise a decoder. The computing device may determine, for a current block of content, a first plurality of block vector predictor (BVP) candidates; may determine, based on comparing a template matching prediction (TMP) cost of each BVP candidate of the first plurality of BVP candidates to at least one threshold, a respective refinement search window size for the each BVP candidate of the first plurality of BVP candidates; may determine a second plurality of BVP candidates based on the first plurality of BVP candidates and a plurality of refinement search windows; and may decode the current block based on a BVP candidate selected from the second plurality of BVP candidates, wherein the determining the respective refinement search window size for the each BVP candidate of the first plurality of BVP candidates may further comprise: based on the TMP cost of the each BVP candidate of the first plurality of BVP candidates being equal to or lower than a first threshold: determining a first size value by using a linear or quadratic function of the TMP cost; and setting the respective refinement search window size to the first size value; wherein the determining the respective refinement search window size for the each BVP candidate of the first plurality of BVP candidates may further comprise: based on the TMP cost of the each BVP candidate of the first plurality of BVP candidates being equal to or lower than a first threshold: determining, based on a lookup table, a first size value; and setting the respective refinement search window size to the first size value; wherein the determining the respective refinement search window size for the each BVP candidate of the first plurality of BVP candidates may further comprise: based on the TMP cost of the each BVP candidate of the first plurality of BVP candidates being equal to or lower than a first threshold, setting the respective refinement search window size to a predetermined value; wherein the determining the respective refinement search window size for the each BVP candidate of the first plurality of BVP candidates may further comprise: based on the TMP cost of the each BVP candidate of the first plurality of BVP candidates being equal to or lower than a first threshold, setting the respective refinement search window size to a first size value that is proportional to a magnitude of the TMP cost; wherein the determining the respective refinement search window size for the each BVP candidate of the first plurality of BVP candidates may further comprise: based on the TMP cost of the each BVP candidate of the first plurality of BVP candidates being greater than a second threshold, setting the respective refinement search window size to a second size value, wherein: the first plurality of BVP candidates comprises at least merge BVP candidates of the current block; and the second threshold may be based on a highest TMP cost of any sparse BVP candidates of the current block; wherein the determining the respective refinement search window size for the each BVP candidate of the first plurality of BVP candidates may further comprise: based on the TMP cost of the each BVP candidate of the first plurality of BVP candidates being less than a second threshold, setting, based on a type of the each BVP candidate, the respective refinement search window size to a third size value, wherein: the second threshold may be based on a highest TMP cost of any sparse BVP candidates of the current block. The computing device may comprise one or more processors and memory, storing instructions that, when executed by the one or more processors, perform the method described herein. A system may comprise the computing device configured to perform the described method, additional operations, and/or include additional elements; and a second computing device configured to encode the current block. A computer-readable medium may store instructions that, when executed, cause performance of the described method, additional operations, and/or include additional elements.

A computing device may perform a method comprising multiple operations. The computing device may comprise a encoder. The computing device may determine, for a current block of content, a first plurality of block vector predictor (BVP) candidates; for each BVP candidate of the first plurality of BVP candidates: may determine a respective refinement search window size based on a template matching prediction (TMP) cost of the BVP candidate; may determine a second plurality of BVP candidates based on: the first plurality of BVP candidates; and a plurality of refinement search windows that comprises a respective refinement search window, of the respective refinement search window size, for the each BVP candidate of the first plurality of BVP candidates; may encode the current block based on a BVP candidate selected from the second plurality of BVP candidates, wherein the determining the respective refinement search window size for the each BVP candidate of the first plurality of BVP candidates may further comprise: based on the TMP cost of the each BVP candidate of the first plurality of BVP candidates being lower than a first threshold, setting the respective refinement search window size to a first size value; or based on the TMP cost of the each BVP candidate of the first plurality of BVP candidates being equal to or greater than the first threshold, setting the respective refinement search window size to a second size value; wherein the determining the respective refinement search window size for the each BVP candidate of the first plurality of BVP candidates may further comprise: selecting the respective refinement search window size from at least two different window sizes, wherein the at least two different window sizes may be independent of a type of the each BVP candidate; wherein the determining the second plurality of BVP candidates may further comprise: based on a refinement search window of one BVP candidate of the first plurality of BVP candidates at least partially overlapping a refinement search window of another BVP candidate of the first plurality of BVP candidates, forming a clustered refinement search window encompassing the refinement search window of the one BVP candidate and the refinement search window of the another BVP candidate; based on a TMP search of the clustered refinement search window, replacing the one BVP candidate and the another BVP candidate in the first plurality of BVP candidates with a refinement BVP candidate; performing refinement searching in the refinement search windows of one or more of the first plurality of BVP candidates; and selecting, based on results of the refinement searching, the second plurality of BVP candidates; wherein the TMP cost may be calculated based on at least one of: a L-shape template of the current block; or a top-only or left-only template of the current block; wherein: the first plurality of BVP candidates may comprise: sparse BVP candidates; merge BVP candidates; and auto-relocated block vector prediction (AR-BVP) BVP candidates; and the merge BVP candidates comprise: adjacent merge candidates of the current block; and non-adjacent merge candidates of the current block; wherein: the first plurality of BVP candidates may comprise: merge BVP candidates of the current block; and no sparse BVP candidates of the current block; and the second plurality of BVP candidates comprises: BVP candidates determined based on the first plurality of BVP candidates and sparse candidates of the current block, wherein each of the sparse candidates may be associated with a respective refinement search window of predetermined size; wherein the respective refinement search window size may be determined further based on a size of the current block; wherein the TMP cost may comprise absolute differences (SAD), sum of absolute transformed differences (SATD), or sum of squares error (SSE); wherein the TMP cost may be calculated for a template of the each BVP candidate and the template may have a predetermined height; wherein the first plurality of BVP candidates may be determined based on sampling a search region in a first sampling interval; wherein the first plurality of BVP candidates may have the lowest TMP costs of BVP candidates obtained from the sampling the search region according to the first sampling interval; wherein the second plurality of BVP candidates may be determined based on sampling the first plurality of refinement windows in a second sampling interval; wherein the second sampling interval may be smaller than the first sampling interval; wherein the second plurality of BVP candidates may have the lowest TMP costs of BVP candidates comprising BVP candidates obtained from the sampling the first plurality of refinement windows; wherein the refinement search window for the respective BVP candidate may be centered at a position indicated by the BVP candidate; wherein the respective refinement window size may specify a width and a height of the refinement search window. The computing device may comprise one or more processors and memory, storing instructions that, when executed by the one or more processors, perform the method described herein. A system may comprise the computing device configured to perform the described method, additional operations, and/or include additional elements; and a second computing device configured to decode the current block. A computer-readable medium may store instructions that, when executed, cause performance of the described method, additional operations, and/or include additional elements.

A computing device may perform a method comprising multiple operations. The computing device may comprise an encoder. The computing device may determine, for a current block of content, a first plurality of block vector predictor (BVP) candidates; may determine, based on comparing a template matching prediction (TMP) cost of each BVP candidate of the first plurality of BVP candidates to at least one threshold, a respective refinement search window size for the each BVP candidate of the first plurality of BVP candidates; may determine a second plurality of BVP candidates based on the first plurality of BVP candidates and a plurality of refinement search windows; and encode the current block based on a BVP candidate selected from the second plurality of BVP candidates, wherein the determining the respective refinement search window size for the each BVP candidate of the first plurality of BVP candidates further comprise: based on the TMP cost of the each BVP candidate of the first plurality of BVP candidates being equal to or lower than a first threshold: determining a first size value by using a linear or quadratic function of the TMP cost; and setting the respective refinement search window size to the first size value, wherein the determining the respective refinement search window size for the each BVP candidate of the first plurality of BVP candidates may further comprise: based on the TMP cost of the each BVP candidate of the first plurality of BVP candidates being equal to or lower than a first threshold: determining, based on a lookup table, a first size value; and setting the respective refinement search window size to the first size value; wherein the determining the respective refinement search window size for the each BVP candidate of the first plurality of BVP candidates may further comprise: based on the TMP cost of the each BVP candidate of the first plurality of BVP candidates being equal to or lower than a first threshold, setting the respective refinement search window size to a predetermined value; wherein the determining the respective refinement search window size for the each BVP candidate of the first plurality of BVP candidates may further comprise: based on the TMP cost of the each BVP candidate of the first plurality of BVP candidates being equal to or lower than a first threshold, setting the respective refinement search window size to a first size value that is proportional to a magnitude of the TMP cost; wherein the determining the respective refinement search window size for the each BVP candidate of the first plurality of BVP candidates may further comprise: based on the TMP cost of the each BVP candidate of the first plurality of BVP candidates being greater than a second threshold, setting the respective refinement search window size to a second size value, wherein: the first plurality of BVP candidates may comprise at least merge BVP candidates of the current block; and the second threshold may be based on a highest TMP cost of any sparse BVP candidates of the current block; wherein the determining the respective refinement search window size for the each BVP candidate of the first plurality of BVP candidates may further comprise: based on the TMP cost of the each BVP candidate of the first plurality of BVP candidates being less than a second threshold, setting, based on a type of the each BVP candidate, the respective refinement search window size to a third size value, wherein: the second threshold may be based on a highest TMP cost of any sparse BVP candidates of the current block. The computing device may comprise one or more processors and memory, storing instructions that, when executed by the one or more processors, perform the method described herein. A system may comprise the computing device configured to perform the described method, additional operations, and/or include additional elements; and a second computing device configured to decode the current block. A computer-readable medium may store instructions that, when executed, cause performance of the described method, additional operations, and/or include additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
determining, by a computing device and for a current block of content, a first plurality of block vector predictor (BVP) candidates;
for each BVP candidate of the first plurality of BVP candidates:
determining a respective refinement search window size based on a template matching prediction (TMP) cost of the BVP candidate;
determining a second plurality of BVP candidates based on:
the first plurality of BVP candidates; and
a plurality of refinement search windows that comprises a respective refinement search window, of the respective refinement search window size, for the each BVP candidate of the first plurality of BVP candidates; and
decoding the current block based on a BVP candidate selected from the second plurality of BVP candidates.

2. The method of claim 1, wherein the determining the respective refinement search window size further comprises:
determining, based on comparing the TMP cost of the BVP candidate to at least one threshold, the respective refinement search window size.

3. The method of claim 1, wherein the determining the respective refinement search window size for the BVP candidate of the first plurality of BVP candidates further comprises:
based on the TMP cost of the BVP candidate being lower than a first threshold, setting the respective refinement search window size to a first size value; or
based on the TMP cost of the BVP candidate being equal to or greater than the first threshold, setting the respective refinement search window size to a second size value.

4. The method of claim 1, wherein the determining the respective refinement search window size for the BVP candidate of the first plurality of BVP candidates further comprises:
selecting the respective refinement search window size from at least two different search window sizes, wherein the at least two different search window sizes are independent of a type of the BVP candidate.

5. The method of claim 1, wherein the determining the second plurality of BVP candidates further comprises:
based on a refinement search window of one BVP candidate of the first plurality of BVP candidates at least partially overlapping a refinement search window of another BVP candidate of the first plurality of BVP candidates, forming a clustered refinement search window encompassing the refinement search window of the one BVP candidate and the refinement search window of the another BVP candidate;
replacing, based on a TMP search of the clustered refinement search window, the one BVP candidate and the another BVP candidate with a refinement BVP candidate;
performing refinement searching in the refinement search windows of one or more of the first plurality of BVP candidates; and
selecting, based on results of the refinement searching, the second plurality of BVP candidates.

6. The method of claim 1, wherein the determining the second plurality of BVP candidates further comprises:
performing refinement searching in the refinement search windows of one or more of the first plurality of BVP candidates; and
selecting, based on results of the refinement searching, the second plurality of BVP candidates.

7. The method of claim 1, wherein the TMP cost is calculated based on at least one of:
a L-shape template of the current block; or
a top-only or left-only template of the current block.

8. The method of claim 1, wherein:
the first plurality of BVP candidates comprise:
sparse BVP candidates;
merge BVP candidates; and
auto-relocated block vector prediction (AR-BVP) BVP candidates; and
the merge BVP candidates comprise:
adjacent merge candidates of the current block; and
non-adjacent merge candidates of the current block.

9. The method of claim 1, wherein:
the first plurality of BVP candidates comprises:
merge BVP candidates of the current block; and
no sparse BVP candidates of the current block; and
the second plurality of BVP candidates comprises:
BVP candidates determined based on the first plurality of BVP candidates and sparse candidates of the current block, wherein each of the sparse candidates is associated with a respective refinement search window of predetermined size.

10. A method comprising:
determining, by a computing device and for a current block of content, a first plurality of block vector predictor (BVP) candidates;
determining, based on comparing a template matching prediction (TMP) cost of each BVP candidate of the first plurality of BVP candidates to at least one threshold, a respective refinement search window size for the each BVP candidate of the first plurality of BVP candidates;
determining a second plurality of BVP candidates based on the first plurality of BVP candidates and a plurality of refinement search windows; and
decoding the current block based on a BVP candidate selected from the second plurality of BVP candidates.

11. The method of claim 10, wherein the determining the respective refinement search window size for the each BVP candidate of the first plurality of BVP candidates further comprises:
based on the TMP cost of the each BVP candidate of the first plurality of BVP candidates being equal to or lower than a first threshold:
determining a first size value by using a linear or quadratic function of the TMP cost; and
setting the respective refinement search window size to the first size value.

12. The method of claim 10, wherein the determining the respective refinement search window size for the each BVP candidate of the first plurality of BVP candidates further comprises:
based on the TMP cost of the each BVP candidate of the first plurality of BVP candidates being equal to or lower than a first threshold:
determining, based on a lookup table, a first size value; and
setting the respective refinement search window size to the first size value.

13. The method of claim 10, wherein the determining the respective refinement search window size for the each BVP candidate of the first plurality of BVP candidates further comprises:
based on the TMP cost of the each BVP candidate of the first plurality of BVP candidates being equal to or lower than a first threshold, setting the respective refinement search window size to a predetermined value.

14. The method of claim 10, wherein the determining the respective refinement search window size for the each BVP candidate of the first plurality of BVP candidates further comprises:
based on the TMP cost of the each BVP candidate of the first plurality of BVP candidates being equal to or lower than a first threshold, setting the respective refinement search window size to a first size value that is proportional to a magnitude of the TMP cost.

15. The method of claim 10, wherein the determining the respective refinement search window size for the each BVP candidate of the first plurality of BVP candidates further comprises:
based on the TMP cost of the each BVP candidate of the first plurality of BVP candidates being greater than a second threshold, setting the respective refinement search window size to a second size value, wherein:
the first plurality of BVP candidates comprises at least merge BVP candidates of the current block; and
the second threshold is based on a highest TMP cost of any sparse BVP candidates of the current block.

16. The method of claim 10, wherein the determining the respective refinement search window size for the each BVP candidate of the first plurality of BVP candidates further comprises:
based on the TMP cost of the each BVP candidate of the first plurality of BVP candidates being less than a second threshold, setting, based on a type of the each BVP candidate, the respective refinement search window size to a third size value, wherein the second threshold is based on a highest TMP cost of any sparse BVP candidates of the current block.

17. A method comprising:
determining, by a computing device and for a current block of content, a first plurality of block vector predictor (BVP) candidates;
for each BVP candidate of the first plurality of BVP candidates:
determining a respective refinement search window size based on a template matching prediction (TMP) cost of the BVP candidate;
determining a second plurality of BVP candidates based on:
the first plurality of BVP candidates; and
a plurality of refinement search windows that comprises a respective refinement search window, of the respective refinement search window size, for the each BVP candidate of the first plurality of BVP candidates; and
encoding the current block based on a BVP candidate selected from the second plurality of BVP candidates.

18. The method of claim 17, wherein the determining the respective refinement search window size for the each BVP candidate of the first plurality of BVP candidates further comprises:
based on the TMP cost of the each BVP candidate of the first plurality of BVP candidates being lower than a first threshold, setting the respective refinement search window size to a first size value; or
based on the TMP cost of the each BVP candidate of the first plurality of BVP candidates being equal to or greater than the first threshold, setting the respective refinement search window size to a second size value.

19. The method of claim 17, wherein the determining the respective refinement search window size for the each BVP candidate of the first plurality of BVP candidates further comprises:
selecting the respective refinement search window size from at least two different window sizes, wherein the at least two different window sizes are independent of a type of the each BVP candidate.

20. The method of claim 17, wherein the determining the second plurality of BVP candidates further comprises:
based on a refinement search window of one BVP candidate of the first plurality of BVP candidates at least partially overlapping a refinement search window of another BVP candidate of the first plurality of BVP candidates, forming a clustered refinement search window encompassing the refinement search window of the one BVP candidate and the refinement search window of the another BVP candidate;
based on a TMP search of the clustered refinement search window, replacing the one BVP candidate and the another BVP candidate in the first plurality of BVP candidates with a refinement BVP candidate;
performing refinement searching in the refinement search windows of one or more of the first plurality of BVP candidates; and
selecting, based on results of the refinement searching, the second plurality of BVP candidates.
